(19) United States
(12) Patent Application Publication
(10) Pub. No.: US 2025/0095875 A1
(43) Pub. Date: Mar. 20, 2025

(54) METHODS AND SYSTEMS FOR GENERATING HIGH-CONTRAST ARRAYS

(71) Applicant: Atom Computing Inc., Berkeley, CA (US)

(72) Inventors: William CAIRNCROSS, Boulder, CO (US); Mickey MCDONALD, Longmont, CO (US); Hyosub KIM, Boulder, CO (US)

(21) Appl. No.: 18/948,178

(22) Filed: Nov. 14, 2024

Related U.S. Application Data
(63) Continuation of application No. PCT/US2023/023897, filed on May 30, 2023.
(60) Provisional application No. 63/347,424, filed on May 31, 2022.

(51) Int. Cl. G21K 1/00; G02B 26/08

(52) U.S. Cl. CPC G21K 1/006; G02B 26/0833

(57) ABSTRACT

Provided herein are apparatuses, systems, and methods for addressing an array. The apparatuses may comprise an array of spots of light and a beam deflector comprising a plurality of elements. Systems and methods may comprise using the apparatuses as described herein. Each spot of the array of spots may be aligned on each of the beam deflector. Apparatuses, systems, and methods herein may generate high contrast spots on an array. The array may be involved in quantum computing.

### CROSS-REFERENCE

This application is the by-pass continuation of International Application No. PCT/US2023/023897, filed May 30, 2023, which claims the benefit of U.S. Provisional Application No. 63/347,424, filed May 31, 2022, each of which are incorporated herein by reference in their entirety.

### BACKGROUND

Quantum computers typically make use of quantum-mechanical phenomena, such as superposition and entanglement, to perform operations on data. Quantum computers may be different from digital electronic computers based on transistors. For instance, whereas digital computers require data to be encoded into binary digits (bits), each of which is always in one of two definite states (0 or 1), quantum computation uses quantum bits (qubits), which can be in superpositions of states.

### SUMMARY

Neutral atom quantum computers may use focused laser beams to address individual atoms trapped in optical tweezers or optical lattices. In some cases, the focused laser beams may be diffraction limited. Many quantum computing schemes in these systems apply these beams to a subset of trapped atoms that is chosen during a computation, rather than beforehand. High contrast between “bright” and “dark” locations in the array may be as high as possible to selectively perform the desired operations on specific atoms. Accordingly, high contrast between individual adjacent atoms may ensure that atoms not intended to be addressed are exposed a reduced or minimal amount of light.

An example approach to addressing a subset of atoms is to use a liquid-crystal spatial light modulator (SLM) to holographically generate an arrangement of laser spots. However, this approach may have certain drawbacks. For example, SLMs may only display different patterns on the 10 millisecond (ms) timescale. In another example, SLMs may holographically generate patterns with relatively lower quality. The lower quality may be characterized by a contrast ratio between “bright” and “dark” areas of the hologram, which is only about 50:1 in laser intensity. Both the slow speed and low contrast may be drawbacks for the use of this approach in future quantum computers.

Provided herein are apparatuses, systems, and methods of using a beam deflector to generate high contrast spots from an array of spots of light. In some embodiments, the beam deflector comprises a plurality of elements. In some cases, the plurality of elements is a digital micromirror device (DMD). The DMD may be configured as an array of shutters for controlling the intensity of the array of spots of light. The initial array of spots of light can be generated by an SLM or other devices, apparatuses, or methods as disclosed herein.

The high contrast between “bright” and “dark” spots in an array of spots of light may be achieved by way of the plurality of elements when the plurality of elements (e.g., a DMD) is arranged such that a portion of the elements selectively reflect light to generate a pattern of spots. The array of spots of light may be directed towards a beam deflector (e.g., a DMD) via an optical component (e.g., a lens). In some instances, the array of focused beams of light may comprise a dimension. The dimension may be a diameter or a beam waist. The beam waist may be smaller than a dimension each of the plurality of elements. The dimension of each of the plurality of elements may comprise a length, a diameter, a height, or a pitch. In some cases, high contrast between each of the spots of the array of spots of light may be achieved when the beam waist of the focused spots of light is smaller than the dimension of each of the plurality of the elements of the beam deflector. The use of the beam deflector provides an advantage of a one-to-one correspondence between each of the elements and laser spots, as opposed to phase-finding algorithms, such as Gerchberg-Saxton, for generating hologram patterns for phase-only SLMs.

In one aspect, the present disclosure provides an apparatus for spatially separating laser beams, the apparatus comprising: an array of spots of light, and a beam deflector comprising a plurality of elements, wherein each spot of the array of spots of light is aligned on each of the plurality of elements of the beam deflector. In some embodiments, the apparatus further comprises a chamber comprising one or more optical trapping units configured to generate a plurality of spatially distinct optical trapping sites. In some embodiments, the plurality of optical trapping sites is configured to trap a plurality of atoms. In some embodiments, the plurality of atoms comprises one or more qubits. In some embodiments, the plurality of atoms comprises at least 60 atoms. In some embodiments, the plurality of atoms comprises neutral atoms. In some embodiments, the plurality of atoms comprises rare earth atoms. In some embodiments, the plurality of atoms comprises ytterbium atoms. In some embodiments, the plurality of atoms comprises alkali atoms. In some embodiments, the plurality of atoms comprises alkaline earth atoms. In some embodiments, the plurality of atoms comprises strontium atoms. In some embodiments, the plurality of atoms comprises strontium—87 atoms. In some embodiments, the plurality of elements comprises a blazed grating. In some embodiments, the plurality of elements comprises a plurality of mirrors. In some embodiments, the plurality of mirrors is a digital micromirror device (DMD). In some embodiments, the DMD is mounted onto a stage, wherein the stage is configured to rotate along three degrees of freedom. In some embodiments, each of the plurality of elements is spatially separated by at least 10 nm. In some embodiments, each of the plurality of elements comprises a surface area. In some embodiments, the surface area ranges from about 1 μm² to about 10 mm². In some embodiments, the apparatus further comprises a first optical component. In some embodiments, the first optical component comprises a lens, a beam splitter, a mirror, a polarizer, a waveplate, or a combination thereof. In some embodiments, the first optical component comprises a first lens having a first focal length (f₀). In some embodiments, the plurality of elements is located at a distance (d) from the first lens, wherein the distance about the same as the first focal length. In some embodiments, the apparatus further comprises a relay component, wherein the relay component is along an optical path after the plurality of elements. In some embodiments, the array of spots of light travel along the optical path. In some embodiments, the relay component comprises a lens, a beam splitter, a mirror, a polarizer, a waveplate, or a combination thereof. In some embodiments, the relay component comprises a first relay lens having a first relay focal length (fₐ). In some embodiments, the first relay lens is after the plurality of elements on the optical path. In some embodiments, the relay component further comprises a folding mirror, wherein the folding mirror is after the first relay lens on the optical path. In some embodiments, the relay component further comprises a relay waveplate between the first relay lens and the folding mirror. In some embodiments, the apparatus further comprises a beam splitter. In some embodiments, the first lens and the first relay lens are separated by at most about 24°. In some embodiments, the apparatus further comprises a second optical component, wherein the second optical component is after the relay component along the optical path. In some embodiments, the second optical component comprises a plurality of mirrors. In some embodiments, the plurality of mirrors is a DMD. In some embodiments, the apparatus further comprises an optical modulator. In some embodiments, the optical modulator is configured to generate the array of spots of light. In some embodiments, the optical modulator comprises a spatial light modulator (SLM), a DMD, a liquid crystal device, or a combination thereof. In some embodiments, the apparatus further comprises a coherent light source configured to direct an emitted light toward the optical modulator. In some embodiments, the coherent light source is configured to emit light having one or more wavelengths ranging from about 200 nm to about 1,000 nm.

In one aspect, the present disclosure provides a system for addressing a subset of atoms in an array. In some embodiments, the system comprises an atom rearrangement unit (ARU), the ARU comprising an apparatus. In some embodiments, the apparatus comprises a plurality of elements operably coupled to a digital device, and at least one lens. In some embodiments, the plurality of elements is configured (i) to direct an array of spots of light in a direction or (ii) to direct a portion of the array of spots of light onto the array. In some embodiments, the apparatus further comprises a chamber comprising one or more optical trapping units configured to generate a plurality of spatially distinct optical trapping sites. In some embodiments, the plurality of optical trapping sites is configured to trap a plurality of atoms. In some embodiments, the plurality of atoms comprises one or more qubits. In some embodiments, the plurality of atoms comprises at least 60 atoms. In some embodiments, the plurality of atoms comprises neutral atoms. In some embodiments, the plurality of atoms comprises rare earth atoms. In some embodiments, the plurality of atoms comprises ytterbium atoms. In some embodiments, the plurality of atoms comprises alkali atoms. In some embodiments, the plurality of atoms comprises alkaline earth atoms. In some embodiments, the plurality of atoms comprises strontium atoms. In some embodiments, the plurality of atoms comprises strontium—87 atoms. In some embodiments, the plurality of elements comprises a blazed grating. In some embodiments, the plurality of elements comprises a plurality of mirrors. In some embodiments, the plurality of mirrors is a digital micromirror device (DMD). In some embodiments, the DMD is mounted onto a stage, wherein the stage is configured to rotate along three degrees of freedom. In some embodiments, each of the plurality of elements is spatially separated by at least 10 nm. In some embodiments, each of the plurality of elements comprises a surface area. In some embodiments, the surface area ranges from about 1 μm² to about 10 mm². In some embodiments, the apparatus further comprises a first optical component. In some embodiments, the first optical component comprises a lens, a beam splitter, a mirror, a polarizer, a waveplate, or a combination thereof. In some embodiments, the first optical component comprises a first lens having a first focal length (f₀). In some embodiments, the plurality of elements is located at a distance (d) from the first lens, wherein the distance about the same as the first focal length. In some embodiments, the apparatus further comprises a relay component, wherein the relay component is along an optical path after the plurality of elements. In some embodiments, the array of spots of light travel along the optical path. In some embodiments, the relay component comprises a comprises a lens, a beam splitter, a mirror, a polarizer, a waveplate, or a combination thereof. In some embodiments, the relay component comprises a first relay lens having a first relay focal length (fₐ). In some embodiments, the first relay lens is after the plurality of elements on the optical path. In some embodiments, the relay component further comprises a folding mirror, wherein the folding mirror is after the first relay lens on the optical path. In some embodiments, the relay component further comprises a waveplate between the first relay lens and the folding mirror. In some embodiments, the apparatus further comprises a beam splitter. In some embodiments, the first lens and the first relay lens are separated by at most about 24°. In some embodiments, the apparatus further comprises a second optical component, wherein the second optical component is after the relay component along the optical path. In some embodiments, the second optical component comprises a plurality of mirrors.

In some embodiments, the plurality of mirrors is a DMD. In some embodiments, the apparatus further comprises an optical modulator. In some embodiments, the optical modulator comprises a spatial light modulator (SLM), a DMD, a liquid crystal device, or a combination thereof. In some embodiments, the optical modulator is configured to generate the plurality of an array of spots of light. In some embodiments, the apparatus comprises a light source. In some embodiments, the light source comprises a coherent light source, configured to emit light having one or more wavelengths that are within a range from about 200 nm to about 1,000 nm.

In one aspect, the present disclosure provides a method for improving contrast of signals on an array. In some embodiments, the method comprises a) directing an array of spots of light onto a plurality of elements, the plurality of elements controlled by a digital device, wherein each of the spots of light is directed onto a separate element of the plurality of elements; and b) orienting using the digital device the plurality of elements to direct the plurality of incident laser beams. In some embodiments, the elements of the DMD are individually manipulatable to steer each of the spots of light. In some embodiments, the array comprises signals having a contrast ratio of at least 1,000:1. In some embodiments, the contrast ratio is at least 5,000:1, 10,000:1, or 20,000:1. In some embodiments, the contrast ratio ranges from about 1,000:1 to 10,000:1. In some embodiments, the method further comprises focusing the array of spots of light through a first optical component. In some embodiments, the first optical component comprises a first lens having a first focal length (f₀). In some embodiments, the first lens is before the plurality of elements. In some embodiments, focusing an array of spots of light through the first lens comprises decreasing a waist of the array of spots of light, wherein the waist is smaller than a dimension each spot of light. In some embodiments, focusing an array of spots of light comprises directing the array of spots of light over a distance (d) between the first lens and the plurality of elements, wherein d is substantially the same as f₀. In some embodiments, the dimension of the element of the plurality of elements comprises a diameter or a pitch. In some embodiments, the orienting the plurality of elements comprises orienting a first portion of the plurality of elements at an orientation ranging from −12° to about +12° relative to an incident plane. In some embodiments, the orienting the plurality of elements comprises orienting the first portion of the plurality of elements at +12° relative to an incident plane. In some embodiments, the orienting the plurality of elements comprises orienting the second portion of the plurality of elements at −12° relative to an incident plane. In some embodiments, the orienting the plurality of elements comprises orienting a first portion of the plurality of elements at +12° relative to an incident plane and orienting a second portion of the plurality of elements at −12° relative to the incident plane. In some embodiments, the method further comprises addressing an arbitrary subset of the array on a time scale. In some embodiments, the time scale comprises at least 10 microseconds. In some embodiments, the array of trapped atoms comprises a portion of a quantum computer.

In one aspect, the present disclosure provides an apparatus for spatially separating laser beams. In some embodiments, the apparatus comprises an array of spots of light and a beam block comprising a plurality of elements. In some embodiments, each spot of the array of spots of light is aligned on each of the plurality of elements of the beam block. In some embodiments, the beam block comprises a microshutter array, the microshutter array comprising microshutters. The apparatus of claim 100, wherein the each of the microshutters has a length ranging from about 10 μm to about 1 mm. In some instances, the length may range from about 50 μm to about 500 μm.

In some aspects, the present disclosure provides a system comprising an apparatus, a light source, and a chamber. The apparatus is as substantially described throughout, wherein the apparatus is configured to spatially separate laser beams. The apparatus comprises an array of spots of light and a beam deflector. The beam deflector may comprise a plurality of elements, wherein each spot of the array of spots of light is aligned on each of the plurality of elements of the beam deflector. The light source may be configured to generate a laser beam. The laser beam may be modulated via an optical modulator (OM). The OM may modulate the light to generate an array of spots of light.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings (also “Figure” and “FIG.” herein), of which:

FIG. 1 shows a computer control system that is programmed or otherwise configured to implement methods provided herein;

FIG. 2 shows an example of a system for performing a non-classical computation;

FIG. 3A shows an example of an optical trapping unit;

FIG. 3B shows an example of a plurality of optical trapping sites;

FIG. 3C shows an example of an optical trapping unit that is partially filled with atoms;

FIG. 3D shows an example of an optical trapping unit that is completely filled with atoms;

FIG. 4 shows an example of an electromagnetic delivery unit;

FIG. 5 shows an example of a state preparation unit;

FIG. 6 shows a flowchart for an example of a first method for performing a non-classical computation;

FIG. 7 shows a flowchart for an example of a second method for performing a non-classical computation;

FIG. 8 shows a flowchart for an example of a third method for performing a non-classical computation;

FIG. 9 shows an energy level structure for single-qubit and multi-qubit operations in strontium—87;

FIGS. 10A and 10B illustrate diagrams of an apparatus according to embodiments of the disclosure;

FIG. 11 illustrates an apparatus comprising a second optical component according to embodiments of the disclosure;

FIG. 12 illustrates an apparatus comprising an alternative second optical component according to embodiments of the disclosure; and

FIG. 13 illustrates a diagram of an array of tweezers showing spots from each pass through the beam path as they fall on the elements of the DMD, according to embodiments of the disclosure.

### DETAILED DESCRIPTION

While various embodiments of the disclosure have been shown and described herein, it will be obvious to those skilled in the art that such embodiments are provided by way of example only. Numerous variations, changes, and substitutions may occur to those skilled in the art without departing from the disclosure. It should be understood that various alternatives to the embodiments of the disclosure described herein may be employed.

While various embodiments of the disclosure have been shown and described herein, it will be obvious to those skilled in the art that such embodiments are provided by way of example only. Numerous variations, changes, and substitutions may occur to those skilled in the art without departing from the disclosure. It should be understood that various alternatives to the embodiments of the disclosure described herein may be employed.

The present disclosure provides apparatuses for spatially separating laser beams. In some cases, the apparatus comprises an array of spots of light. An apparatus may further comprise a beam deflector. In some instances, the beam deflector may comprise a plurality of elements. In some cases, each spot of the array of spots can be aligned on each of the plurality of elements of the beam deflector.

In some cases, the apparatus further comprises a chamber. The chamber may comprise one or more optical trapping units configured to generate a plurality of spatially distinct optical trapping sites. The plurality of optical trapping sites is configured to trap a plurality of atoms. In some instances, the plurality of atoms may comprise one or more qubits. For example, the plurality of atoms may be configured to be usable as one or more qubits. The one or more qubits may be configured to perform a non-classical computation (e.g., a non-classical computation as described elsewhere herein). For example, the one or more qubits can be configured to perform a gate-based quantum computation. In another example, the one or more qubits may be configured to perform a quantum computation. The plurality of atoms may comprise at least about 1, 2, 3, 4, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 300, 400, 500, or more atoms. The one or more atoms may comprise at most about 500, 400, 300, 200, 190, 180, 170, 160, 150, 140, 130, 120, 110, 100, 95, 90, 85, 80, 75, 70, 65, 60, 55, 50, 45, 40, 35, 30, 25, 20, 15, 10, 5, 4, 3, 2, or fewer atoms. The one or more atoms may comprise a number of atoms as defined by any two of the proceeding values. For example, the one or more atoms may comprise from about 75 to about 150 atoms. The one or more atoms may comprise neutral atoms. For example, the one or more atoms may comprise atoms that are not ionized (e.g., are in a neutral state). Each atom of the one or more atoms may be a neutral atom. For example, each atom of an array of atoms can be not ionized. The one or more atoms may comprise rare earth atoms (e.g., lanthanide series atoms (e.g., ytterbium, neodymium, lanthanum, erbium, etc.), scandium, yttrium, etc.), alkali atoms (e.g., sodium, potassium, etc.), alkali earth atoms (e.g., calcium, strontium (e.g., strontium—87 atoms), etc.), or the like, or any combination thereof.

### Beam Deflector

In some cases, the plurality of elements may be configured to direct the array of spots of light. The plurality of elements may be oriented at an angle with respect to an incident plane. In some cases, the incident plane may be defined as a plane that is perpendicular to the plane of the plurality of elements. In some instances, a first portion of the plurality of elements may be oriented at a first angle to direct a first portion of the array of spots of light. A second portion of the plurality of elements may be oriented at a second angle to direct a second portion of the array of spots of light. In some instances, the first angle may range from about −20 degrees (°) to about 0°. The second angle may range from about 0° to about +20°. In some instances, the first portion of the plurality of elements oriented at the first angle may be configured to direct the array of spots of light toward a downstream component (e.g., a chamber comprising qubits). In some cases, the second portion of the plurality of elements oriented at the second angle may be configured to direct the array of spots of light away from the downstream component. In some cases, the second portion of the plurality of elements may direct the second portion of the array of spots of light toward a beam dump.

In some cases, the plurality of elements may comprise a blazed grating. In some instances, the plurality of elements comprises a plurality of mirrors. In some instances, the plurality of elements comprises at least about 10, about 20, about 30, about 40, about 50, about 60, about 70, about 80, about 90, about 100, about 200, about 300, about 400, about 500, about 600, about 700, about 800, about 900, about 1,000, about 2,000, about 3,000, about 4,000, about 5,000, about 6,000, about 7,000, about 8,000, about 9,000, about 10,000, about 20,000, about 30,000, about 40,000, about 50,000, about 60,000, about 70,000, about 80,000, about 90,000, about 100,000, about 200,000, about 300,000, about 400,000, about 500,000, about 600,000, about 700,000, about 800,000, about 900,000, or about 1,000,000 elements, such as mirrors or individual gratings of the blazed grating. In some instances, the plurality of elements ranges from about 10,000 to about 1,000,000, from about 50,000, to about 500,000, or from about 100,000 to about 200,000 elements. In some cases, each of the plurality of elements is spatially separated by at least about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, or about 10 μm.

In some instances, each of the plurality of elements comprises a surface area. The surface area of each element may range from about 1 μm² to about 10 mm², from about 5 μm² to about 5 mm², from about 10 μm² to about 1 mm², or from about 100 μm² to about 500 μm². In some instances, the surface area of each element is at least 1 μm², about 2 μm², about 3 μm², about 4 μm², about 5 μm², about 6 μm², about 7 μm², about 8 μm², about 9 μm², about 10 μm², about 20 μm², about 30 μm², about 40 μm², about 50 μm², about 60 μm², about 70 μm², about 80 μm², about 90 μm², about 100 μm², about 200 μm², about 300 μm², about 400 μm², about 500 μm², about 600 μm², about 700 μm², about 800 μm², about 900 μm², about 1 mm², about 2 mm², about 3 mm², about 4 mm², about 5 mm², about 6 mm², about 7 mm², about 8 mm², about 9 mm², or about 10 mm². In some embodiments, the surface may be at most 10 mm², about 9 mm², about 8 mm², about 7 mm², about 6 mm², about 5 mm², about 4 mm², about 3 mm², about 2 mm², about 1 mm², about 900 μm², about 800 μm², about 700 μm², about 600 μm², or about 500 μm².

In some instances, each of the plurality of elements comprises a dimension, such as a diameter. The diameter of each of the plurality of elements may be about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 15 μm, about 20 μm, about 25 μm, about 30 μm, about 35 μm, about 40 μm, about 45 μm, or about 50 μm.

In some instances, the plurality of elements comprises a plurality of mirrors. Each of the plurality of mirrors may have a diameter that is substantially the same. In some instances, the plurality of mirrors may comprise a flat mirror, a concave mirror, or a combination thereof. In some instances, the plurality of mirrors may comprise a coating.

In some cases, the plurality of mirrors is a digital micromirror device (DMD). In some cases, the DMD is mounted onto a stage, wherein the stage is configured to rotate along three degrees of freedom. In some cases, when a DMD is used, the incident plane is relative to the stage, and each of the plurality of elements may be oriented at an angle relative to the incident plane. In some instances, the apparatus further comprises a controller operably coupled to the plurality of elements, such as the DMD. In some cases, the controller may orient a first portion of the plurality of elements at a first angle. The controller may orient a second portion of the plurality of elements at a second angle. The controller may refresh or change the orientation of the first portion and the second portion at a refresh rate. In some instances, the refresh rate ranges from about 100 Hz to about 100 kHz, about 200 Hz to about 900 kHz, from about 300 Hz to about 800 kHz, from about 500 Hz to about 700 kHz, from about 1 kHz to about 500 kHz, or from about 20 kHz to about 250 kHz. In some instances, the refresh rate is at least about 10 kHz, about 20 kHz, about 30 kHz, about 40 kHz, about 50 kHz, about 60 kHz, about 70 kHz, about 80 kHz, about 90 kHz, about 100 kHz, about 200 kHz, about 300 kHz, about 400 kHz, or about 500 kHz.

In some instances, the DMD may be configured to generate a pattern of spots of light. In some instances, the DMD may generate a pattern based on a refresh rate. The refresh rate may correspond to a rate at which elements (e.g., mirrors) may change an orientation as a function of time. For example, when the refresh rate is about 30 kHz, a pattern of spots of light may be generated approximately every 30 microseconds (μs). In some instances, a pattern of spots of light may generated every about 10 μs, about 20 μs, about 30 μs, about 40 μs, about 50 μs, about 60 μs, about 70 μs, about 80 μs, about 90 μs, about 100 μs, about 200 μs, about 300 μs, about 400 μs, about 500 μs, about 600 μs, about 700 μs, about 800 μs, about 900 μs, or about 1 ms. In some instances, a pattern of spots of light may generated at most every about about 1 ms, about 900 μs, about 800 μs, about 700 μs, about 600 μs, about 500 μs, about 400 μs, about 300 μs, about 200 μs, or about 100 μs.

In some instances, the DMD may further comprise a filter.

### First Optical Component

In some cases, the apparatus further comprises a first optical component. In some instances, the first optical component comprises a lens, a beam splitter, a mirror, a polarizer, a waveplate, or a combination thereof. In some instances, the first optical component comprises a first lens having a first focal length (f₀). In some cases, the plurality of elements is located at a distance (d) from the first optical component, such as the first lens.

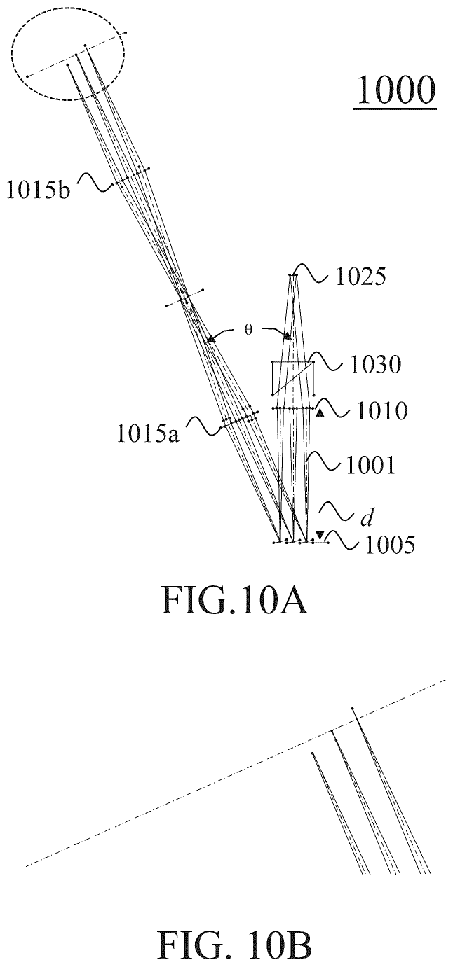

As generally illustrated in FIG. 10A, an apparatus 1000 may comprise an array of spots of light 1001 and a plurality of elements 1005. The plurality of elements 1005 may comprise mirrors. The apparatus 1000 may further comprise a first optical component 1010. In some cases, the first optical component 1010 comprises a dimension. The dimension may comprise a focal length. In some cases, the first optical component comprises a first lens that has a first focal length (f₀). In some cases, the plurality of elements 1005 may be placed at a distance (d) that is substantially similar to f₀, wherein the distance corresponds to a length between a center of the first optical component 1010 and the plurality of mirrors 1005.

In some cases, each of the array of spots of light may comprise a beam waist. The beam waist may be smaller than a dimension of the plurality of elements, such as a length, a height, a diameter, or a pitch. In some cases, the beam waist is at least about 10%, about 20%, about 30%, about 40%, about 50%, about 60%, about 70%, about 80%, or about 90% smaller than the dimension of the plurality of elements. For example, as in FIG. 10A, a pitch of a mirror of the plurality of mirrors 1005 may comprise a pitch, and the beam waist of a spot of the array of spots may have a diameter smaller than the pitch of the mirror.

### Relay Component

In some cases, the apparatus may comprise a relay component. The relay component may be configured to propagate the array of spots of light. The relay component may direct the array of spots along an optical path. The relay component comprises a lens, a beam splitter, a mirror, a polarizer, a waveplate, or a combination thereof. The relay component may be positioned along the optical path after the plurality of elements. The relay component may be positioned between the plurality of elements and the second optical component.

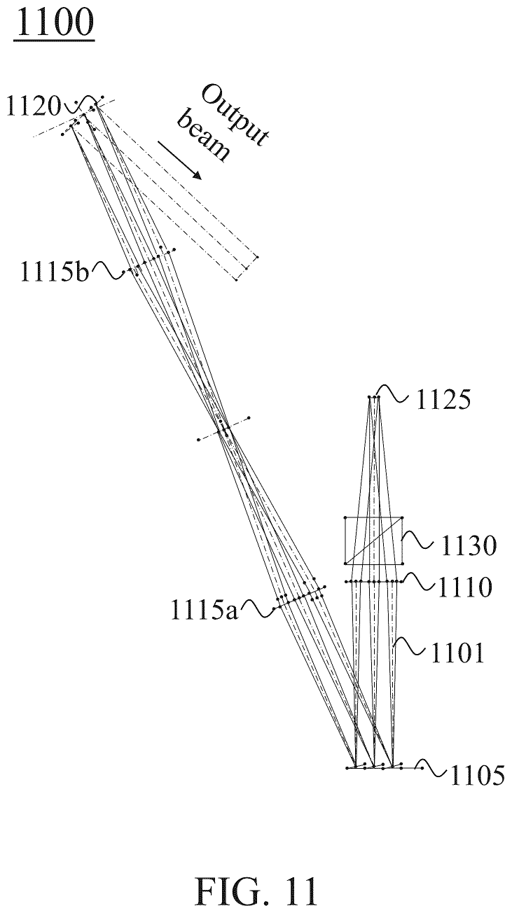

As illustrated in FIG. 10A, the apparatus 1000 may comprise a relay component 1015 or a series of relay components 1015a, 1015b, 1015n, wherein n is an integer from 1 to 50. In some instances, the relay component may comprise a lens, a beam splitter, a mirror, a polarizer, a waveplate, or a combination thereof. In some instances, the relay component may comprise a pair of lenses, as illustrated in FIGS. 10A and 11. The pair of lenses may comprise a first relay lens 1015a having a first relay focal length (fₐ) and a second relay lens 1015b having a second relay focal length (f_{b}). In some instances, the first relay lens comprises a first convex lens, and the second relay lens comprises a second convex lens. In some instances, fₐ may be substantially the same as f_{b}. In some cases, fₐ may be larger than f_{b}. In some cases, fₐ may be less than f_{b}.

In some cases, the relay component may be configured to focus the array of spots of light. In some instances, the relay component may be oriented at an angle (theta, θ) relative to the incident plane. In some instances, the angle may range from about 0° to about 24°. In some cases, the first relay lens may be oriented at an angle ranging from about 12° to about 24° with respect to the first optical component. In some instances, the first relay lens may be oriented at most 24° from the first optical component, such as a first lens.

In some cases, the relay component may further comprise a relay mirror. In some cases, the relay mirror may be placed at a distance (x) from the first relay lens. In some cases, x is shorter than the focal length of the first relay lens (fₐ). In some cases, x is longer than fₐ. In some instances, the relay mirror is a folding mirror. The folding mirror may be configured to fold light 180° from an incident direction and send light in the opposite direction on the optical path.

In some instances, the relay component further comprises a relay waveplate. The relay waveplate may be positioned after a first relay lens. The first relay lens may comprise a first relay focal length (fₐ), and the relay waveplate may be placed at a distance shorter than fₐ such that the first relay lens does not focus light onto the relay waveplate. In the cases, the waveplate may be configured to select for a polarization of the array of spots of light. In some cases, the waveplate may be a quarter waveplate (λ/4) or a half-wave plate (λ/2). In some cases, the mirror may be a flat mirror. In some cases, the mirror may further comprise a coating.

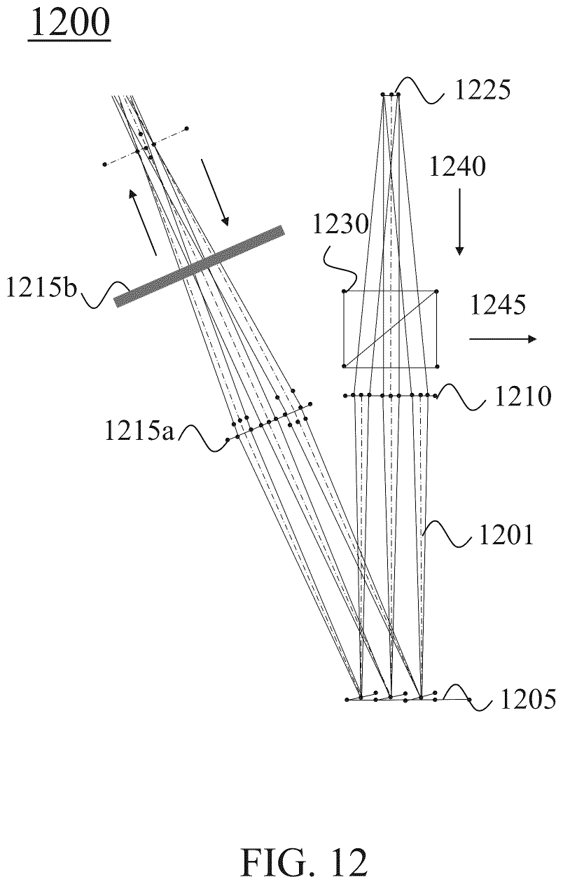

As illustrated in FIG. 12, the apparatus 1200 may comprise a second optical component 1220, wherein the second optical component comprises a mirror and a waveplate. The second optical component 1220 may be placed adjacent to a relay component 1215. The relay component 1215 may comprise a first relay lens 1215a having a first relay focal length (fₐ) and is configured to focus light. In some cases, the relay component 1215 may be a biconvex lens. The relay component 1215 may further comprise a relay waveplate 1215b. The relay waveplate 1215b may be positioned at a distance from the first relay lens 1215a shorter than fₐ. The apparatus 1200 may further comprise an optical modulator 1225.

The array of spots of light 1201 may be focused onto the elements of the plurality of elements 1205. The first portion of the array of spots may pass through the waveplate and be reflected by the mirror. The reflected array of spots may pass through the waveplate and through the first relay lens 1215a toward the plurality of elements 1205. The first relay lens 1215a may focus the array of spots onto the plurality of elements 1205 to provide an array of refocused spots. The array of refocused spots may be aligned onto each of the elements of the plurality of elements 1205. The array of refocused spots may be reflected off of the elements of the plurality of elements 1205 and directed toward the first optical component 1210 to provide an array of spots. The array of spots may be refocused through the first optical component 1210 to provide an array of focused spots of light. The array of focused spots of light may be directed toward a polarizing beam splitter (PBS) 1230. The PBS 1230 may be situated between the first optical component 1210 and the optical modulator 1225.

### Second Optical Component

In some cases, the apparatus further comprises a second optical component. The second optical component may comprise a lens, a beam splitter, a mirror, a polarizer, a waveplate, or a combination thereof.

In some cases, the second optical component comprises a second plurality of elements. The second plurality of elements may comprise a plurality of blazed gratings, mirrors, or a combination thereof. In some instances, the second plurality of elements comprises at least about 10, about 20, about 30, about 40, about 50, about 60, about 70, about 80, about 90, about 100, about 200, about 300, about 400, about 500, about 600, about 700, about 800, about 900, about 1,000, about 2,000, about 3,000, about 4,000, about 5,000, about 6,000, about 7,000, about 8,000, about 9,000, or about 10,000 elements, such as bladed gratings or mirrors. In some cases, each of the second plurality of elements is spatially separated by at least about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, or about 10 μm.

In some instances, each of the second plurality of elements comprises a surface area, a surface area. The surface area of each element may range from about 1 μm² to about 10 mm², from about 5 μm² to about 5 mm², from about 10 μm² to about 1 mm², or from about 100 μm² to about 500 μm². In some instances, the surface area of each element is at least 1 μm², about 2 μm², about 3 μm², about 4 μm², about 5 μm², about 6 μm², about 7 μm², about 8 μm², about 9 μm², about 10 μm², about 20 μm², about 30 μm², about 40 μm², about 50 μm², about 60 μm², about 70 μm², about 80 μm², about 90 μm², about 100 μm², about 200 μm², about 300 μm², about 400 μm², about 500 μm², about 600 μm², about 700 μm², about 800 μm², about 900 μm², about 1 mm², about 2 mm², about 3 mm², about 4 mm², about 5 mm², about 6 mm², about 7 mm², about 8 mm², about 9 mm², or about 10 mm². In some embodiments, the surface may be at most 10 mm², about 9 mm², about 8 mm², about 7 mm², about 6 mm², about 5 mm², about 4 mm², about 3 mm², about 2 mm², about 1 mm², about 900 μm², about 800 μm², about 700 μm², about 600 μm², or about 500 μm².

In some instances, each of the second plurality of elements comprises a dimension, such as a diameter. The diameter of each of the plurality of elements may be about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 25 μm, about 30 μm, or about 40 μm. The diameter of each of the plurality of elements may be at most about 40 μm about 30 μm, about 25 μm, about 20 μm, about 19 μm, about 18 μm, about 17 μm, about 16 μm, about 15 μm, about 14 μm, about 13 μm, about 12 μm, about 11 μm, or about 10 μm. The diameter may be at least about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, or about 9 μm. In some instances, the second plurality of elements comprises a plurality of mirrors. Each of the second plurality of mirrors may have a diameter that is substantially the same. In some instances, the second plurality of mirrors may comprise a flat mirror, a concave mirror, or a combination thereof. In some instances, the second plurality of mirrors may comprise a coating.

In some cases, the second plurality of elements is a digital micromirror device (DMD). In some instances, the second plurality of elements comprises a second plurality of mirrors. In some instances, the second plurality of mirrors may prevent or compensate for defocusing or shrinkage of each of the focused spots of light of the array of light. In some cases, the DMD is mounted onto a stage, wherein the stage is configured to rotate along three degrees of freedom. In some cases, when a DMD is used, the incident plane is relative to the stage, and each of the plurality of elements may be oriented at an angle relative to the incident plane. As illustrated in FIG. 11, an apparatus 1100 may comprise a first plurality of elements 1105 comprising a first DMD. The apparatus 1100 may comprise a second optical component 1120, wherein the second optical component 1120 comprises a second plurality of elements. In some cases, the second plurality of elements is a second DMD 1120. As illustrated in FIG. 11, at least two relay components, 1115a and 1115b, may be used. The first relay component 1115a may comprise a lens having a focal length (fₐ). The second relay component 1115b may comprise a lens having a focal length (f_{b}). An array of spots of light may be focused onto the first DMD, and the reflected light may be refocused as it passes through the relay component 1115a. In some instances, the array of refocused spots of light may pass through a conjugate plane. As the array of refocused spots passes through the conjugate plane, the spots of the array of spots may diffuse. As the array of diffuse spots pass through the relay component 1115b, the relay component 1115b may refocus the spots of the array onto the second DMD, such that each of the refocused spots of the array is aligned with each of the mirrors of the second DMD 1120. The second DMD may be operably coupled to a second digital device, which may control an orientation of a first portion of second DMD mirrors and a second portion of second DMD mirrors. The orientation of the first portion of second DMD mirrors may be configured to direct spots of the refocused spots of the array of refocused spots. In some cases, the array of refocused spots may be directed towards a downstream component (e.g., a chamber comprising qubits). The directed light may comprise an output beam. A second portion of the second DMD mirrors may direct light away from the downstream component, such as toward a beam dump.

In some instances, the apparatus further comprises a controller operably coupled to the second plurality of elements 1120. In some cases, the controller may orient a first portion of the second plurality of elements at a first angle. The controller may orient a second portion of the second plurality of elements at a second angle. The controller may refresh or change the orientation of the first portion and the second portion at a refresh rate. In some instances, the refresh rate ranges from about 100 Hz to about 100 kHz, about 200 Hz to about 900 kHz, from about 300 Hz to about 800 kHz, from about 500 Hz to about 700 kHz, from about 1 kHz to about 500 kHz, or from about 20 kHz to about 250 kHz. In some instances, the refresh rate is at least about 10 kHz, about 20 kHz, about 30 kHz, about 40 kHz, about 50 kHz, about 60 kHz, about 70 kHz, about 80 kHz, about 90 kHz, about 100 kHz, about 200 kHz, about 300 kHz, about 400 kHz, or about 500 kHz.

### Light Source

In some cases, the apparatus may be in communication with a plurality of light sources. The plurality of light sources may comprise a coherent light source. The coherent light source may comprise lasers. The lasers may emit light comprising one or more wavelengths in the ultraviolet (UV), visible, or infrared (IR) portions of the electromagnetic spectrum. The lasers may emit light comprising one or more wavelengths of at least about 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, 1,010 nm, 1,020 nm, 1,030 nm, 1,040 nm, 1,050 nm, 1,060 nm, 1,070 nm, 1,080 nm, 1,090 nm, 1,100 nm, 1,110 nm, 1,120 nm, 1,130 nm, 1,140 nm, 1,150 nm, 1,160 nm, 1,170 nm, 1,180 nm, 1,190 nm, 1,200 nm, 1,210 nm, 1,220 nm, 1,230 nm, 1,240 nm, 1,250 nm, 1,260 nm, 1,270 nm, 1,280 nm, 1,290 nm, 1,300 nm, 1,310 nm, 1,320 nm, 1,330 nm, 1,340 nm, 1,350 nm, 1,360 nm, 1,370 nm, 1,380 nm, 1,390 nm, 1,400 nm, or more. The lasers may emit light comprising one or more wavelengths of at most about 1,400 nm, 1,390 nm, 1,380 nm, 1,370 nm, 1,360 nm, 1,350 nm, 1,340 nm, 1,330 nm, 1,320 nm, 1,310 nm, 1,300 nm, 1,290 nm, 1,280 nm, 1,270 nm, 1,260 nm, 1,250 nm, 1,240 nm, 1,230 nm, 1,220 nm, 1,210 nm, 1,200 nm, 1,190 nm, 1,180 nm, 1,170 nm, 1,160 nm, 1,150 nm, 1,140 nm, 1,130 nm, 1,120 nm, 1,110 nm, 1,100 nm, 1,090 nm, 1,080 nm, 1,070 nm, 1,060 nm, 1,050 nm, 1,040 nm, 1,030 nm, 1,020 nm, 1,010 nm, 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, 390 nm, 380 nm, 370 nm, 360 nm, 350 nm, 340 nm, 330 nm, 320 nm, 310 nm, 300 nm, 290 nm, 280 nm, 270 nm, 260 nm, 250 nm, 240 nm, 230 nm, 220 nm, 210 nm, 200 nm. The lasers may emit light comprising one or more wavelengths that are within a range defined by any two of the preceding values. The coherent light source may be configured to emit light having one or more wavelengths of light ranging from about 200 nm to about 2,000 nm.

The lasers may emit light having a bandwidth of at least about 1×10⁻¹⁵ nm, 2×10⁻¹⁵ nm, 3×10⁻¹⁵ nm, 4×10⁻¹⁵ nm, 5×10⁻¹⁵ nm, 6×10⁻¹⁵ nm, 7×10⁻¹⁵ nm, 8×10⁻¹⁵ nm, 9×10⁻¹⁵ nm, 1×10⁻¹⁴ nm, 2×10⁻¹⁴ nm, 3×10⁻¹⁴ nm, 4×10⁻¹⁴ nm, 5×10⁻¹⁴ nm, 6×10⁻¹⁴ nm, 7×10⁻¹⁴ nm, 8×10⁻¹⁴ nm, 9×10⁻¹⁴ nm, 1×10⁻¹³ nm, 2×10⁻¹³ nm, 3×10⁻¹³ nm, 4×10⁻¹³ nm, 5×10⁻¹³ nm, 6×10⁻¹³ nm, 7×10⁻¹³ nm, 8×10⁻¹³ nm, 9×10⁻¹³ nm, 1×10⁻¹² nm, 2×10⁻¹² nm, 3×10⁻¹² nm, 4×10⁻¹² nm, 5×10⁻¹² nm, 6×10⁻¹² nm, 7×10⁻¹² nm, 8×10⁻¹² nm, 9×10⁻¹² nm, 1×10⁻¹¹ nm, 2×10⁻¹¹ nm, 3×10⁻¹¹ nm, 4×10⁻¹¹ nm, 5×10⁻¹¹ nm, 6×10⁻¹¹ nm, 7×10⁻¹¹ nm, 8×10⁻¹¹ nm, 9×10⁻¹¹ nm, 1×10⁻¹⁰ nm, 2×10⁻¹⁰ nm, 3×10⁻¹⁰ nm, 4×10⁻¹⁰ nm, 5×10⁻¹⁰ nm, 6×10⁻¹⁰ nm, 7×10⁻¹⁰ nm, 8×10⁻¹⁰ nm, 9×10⁻¹⁰ nm, 1×10⁻⁹ nm, 2×10⁻⁹ nm, 3×10⁻⁹ nm, 4×10⁻⁹ nm, 5×10⁻⁹ nm, 6×10⁻⁹ nm, 7×10⁻⁹ nm, 8×10⁻⁹ nm, 9×10⁻⁹ nm, 1×10⁻⁸ nm, 2×10⁻⁸ nm, 3×10⁻⁸ nm, 4×10⁻⁸ nm, 5×10⁻⁸ nm, 6×10⁻⁸ nm, 7×10⁻⁸ nm, 8×10⁻⁸ nm, 9×10⁻⁸ nm, 1×10⁻⁷ nm, 2×10⁻⁷ nm, 3×10⁻⁷ nm, 4×10⁻⁷ nm, 5×10⁻⁷ nm, 6×10⁻⁷ nm, 7×10⁻⁷ nm, 8×10⁻⁷ nm, 9×10⁻⁷ nm, 1×10⁻⁶ nm, 2×10⁻⁶ nm, 3×10⁻⁶ nm, 4×10⁻⁶ nm, 5×10⁻⁶ nm, 6×10⁻⁶ nm, 7×10⁻⁶ nm, 8×10⁻⁶ nm, 9×10⁻⁶ nm, 1×10⁻⁵ nm, 2×10⁻⁵ nm, 3×10⁻⁵ nm, 4×10⁻⁵ nm, 5×10⁻⁵ nm, 6×10⁻⁵ nm, 7×10⁻⁵ nm, 8×10⁻⁵ nm, 9×10⁻⁵ nm, 1×10⁻⁴ nm, 2×10⁻⁴ nm, 3×10⁻⁴ nm, 4×10⁻⁴ nm, 5×10⁻⁴ nm, 6×10⁻⁴ nm, 7×10⁻⁴ nm, 8×10⁻⁴ nm, 9×10⁻⁴ nm, 1×10⁻³ nm, or more. The lasers may emit light having a bandwidth of at most about 1×10⁻³ nm, 9×10⁻⁴ nm, 8×10⁻⁴ nm, 7×10⁻⁴ nm, 6×10⁻⁴ nm, 5×10⁻⁴ nm, 4×10⁻⁴ nm, 3×10⁻⁴ nm, 2×10⁻⁴ nm, 1×10⁻⁴ nm, 9×10⁻⁵ nm, 8×10⁻⁵ nm, 7×10⁻⁵ nm, 6×10⁻⁵ nm, 5×10⁻⁵ nm, 4×10⁻⁵ nm, 3×10⁻⁵ nm, 2×10⁻⁵ nm, 1×10⁻⁵ nm, 9×10⁻⁶ nm, 8×10⁻⁶ nm, 7×10⁻⁶ nm, 6×10⁻⁶ nm, 5×10⁻⁶ nm, 4×10⁻⁶ nm, 3×10⁻⁶ nm, 2×10⁻⁶ nm, 1×10⁻⁶ nm, 9×10⁻⁷ nm, 8×10⁻⁷ nm, 7×10⁻⁷ nm, 6×10⁻⁷ nm, 5×10⁻⁷ nm, 4×10⁻⁷ nm, 3×10⁻⁷ nm, 2×10⁻⁷ nm, 1×10⁻⁷ nm, 9×10⁻⁸ nm, 8×10⁻⁸ nm, 7×10⁻⁸ nm, 6×10⁻⁸ nm, 5×10⁻⁸ nm, 4×10⁻⁸ nm, 3×10⁻⁸ nm, 2×10⁻⁸ nm, 1×10⁻⁸ nm, 9×10⁻⁹ nm, 8×10⁻⁹ nm, 7×10⁻⁹ nm, 6×10⁻⁹ nm, 5×10⁻⁹ nm, 4×10⁻⁹ nm, 3×10⁻⁹ nm, 2×10⁻⁹ nm, 1×10⁻⁹ nm, 9×10⁻¹⁰ nm, 8×10⁻¹⁰ nm, 7×10⁻¹⁰ nm, 6×10⁻¹⁰ nm, 5×10⁻¹⁰ nm, 4×10⁻¹⁰ nm, 3×10⁻¹⁰ nm, 2×10⁻¹⁰ nm, 1×10⁻¹⁰ nm, 9×10⁻¹¹ nm, 8×10⁻¹¹ nm, 7×10⁻¹¹ nm 6×10⁻¹¹ nm, 5×10⁻¹¹ nm, 4×10⁻¹¹ nm, 3×10⁻¹¹ nm, 2×10⁻¹¹ nm, 1×10⁻¹¹ nm, 9×10⁻¹² nm, 8×10⁻¹² nm, 7×10⁻¹² nm, 6×10⁻¹² nm, 5×10⁻¹² nm, 4×10⁻¹² nm, 3×10⁻¹² nm, 2×10⁻¹² nm, 1×10⁻¹² nm, 9×10⁻¹³ nm, 8×10⁻¹³ nm, 7×10⁻¹³ nm, 6×10⁻¹³ nm, 5×10⁻¹³ nm, 4×10⁻¹³ nm, 3×10⁻¹³ nm, 2×10⁻¹³ nm, 1×10⁻¹³ nm, 9×10⁻¹⁴ nm, 8×10⁻¹⁴ nm, 7×10⁻¹⁴ nm, 6×10⁻¹⁴ nm, 5×10⁻¹⁴ nm, 4×10⁻¹⁴ nm, 3×10⁻¹⁴ nm, 2×10⁻¹⁴ nm, 1×10⁻¹⁴ nm, 9×10⁻¹⁵ nm, 8×10⁻¹⁵ nm, 7×10⁻¹⁵ nm, 6×10⁻¹⁵ nm, 5×10⁻¹⁵ nm, 4×10⁻¹⁵ nm, 3×10⁻¹⁵ nm, 2×10⁻¹⁵ nm, 1×10⁻¹⁵ nm, or less. The lasers may emit light having a bandwidth that is within a range defined by any two of the preceding values.

The light sources may be configured to emit light tuned to one or more magic wavelengths corresponding to the plurality of atoms. A magic wavelength corresponding to an atom may comprise any wavelength of light that gives rise to equal or nearly equal polarizabilities of the first and second atomic states. The magic wavelengths for a transition between the first and second atomic states may be determined by calculating the wavelength-dependent polarizabilities of the first and second atomic states and finding crossing points. Light tuned to such a magic wavelength may give rise to equal or nearly equal differential light shifts in the first and second atomic states, regardless of the intensity of the light emitted by the light sources. This may effectively decouple the first and second atomic states from motion of the atoms. The magic wavelengths may utilize one or more scalar or tensor light shifts. The scalar or tensor light shifts may depend on magnetic sublevels within the first and second atomic states.

For instance, group III atoms and metastable states of alkaline earth or alkaline earth-like atoms may possess relatively large tensor shifts whose angle relative to an applied magnetic field may be tuned to cause a situation in which scalar and tensor shifts balance and give a zero or near zero differential light shift between the first and second atomic states. The angle θ may be tuned by selecting the polarization of the emitted light. For instance, when the emitted light is linearly polarized, the total polarizability α may be written as a sum of the scalar component α_{scalar} and the tensor component αₜₑₙₛₒᵣ:

$$α = {α}_{scalar} + ( 3 cos {θ}^{2} - 1 ) {α}_{tensor}$$

By choosing θ appropriately, the polarizability of the first and second atomic states may be chosen to be equal or nearly equal, corresponding to a zero or near zero differential light shift and the motion of the atoms may be decoupled.

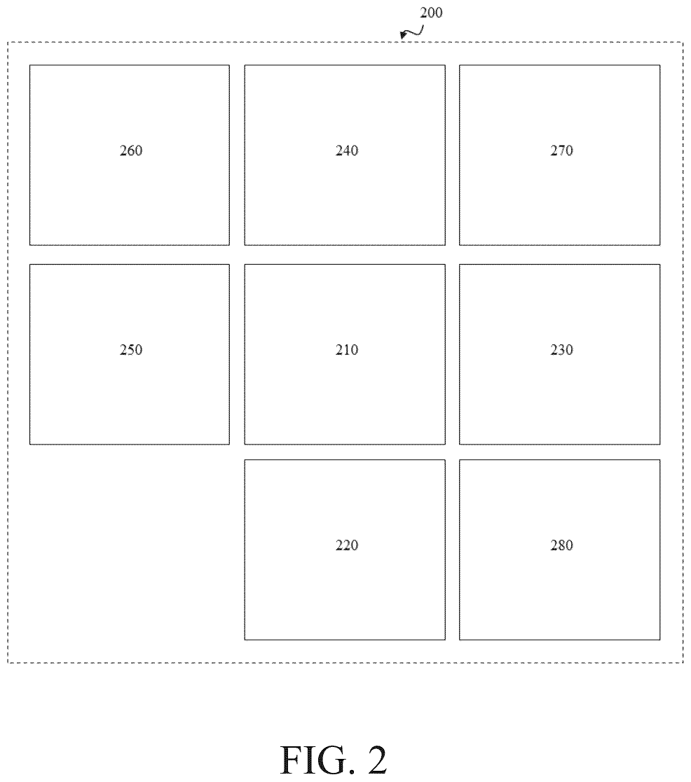

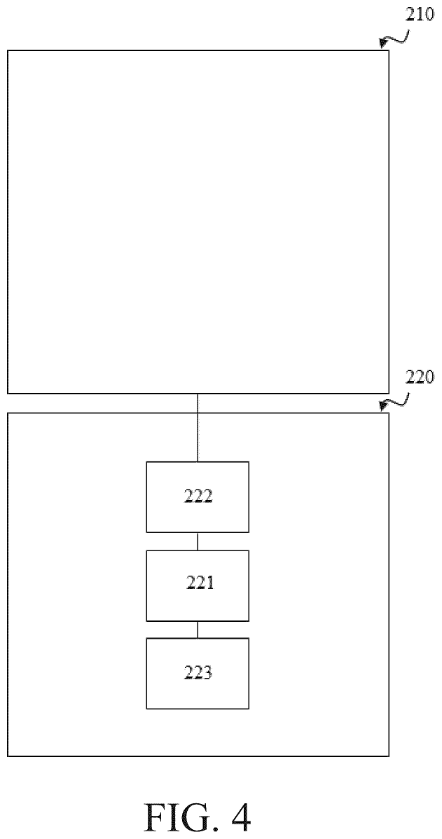

In some cases, the apparatus further comprises an optical modulator (OM). The light sources may be configured to direct light to one or more OMs configured to selectively apply the electromagnetic energy to one or more atoms of the plurality of atoms. For instance, the electromagnetic delivery unit may comprise OM (e.g., OM 222 in FIG. 2). Although depicted as comprising a single OM in FIG. 4, the electromagnetic delivery unit may comprise any number of OMs, such as at least about 1, 2, 3, 4, 5, 6, 7, 8, 9, 10, or more OMs or at most about 10, 9, 8, 7, 6, 5, 4, 3, 2, or 1 OMs. The OMs may comprise one or more spatial light modulators (SLMs), acousto-optic deflectors (AODs), or acousto-optic modulator (AOMs). The OMs may comprise one or more DMDs. The OMs may comprise one or more liquid crystal devices, such as one or more LCoS devices or diffractive optical element (DOE). In some cases, the SLM may be active or passive. In some instances, a phase or amplitude of light generated by the SLM may be modulated.

In some instances, the optical modulator may be configured to generate an array of spots of light. In some cases, the array of spots of light comprises an array of tweezers. In some cases, each of the focused spots of light of the array may be separated by a distance. In some instances, the distances may be defined as the dimension between a first center of a first focused spot of light and a second center of a second focused spot. In some cases, the distance may be about 50 nm, about 100 nm, about 150 mm, about 200 nm, about 250 nm, about 300 mm, about 350 mm, about 400 nm, about 450 nm, about 500 nm, about 550 nm, about 600 nm, about 650 nm, about 700 nm, about 750 mm, about 800 nm, about 850 nm, about 900 nm, about 950 nm, about 1.0 μm, about 1.1 μm, about 1.2 μm, about 1.3 μm, about 1.4 μm, about 1.5 μm, about 1.6 μm, about 1.7 μm, about 1.8 μm, about 1.9 μm, about 2.0 μm, about 2.1 μm, about 2.2 μm, about 2.3 μm, about 2.4 μm, about 2.5 μm, about 2.6 μm, about 2.7 μm, about 2.8 μm, about 2.9 μm, about 3.0 μm, about 3.1 μm, about 3.2 μm, about 3.3 μm, about 3.4 μm, about 3.5 μm, about 3.6 μm, about 3.7 μm, about 3.8 μm, about 3.9 μm, about 4.0 μm, about 4.1 μm, about 4.2 μm, about 4.3 μm, about 4.4 μm, about 4.5 μm, about 4.6 μm, about 4.7 μm, about 4.8 μm, about 4.9 μm, about 5.0 μm, about 6.0 μm, about 7.0 μm, about 8.0 μm, about 9.0 μm, about 10 μm, about 20 μm, about 30 μm, about 40 μm, about 50 μm, about 60 μm, about 70 μm, about 80 μm, about 90 μm, or about 100 μm. The distance may be at most about 100 μm, about 90 μm, about 80 μm, about 70 μm, about 60 μm, about 50 μm, about 40 μm, about 30 μm, about 20 μm, or about 10 μm. In some instances, the distance may be at least about 50 mm, about 100 nm, about 200 mm, about 300 nm, about 400 mm, about 500 mm, about 600 nm, about 700 mm, about 800 mm, about 900 mm, about 1 μm, about 2 μm, about 3 μm, about 4 μm, about 5 μm, about 6 μm, about 7 μm, about 8 μm, about 9 μm, or about 10 μm.

In some cases, the apparatus further comprises a third optical component. In some cases, the third optical component may be interspaced between the first optical component and an optical modulator. In some cases, the third optical component comprises a beam splitter, such as beam splitter 1130 or beam splitter 1230 in FIG. 11 or 12, respectively.

### Atom Rearrangement Unit

The present disclosure provides systems for addressing a subset of atoms in an array. In some instances, the system comprises an atom rearrangement unit (ARU). The ARU may comprise an apparatus. The apparatus may comprise a plurality of elements operably coupled to a digital device. The plurality of elements may be configured to (i) to direct a plurality of a plurality of incident laser beams in a direction or (ii) to direct a portion of the plurality of incident laser beams onto the array. The apparatus may further comprise at least one lens.

In some cases, the apparatus further comprises a chamber. The chamber may comprise one or more optical trapping units configured to generate a plurality of spatially distinct optical trapping sites. The plurality of optical trapping sites is configured to trap a plurality of atoms. In some instances, the plurality of atoms may comprise one or more qubits. For example, the plurality of atoms may be configured to be usable as one or more qubits. The one or more qubits may be configured to perform a non-classical computation (e.g., a non-classical computation as described elsewhere herein). For example, the one or more qubits can be configured to perform a gate-based quantum computation. In another example, the one or more qubits may be configured to perform a quantum computation. The plurality of atoms may comprise at least about 1, 2, 3, 4, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 300, 400, 500, or more atoms. The one or more atoms may comprise at most about 500, 400, 300, 200, 190, 180, 170, 160, 150, 140, 130, 120, 110, 100, 95, 90, 85, 80, 75, 70, 65, 60, 55, 50, 45, 40, 35, 30, 25, 20, 15, 10, 5, 4, 3, 2, or fewer atoms. The plurality of atoms may comprise a number of atoms as defined by any two of the proceeding values. For example, the one or more atoms may comprise from about 75 to about 150 atoms. The one or more atoms may comprise neutral atoms. For example, the one or more atoms may comprise atoms that are not ionized (e.g., are in a neutral state). Each atom of the one or more atoms may be a neutral atom. For example, each atom of an array of atoms can be not ionized. The one or more atoms may comprise rare earth atoms (e.g., lanthanide series atoms (e.g., ytterbium, neodymium, lanthanum, erbium, etc.), scandium, yttrium, etc.), alkali atoms (e.g., sodium, potassium, etc.), alkali earth atoms (e.g., calcium, strontium (e.g., strontium—87 atoms), etc.), or the like, or any combination thereof.

Beam Deflector—In some cases, the plurality of elements may be configured to direct the array of spots of light. The plurality of elements may be oriented at an angle with respect to an incident plane. In some cases, the incident plane may be defined as a plane that is perpendicular to the plane of the plurality of elements. In some instances, a first portion of the plurality of elements may be oriented at a first angle to direct a first portion of the array of spots of light. A second portion of the plurality of elements may be oriented at a second angle to direct a second portion of the array of spots of light. In some instances, the first angle may range from −20 degrees (°) to about 0°. The second angle may range from about 0° to about +20°. In some instances, the first angle may range from −17° to about 0°. The second angle may range from about 0° to about +17°. In some instances, the first angle may range from −12° to about 0°. The second angle may range from about 0° to about +12°. In some instances, the first portion of the plurality of elements oriented at the first angle may be configured to direct the array of spots of light toward a downstream component (e.g., a chamber comprising qubits). In some cases, the second portion of the plurality of elements oriented at the second angle may be configured to direct the array of spots of light away from the downstream component. In some cases, the second portion of the plurality of elements may direct the second portion of the array of spots of light toward a beam dump.

In some cases, the plurality of elements may comprise a blazed grating. In some instances, the plurality of elements comprises a plurality of mirrors. In some instances, the plurality of elements comprises at least about 10, about 20, about 30, about 40, about 50, about 60, about 70, about 80, about 90, about 100, about 200, about 300, about 400, about 500, about 600, about 700, about 800, about 900, about 1,000, about 2,000, about 3,000, about 4,000, about 5,000, about 6,000, about 7,000, about 8,000, about 9,000, about 10,000, about 20,000, about 30,000, about 40,000, about 50,000, about 60,000, about 70,000, about 80,000, about 90,000, about 100,000, about 200,000, about 300,000, about 400,000, about 500,000, about 600,000, about 700,000, about 800,000, about 900.000, or about 1,000,000 elements, such as mirrors or individual gratings of the blazed grating. In some instances, the plurality of elements ranges from about 10,000 to about 1,000,000, from about 50,000, to about 500,000, or from about 100,000 to about 200,000 elements. In some cases, each of the plurality of elements is spatially separated by at least about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, or about 10 μm.

In some instances, each of the plurality of elements comprises a surface area. The surface area of each element may range from may range from about 1 μm² to about 10 mm², from about 5 μm² to about 5 mm², from about 10 μm² to about 1 mm², or from about 100 μm² to about 500 μm². In some instances, the surface area of each element is at least 1 μm², about 2 μm², about 3 μm², about 4 μm², about 5 μm², about 6 μm², about 7 μm², about 8 μm², about 9 μm², about 10 μm², about 20 μm², about 30 μm², about 40 μm², about 50 μm², about 60 μm², about 70 μm², about 80 μm², about 90 μm², about 100 μm², about 200 μm², about 300 μm², about 400 μm², about 500 μm², about 600 μm², about 700 μm², about 800 μm², about 900 μm², about 1 mm², about 2 mm², about 3 mm², about 4 mm², about 5 mm², about 6 mm², about 7 mm², about 8 mm², about 9 mm², or about 10 mm². In some embodiments, the surface may be at most 10 mm², about 9 mm², about 8 mm², about 7 mm², about 6 mm², about 5 mm², about 4 mm², about 3 mm², about 2 mm², about 1 mm², about 900 μm², about 800 μm², about 700 μm², about 600 μm², or about 500 μm².

In some instances, each of the plurality of elements comprises a dimension, such as a diameter. The diameter of each of the plurality of elements may be about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 25 μm, about 30 μm, about 40 μm, or about 50 μm. The diameter of each of the plurality of elements may be at most about 40 μm about 30 μm, about 25 μm, about 20 μm, about 19 μm, about 18 μm, about 17 μm, about 16 μm, about 15 μm, about 14 μm, about 13 μm, about 12 μm, about 11 μm, or about 10 μm. The diameter may be at least about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, or about 9 μm.

In some instances, the plurality of elements comprises a plurality of mirrors. Each of the plurality of mirrors may have a diameter that is substantially the same. In some instances, the plurality of mirrors may comprise a flat mirror, a concave mirror, or a combination thereof. In some instances, the plurality of mirrors may comprise a coating.

In some cases, the plurality of mirrors is a digital micromirror device (DMD). In some cases, the DMD is mounted onto a stage, wherein the stage is configured to rotate along three degrees of freedom. In some cases, when a DMD is used, the incident plane is relative to the stage, and each of the plurality of elements may be oriented at an angle relative to the incident plane. In some instances, the apparatus further comprises a controller operably coupled to the plurality of elements, such as the DMD. In some cases, the controller may orient a first portion of the plurality of elements at a first angle. The controller may orient a second portion of the plurality of elements at a second angle. The controller may refresh or change the orientation of the first portion and the second portion at a refresh rate. In some instances, the refresh rate ranges from about 100 Hz to about 100 kHz, about 200 Hz to about 900 kHz, from about 300 Hz to about 800 kHz, from about 500 Hz to about 700 kHz, from about 1 kHz to about 500 kHz, or from about 20 kHz to about 250 kHz. In some instances, the refresh rate is at least about 10 kHz, about 20 kHz, about 30 kHz, about 40 kHz, about 50 kHz, about 60 kHz, about 70 kHz, about 80 kHz, about 90 kHz, about 100 kHz, about 200 kHz, about 300 kHz, about 400 kHz, or about 500 kHz.

In some instances, the DMD may be configured to generate a pattern of spots of light. In some instances, the DMD may generate a pattern based on a refresh rate. The refresh rate may correspond to a rate at which elements (e.g., mirrors) may change an orientation as a function of time. For example, when the refresh rate is about 30 kHz, a pattern of spots of light may be generated approximately every 30 microseconds (μs). In some instances, a pattern of spots of light may generated every about 10 μs, about 20 μs, about 30 μs, about 40 μs, about 50 μs, about 60 μs, about 70 μs, about 80 μs, about 90 μs, about 100 μs, about 200 μs, about 300 μs, about 400 μs, about 500 μs, about 600 μs, about 700 μs, about 800 μs, about 900 μs, or about 1 ms. In some instances, a pattern of spots of light may generated at most every about about 1 ms, about 900 μs, about 800 μs, about 700 μs, about 600 μs, about 500 μs, about 400 μs, about 300 μs, about 200 μs, or about 100 μs.

In some instances, the DMD may further comprise a filter.

First Optical Component—In some cases, the apparatus of the system further comprises a first optical component. In some instances, the first optical component comprises a lens, a beam splitter, a mirror, a polarizer, a waveplate, or a combination thereof. In some instances, the first optical component comprises a first lens having a first focal length (f₀). In some cases, the plurality of elements is located at a distance (d) from the first optical component, such as the first lens.

As generally illustrated in FIG. 10A, an apparatus 1000 may comprise an array of spots of light 1001 and a plurality of elements 1005. The plurality of elements 1005 may comprise mirrors. The apparatus 1000 may further comprise a first optical component 1010. In some cases, the first optical component 1010 comprises a dimension. The dimension may comprise a focal length. In some cases, the first optical component comprises a first lens that has a first focal length (f₀). In some cases, the plurality of elements 1005 may be placed at a distance (d) that is substantially similar to f₀, wherein the distance corresponds to a length between a center of the first optical component 1010 and the plurality of mirrors 1005.

In some cases, each of the array of spots of light may comprise a beam waist. The beam waist may be smaller than a dimension of the plurality of elements, such as a length, a height, a diameter, or a pitch. In some cases, the beam waist is at least about 10%, about 20%, about 30%, about 40%, about 50%, about 60%, about 70%, about 80%, or about 90% smaller than the dimension of the plurality of elements. For example, as in FIG. 10A, a pitch of a mirror of the plurality of mirrors 1005 may comprise a pitch, and the beam waist of a spot of the array of spots may have a diameter smaller than the pitch of the mirror.

Relay Optics—In some cases, the apparatus of the system may comprise a relay component. The relay component may be configured to propagate the array of spots of light. The relay component may direct the array of spots along an optical path. The relay component comprises a lens, a beam splitter, a mirror, a polarizer, a waveplate, or a combination thereof. The relay component may be positioned along the optical path after the plurality of elements. The relay component may be positioned between the plurality of elements and the second optical component.

As illustrated in FIG. 10A, the apparatus 1000 may comprise a relay component 1015 or a series of relay components 1015a, 1015b, 1015n, wherein n is an integer from 1 to 50. In some instances, the relay component may comprise a lens, a beam splitter, a mirror, a polarizer, a waveplate, or a combination thereof. In some instances, the relay component may comprise a pair of lenses, as illustrated in FIGS. 10A and 11. The pair of lenses may comprise a first relay lens 1015a having a first relay focal length (fₐ) and a second relay lens 1015b having a second relay focal length (f_{b}). In some instances, the first relay lens comprises a first convex lens, and the second relay lens comprises a second convex lens. In some instances, fₐ may be substantially the same as f_{b}. In some cases, fₐ may be larger than f_{b}. In some cases, fₐ may be less than f_{b}.

In some cases, the relay component may be configured to focus the array of spots of light. In some instances, the relay component may be oriented at an angle (theta, θ) relative to the incident plane. In some instances, the angle may range from about 0° to about 34°. In some cases, the first relay lens may be oriented at an angle ranging from about 12° to about 34° with respect to the first optical component. In some instances, the first relay lens may be oriented at most 34° from the first optical component, such as a first lens.

In some cases, the relay component may further comprise a relay mirror. In some cases, the relay mirror may be placed at a distance (x) from the first relay lens. In some cases, x is shorter than the focal length of the first relay lens (fₐ). In some cases, x is longer than fₐ. In some instances, the relay mirror is a folding mirror. The folding mirror may be configured to fold light 180° from an incident direction and send light in the opposite direction on the optical path.

In some instances, the relay component further comprises a relay waveplate. The relay waveplate may be positioned after a first relay lens. The first relay lens may comprise a first relay focal length (fₐ), and the relay waveplate may be placed at a distance shorter than fₐ such that the first relay lens does not focus light onto the relay waveplate. In the cases, the waveplate may be configured to select for a polarization of the array of spots of light. In some cases, the waveplate may be a quarter waveplate (λ/4), a half-wave plate (λ/2), or a combination thereof. In some cases, the mirror may be a flat mirror. In some cases, the mirror may further comprise a coating.

As illustrated in FIG. 12, the apparatus 1200 may comprise a second optical component 1220, wherein the second optical component comprises a mirror and a waveplate. The second optical component 1220 may be placed adjacent to a relay component 1215. The relay component 1215 may comprise a first relay lens 1215a having a first relay focal length (fₐ) and is configured to focus or to collimate light. In some cases, the relay component 1215 may be a biconvex lens, a plano-convex lens, or a multi-component lens (e.g., a doublet lens or a triplet lens). The relay component 1215 may further comprise a relay waveplate 1215b. The relay waveplate 1215b may be positioned at a distance from the first relay lens 1215a shorter than fₐ. The apparatus 1200 may further comprise an optical modulator 1225.

The array of spots of light 1201 may be focused onto the elements of the plurality of elements 1205. The first portion of the array of spots may pass through the waveplate and be reflected by the mirror. The reflected array of spots may pass through the waveplate and through the first relay lens 1215a toward the plurality of elements 1205. The first relay lens 1215a may focus the array of spots onto the plurality of elements 1205 to provide an array of refocused spots. The array of refocused spots may be aligned onto each of the elements of the plurality of elements 1205. The array of refocused spots may be reflected off of the elements of the plurality of elements 1205 and directed toward the first optical component 1210 to provide an array of spots. The array of spots may be refocused or recollimated through the first optical component 1210 to provide an array of focused spots of light or a bundle of collimated light. The array of focused spots of light or a bundle of collimated light may be directed toward a polarizing beam splitter (PBS) 1230. The PBS 1230 may be situated between the first optical component 1210 and the optical modulator 1225.

Second Optical Component—In some cases, the apparatus of the system further comprises a second optical component. The second optical component may comprise a lens, a beam splitter, a mirror, a polarizer, a waveplate, or a combination thereof.

In some cases, the second optical component comprises a second plurality of elements. The second plurality of elements may comprise a plurality of blazed gratings, mirrors, or a combination thereof. In some instances, the second plurality of elements comprises at least about 10, about 20, about 30, about 40, about 50, about 60, about 70, about 80, about 90, about 100, about 200, about 300, about 400, about 500, about 600, about 700, about 800, about 900, about 1,000, about 2,000, about 3,000, about 4,000, about 5,000, about 6,000, about 7,000, about 8,000, about 9,000, or about 10,000 elements, such as blazed gratings or mirrors. In some cases, each of the second plurality of elements is spatially separated by at least about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, or about 10 μm.

In some instances, each of the second plurality of elements comprises a surface area. The surface area of each element may range from about may range from about 1 μm² to about 10 mm², from about 5 μm² to about 5 mm², from about 10 μm² to about 1 mm², or from about 100 μm² to about 500 μm². In some instances, the surface area of each element is at least 1 μm², about 2 μm², about 3 μm², about 4 μm², about 5 μm², about 6 μm², about 7 μm², about 8 μm², about 9 μm², about 10 μm², about 20 μm², about 30 μm², about 40 μm², about 50 μm², about 60 μm², about 70 μm², about 80 μm², about 90 μm², about 100 μm², about 200 μm², about 300 μm², about 400 μm², about 500 μm², about 600 μm², about 700 μm², about 800 μm², about 900 μm², about 1 mm², about 2 mm², about 3 mm², about 4 mm², about 5 mm², about 6 mm², about 7 mm², about 8 mm², about 9 mm², or about 10 mm². In some embodiments, the surface may be at most 10 mm², about 9 mm², about 8 mm², about 7 mm², about 6 mm², about 5 mm², about 4 mm², about 3 mm², about 2 mm², about 1 mm², about 900 μm², about 800 μm², about 700 μm², about 600 μm², or about 500 μm².

In some instances, each of the second plurality of elements comprises a dimension, such as a diameter. The diameter of each of the plurality of elements may be about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 25 μm, about 30 μm, or about 40 μm. The diameter of each of the plurality of elements may be at most about 40 μm about 30 μm, about 25 μm, about 20 μm, about 19 μm, about 18 μm, about 17 μm, about 16 μm, about 15 μm, about 14 μm, about 13 μm, about 12 μm, about 11 μm, or about 10 μm. The diameter may be at least about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, or about 9 μm. In some instances, the second plurality of elements comprises a plurality of mirrors. Each of the second plurality of mirrors may have a diameter that is substantially the same. In some instances, the second plurality of mirrors may comprise a flat mirror, a concave mirror, or a combination thereof. In some instances, the second plurality of mirrors may comprise a coating.

In some cases, the second plurality of elements is a digital micromirror device (DMD). In some instances, the second plurality of elements comprises a second plurality of mirrors. In some instances, the second plurality of mirrors may prevent or compensate for defocusing or shrinkage of each of the focused spots of light of the array of light. In some cases, the DMD is mounted onto a stage, wherein the stage is configured to rotate along three degrees of freedom. In some cases, when a DMD is used, the incident plane is relative to the stage, and each of the plurality of elements may be oriented at an angle relative to the incident plane. As illustrated in FIG. 11, an apparatus 1100 may comprise a first plurality of elements 1105 comprising a first DMD. The apparatus 1100 may comprise a second optical component 1120, wherein the second optical component 1120 comprises a second plurality of elements. In some cases, the second plurality of elements is a second DMD 1120. As illustrated in FIG. 11, at least two relay components, 1115a and 1115b, may be used. The first relay component 1115a may comprise a lens having a focal length (fₐ). The second relay component 1115b may comprise a lens having a focal length (f_{b}). An array of spots of light may be focused onto the first DMD, and the reflected light may be refocused as it passes through the relay component 1115a. In some instances, the array of refocused spots of light may pass through a conjugate plane. As the array of refocused spots passes through the conjugate plane, the spots of the array of spots may diffuse. As the array of diffuse spots pass through the relay component 1115b, the relay component 1115b may refocus the spots of the array onto the second DMD, such that each of the refocused spots of the array is aligned with each of the mirrors of the second DMD 1120. The second DMD may be operably coupled to a second digital device, which may control an orientation of a first portion of second DMD mirrors and a second portion of second DMD mirrors. The orientation of the first portion of second DMD mirrors may be configured to direct spots of the refocused spots of the array of refocused spots. In some cases, the array of refocused spots may be directed towards a downstream component (e.g., a chamber comprising qubits). The directed light may comprise an output beam. A second portion of the second DMD mirrors may direct light away from the downstream component, such as toward a beam dump.

In some instances, the apparatus further comprises a controller operably coupled to the second plurality of elements 1120. In some cases, the controller may orient a first portion of the second plurality of elements at a first angle. The controller may orient a second portion of the second plurality of elements at a second angle. The controller may refresh or change the orientation of the first portion and the second portion at a refresh rate. In some instances, the refresh rate ranges from about 100 Hz to about 100 kHz, about 200 Hz to about 900 kHz, from about 300 Hz to about 800 kHz, from about 500 Hz to about 700 kHz, from about 1 kHz to about 500 kHz, or from about 20 kHz to about 250 kHz. In some instances, the refresh rate is at least about 10 kHz, about 20 kHz, about 30 kHz, about 40 kHz, about 50 kHz, about 60 kHz, about 70 kHz, about 80 kHz, about 90 kHz, about 100 kHz, about 200 kHz, about 300 kHz, about 400 kHz, or about 500 kHz.

Light Source—In some cases, the apparatus of the system may be in communication with a plurality of light sources. The plurality of light sources may comprise a coherent light source. The coherent light source may comprise lasers. The lasers may emit light comprising one or more wavelengths in the ultraviolet (UV), visible, or infrared (IR) portions of the electromagnetic spectrum. The lasers may emit light comprising one or more wavelengths of at least about 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, 1,010 nm, 1,020 nm, 1,030 nm, 1,040 nm, 1,050 nm 1,060 nm 1,070 nm, 1,080 nm, 1,090 nm, 1,100 nm 1,110 nm, 1,120 nm 1,130 nm 1,140 nm, 1,150 nm, 1,160 nm, 1,170 nm, 1,180 nm, 1,190 nm, 1,200 nm, 1,210 nm 1.220 nm, 1,230 nm, 1,240 nm, 1,250 nm, 1,260 nm, 1,270 nm, 1,280 nm, 1,290 nm, 1,300 nm, 1,310 nm, 1,320 nm, 1,330 nm, 1,340 nm, 1,350 nm, 1,360 nm, 1,370 nm, 1,380 nm, 1,390 nm, 1,400 nm, or more. The lasers may emit light comprising one or more wavelengths of at most about 1,400 nm, 1,390 nm, 1,380 nm, 1.370 nm, 1,360 nm, 1,350 nm, 1,340 nm, 1,330 nm, 1,320 nm, 1,310 nm, 1,300 nm, 1,290 nm, 1,280 nm, 1,270 nm, 1,260 nm, 1,250 nm, 1,240 nm, 1,230 nm, 1,220 nm, 1,210 nm, 1,200 nm, 1,190 nm, 1,180 nm, 1,170 nm 1,160 nm 1,150 nm, 1,140 nm, 1,130 nm, 1,120 nm, 1,110 nm, 1,100 nm, 1,090 nm, 1,080 nm, 1.070 nm, 1,060 nm, 1,050 nm, 1,040 nm, 1,030 nm, 1,020 nm, 1,010 nm, 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, 390 nm, 380 nm, 370 nm, 360 nm, 350 nm, 340 nm, 330 nm, 320 nm, 310 nm, 300 nm, 290 nm, 280 nm, 270 nm, 260 nm, 250 nm, 240 nm, 230 nm, 220 nm, 210 nm, 200 nm. The lasers may emit light comprising one or more wavelengths that are within a range defined by any two of the preceding values. The coherent light source may be configured to emit light having one or more wavelengths of light ranging from about 200 nm to about 2,000 nm.

The lasers may emit light having a bandwidth of at least about 1×10⁻¹⁵ nm, 2×10⁻¹⁵ nm, 3×10⁻¹⁵ nm, 4×10⁻¹⁵ nm, 5×10⁻¹⁵ nm, 6×10⁻¹⁵ nm, 7×10⁻¹⁵ nm, 8×10⁻¹⁵ nm, 9×10⁻¹⁵ nm, 1×10⁻¹⁴ nm, 2×10⁻¹⁴ nm, 3×10⁻¹⁴ nm, 4×10⁻¹⁴ nm, 5×10⁻¹⁴ nm, 6×10⁻¹⁴ nm, 7×10⁻¹⁴ nm, 8×10⁻¹⁴ nm, 9×10⁻¹⁴ nm, 1×10⁻¹³ nm, 2×10⁻¹³ nm, 3×10⁻¹³ nm, 4×10⁻¹³ nm, 5×10⁻¹³ nm, 6×10⁻¹³ nm, 7×10⁻¹³ nm, 8×10⁻¹³ nm, 9×10⁻¹³ nm, 1×10⁻¹² nm, 2×10⁻¹² nm, 3×10⁻¹² nm, 4×10⁻¹² nm, 5×10⁻¹² nm, 6×10⁻¹² nm, 7×10⁻¹² nm, 8×10⁻¹² nm, 9×10⁻¹² nm, 1×10⁻¹¹ nm, 2×10⁻¹¹ nm, 3×10⁻¹¹ nm, 4×10⁻¹¹ nm, 5×10⁻¹¹ nm, 6×10⁻¹¹ nm, 7×10⁻¹¹ nm, 8×10⁻¹¹ nm, 9×10⁻¹¹ nm, 1×10⁻¹⁰ nm, 2×10⁻¹⁰ nm, 3×10⁻¹⁰ nm, 4×10⁻¹⁰ nm, 5×10⁻¹⁰ nm, 6×10⁻¹⁰ nm, 7×10⁻¹⁰ nm, 8×10⁻¹⁰ nm, 9×10⁻¹⁰ nm, 1×10⁻⁹ nm, 2×10⁻⁹ nm, 3×10⁻⁹ nm, 4×10⁻⁹ nm, 5×10⁻⁹ nm, 6×10⁻⁹ nm, 7×10⁻⁹ nm, 8×10⁻⁹ nm, 9×10⁻⁹ nm, 1×10⁻⁸ nm, 2×10⁻⁸ nm, 3×10⁻⁸ nm, 4×10⁻⁸ nm, 5×10⁻⁸ nm, 6×10⁻⁸ nm, 7×10⁻⁸ nm, 8×10⁻⁸ nm, 9×10⁻⁸ nm, 1×10⁻⁷ nm, 2×10⁻⁷ nm, 3×10⁻⁷ nm, 4×10⁻⁷ nm, 5×10⁻⁷ nm, 6×10⁻⁷ nm, 7×10⁻⁷ nm, 8×10⁻⁷ nm, 9×10⁻⁷ nm, 1×10⁻⁶ nm, 2×10⁻⁶ nm, 3×10⁻⁶ nm, 4×10⁻⁶ nm, 5×10⁻⁶ nm, 6×10⁻⁶ nm, 7×10⁻⁶ nm, 8×10⁻⁶ nm, 9×10⁻⁶ nm, 1×10⁻⁵ nm, 2×10⁻⁵ nm, 3×10⁻⁵ nm, 4×10⁻⁵ nm, 5×10⁻⁵ nm, 6×10⁻⁵ nm, 7×10⁻⁵ nm, 8×10⁻⁵ nm, 9×10⁻⁵ nm, 1×10⁻⁴ nm, 2×10⁻⁴ nm, 3×10⁻⁴ nm, 4×10⁻⁴ nm, 5×10⁻⁴ nm, 6×10⁻⁴ nm, 7×10⁻⁴ nm, 8×10⁻⁴ nm, 9×10⁻⁴ nm, 1×10⁻³ nm, or more. The lasers may emit light having a bandwidth of at most about 1×10⁻³ nm, 9×10⁻⁴ nm, 8×10⁻⁴ nm, 7×10⁻⁴ nm, 6×10⁻⁴ nm, 5×10⁻⁴ nm, 4×10⁻⁴ nm, 3×10⁻⁴ nm, 2×10⁻⁴ nm, 1×10⁻⁴ nm, 9×10⁻⁵ nm, 8×10⁻⁵ nm, 7×10⁻⁵ nm, 6×10⁻⁵ nm, 5×10⁻⁵ nm, 4×10⁻⁵ nm, 3×10⁻⁵ nm, 2×10⁻⁵ nm, 1×10⁻⁵ nm, 9×10⁻⁶ nm, 8×10⁻⁶ nm, 7×10⁻⁶ nm, 6×10⁻⁶ nm, 5×10⁻⁶ nm, 4×10⁻⁶ nm, 3×10⁻⁶ nm, 2×10⁻⁶ nm, 1×10⁻⁶ nm, 9×10⁻⁷ nm, 8×10⁻⁷ nm, 7×10⁻⁷ nm, 6×10⁻⁷ nm, 5×10⁻⁷ nm, 4×10⁻⁷ nm, 3×10⁻⁷ nm, 2×10⁻⁷ nm, 1×10⁻⁷ nm, 9×10⁻⁸ nm, 8×10⁻⁸ nm, 7×10⁻⁸ nm, 6×10⁻⁸ nm, 5×10⁻⁸ nm, 4×10⁻⁸ nm, 3×10⁻⁸ nm, 2×10⁻⁸ nm, 1×10⁻⁸ nm, 9×10⁻⁹ nm, 8×10⁻⁹ nm, 7×10⁻⁹ nm, 6×10⁻⁹ nm, 5×10⁻⁹ nm, 4×10⁻⁹ nm, 3×10⁻⁹ nm, 2×10⁻⁹ nm, 1×10⁻⁹ nm, 9×10⁻¹⁰ nm, 8×10⁻¹⁰ nm, 7×10⁻¹⁰ nm, 6×10⁻¹⁰ nm, 5×10⁻¹⁰ nm, 4×10⁻¹⁰ nm, 3×10⁻¹⁰ nm, 2×10⁻¹⁰ nm, 1×10⁻¹⁰ nm, 9×10⁻¹¹ nm, 8×10⁻¹¹ nm, 7×10⁻¹¹ nm 6×10⁻¹¹ nm, 5×10⁻¹¹ nm, 4×10⁻¹¹ nm, 3×10⁻¹¹ nm, 2×10⁻¹¹ nm, 1×10⁻¹¹ nm, 9×10⁻¹² nm, 8×10⁻¹² nm, 7×10⁻¹² nm, 6×10⁻¹² nm, 5×10⁻¹² nm, 4×10⁻¹² nm, 3×10⁻¹² nm, 2×10⁻¹² nm, 1×10⁻¹² nm, 9×10⁻¹³ nm, 8×10⁻¹³ nm, 7×10⁻¹³ nm, 6×10⁻¹³ nm, 5×10⁻¹³ nm, 4×10⁻¹³ nm, 3×10⁻¹³ nm, 2×10⁻¹³ nm, 1×10⁻¹³ nm, 9×10⁻¹⁴ nm, 8×10⁻¹⁴ nm, 7×10⁻¹⁴ nm, 6×10⁻¹⁴ nm, 5×10⁻¹⁴ nm, 4×10⁻¹⁴ nm, 3×10⁻¹⁴ nm, 2×10⁻¹⁴ nm, 1×10⁻¹⁴ nm, 9×10⁻¹⁵ nm, 8×10⁻¹⁵ nm, 7×10⁻¹⁵ nm, 6×10⁻¹⁵ nm, 5×10⁻¹⁵ nm, 4×10⁻¹⁵ nm, 3×10⁻¹⁵ nm, 2×10⁻¹⁵ nm, 1×10⁻¹⁵ nm, or less. The lasers may emit light having a bandwidth that is within a range defined by any two of the preceding values.

The light sources may be configured to emit light tuned to one or more magic wavelengths corresponding to the plurality of atoms. A magic wavelength corresponding to an atom may comprise any wavelength of light that gives rise to equal or nearly equal polarizabilities of the first and second atomic states. The magic wavelengths for a transition between the first and second atomic states may be determined by calculating the wavelength-dependent polarizabilities of the first and second atomic states and finding crossing points. Light tuned to such a magic wavelength may give rise to equal or nearly equal differential light shifts in the first and second atomic states, regardless of the intensity of the light emitted by the light sources. This may effectively decouple the first and second atomic states from motion of the atoms. The magic wavelengths may utilize one or more scalar or tensor light shifts. The scalar or tensor light shifts may depend on magnetic sublevels within the first and second atomic states.

For instance, group III atoms and metastable states of alkaline earth or alkaline earth-like atoms may possess relatively large tensor shifts whose angle relative to an applied magnetic field may be tuned to cause a situation in which scalar and tensor shifts balance and give a zero or near zero differential light shift between the first and second atomic states. The angle θ may be tuned by selecting the polarization of the emitted light. For instance, w % ben the emitted light is linearly polarized, the total polarizability α may be written as a sum of the scalar component α_{scalar} and the tensor component αₜₑₙₛₒᵣ:

$$α = {α}_{scalar} + ( 3 cos {θ}^{2} - 1 ) {α}_{tensor}$$

By choosing θ appropriately, the polarizability of the first and second atomic states may be chosen to be equal or nearly equal, corresponding to a zero or near zero differential light shift and the motion of the atoms may be decoupled.

In some cases, the apparatus further comprises an optical modulator (OM). The light sources may be configured to direct light to one or more OMs configured to selectively apply the electromagnetic energy to one or more atoms of the plurality of atoms. For instance, the electromagnetic delivery unit may comprise OM (e.g., OM 222 in FIG. 2). Although depicted as comprising a single OM in FIG. 4, the electromagnetic delivery unit may comprise any number of OMs, such as at least about 1, 2, 3, 4, 5, 6, 7, 8, 9, 10, or more OMs or at most about 10, 9, 8, 7, 6, 5, 4, 3, 2, or 1 OMs. The OMs may comprise one or more spatial light modulators (SLMs), acousto-optic deflectors (AODs), or acousto-optic modulator (AOMs). The OMs may comprise one or more DMDs. The OMs may comprise one or more liquid crystal devices, such as one or more LCoS devices or diffractive optical element (DOE). In some cases, the SLM may be active or passive. In some instances, a phase or amplitude of light generated by the SLM may be modulated.

In some instances, the optical modulator may be configured to generate an array of spots of light. In some cases, the array of spots of light comprises an array of tweezers. In some cases, each of the focused spots of light of the array may be separated by a distance. In some instances, the distances may be defined as the dimension between a first center of a first focused spot of light and a second center of a second focused spot. In some cases, the distance may be about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, about 1.0 μm, about 1.1 μm, about 1.2 μm, about 1.3 μm, about 1.4 μm, about 1.5 μm, about 1.6 μm, about 1.7 μm, about 1.8 μm, about 1.9 μm, about 2.0 μm, about 2.1 μm, about 2.2 μm, about 2.3 μm, about 2.4 μm, about 2.5 μm, about 2.6 μm, about 2.7 μm, about 2.8 μm, about 2.9 μm, about 3.0 μm, about 3.1 μm, about 3.2 μm, about 3.3 μm, about 3.4 μm, about 3.5 μm, about 3.6 μm, about 3.7 μm, about 3.8 μm, about 3.9 μm, about 4.0 μm, about 4.1 μm, about 4.2 μm, about 4.3 μm, about 4.4 μm, about 4.5 μm, about 4.6 μm, about 4.7 μm, about 4.8 μm, about 4.9 μm, about 5.0 μm, about 6.0 μm, about 7.0 μm, about 8.0 μm, about 9.0 μm, about 10 μm, about 20 μm, about 30 μm, about 40 μm, about 50 μm, about 60 μm, about 70 μm, about 80 μm, about 90 μm, or about 100 μm. The distance may be at most about 100 μm, about 90 μm, about 80 μm, about 70 μm, about 60 μm, about 50 μm, about 40 μm, about 30 μm, about 20 μm, or about 10 μm. In some instances, the distance may be at least about 50 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, or about 10 μm. In some cases, the apparatus further comprises a third optical component. In some cases, the third optical component may be interspaced between the first optical component and an optical modulator. In some cases, the third optical component comprises a beam splitter, such as beam splitter 1130 or beam splitter 1230 in FIG. 11 or 12, respectively.

### Methods for Improving Contrast

The present disclosure provides methods for improving contrast of signals on an array. In some cases, the method generates high contrast signals on an array. In some instances, the array comprises directing an array of spots of light onto a plurality of elements. In some cases, the plurality of elements is controlled by a digital device. In some cases, each of the spots of light is directed onto a separate element of the plurality of elements. In some instances, the method may further comprise orienting using the digital device the plurality of elements to direct the plurality of incident laser beams. In some instances, the elements of the DMD are individually manipulatable to steer each of the spots of light.

In some cases, the array comprises a contrast ratio. In some instances, the contrast ratio may be determined based on a comparison of relative light intensity of a spot of the array in the presence of absence of a spot of light. In some instances, the contrast ratio ranges from about 100:1 to about 50,000:1, from about 200:1 to about 40,000:1, from about 300:1 to about 30,000:1, from about 400:1 to about 20,000:1, from about 500:1 to about 10,000:1, from about 600:1 to about 9,000:1, from about 700:1 to about 8,000:1, from about 800:1 to about 7,000:1, from about 900:1 to about 6,000:1, from about 1,000:1 to about 5,000:1, or from about 2,000:1 to about 4,000:1. In some instances, the contrast ratio ranges from about 100:1 to about 1,000:1, from about 200:1 to about 2,000:1, from about 300:1 to about 3,000:1, from about 400:1 to about 4,000:1, from about 500:1 to about 5,000:1, from about 600:1 to about 6,000:1, from about 700:1 to about 7,000:1, from about 800:1 to about 8,000:1, from about 900:1 to about 9,000:1, from about 1,000:1 to about 10,000:1, from about 2,000:1 to about 20,000:1, from about 3,000:1 to about 30,000:1, from about 4,000:1 to about 40,000:1, or from about 5,000:1 to about 50,000:1. In some cases, the contrast ratio is at least about 1,000:1, about 2,000:1, about 3,000:1, about 4,000:1, about 5,000:1, about 6,000:1, about 7,000:1, about 8,000:1, about 9,000:1, about 10,000:1, about 20,000:1, about 30,000:1, about 40,000:1, or about 50,000:1. In some cases, the contrast ratio is at most about 50,000:1, about 40,000:1, about 30.000:1, about 20,000:1, about 10,000:1, about 9,000:1, about 8,000:1, about 7,000:1, about 6,000:1, about 5,000:1, about 4,000:1, about 3,000:1, about 2,000:1, or about 1,000:1.

Focusing—In some cases, the method further comprises focusing a plurality of incident laser beams through a first optical component. In some instances, passing the plurality of incident laser beams through a first optical component comprises providing an array of spots of light. In some instances, focusing a plurality of incident laser beams comprises decreasing a waist of each of the spots of the array of spots of light. The waist may be smaller than a dimension of an element of the plurality of elements. In some instances, the waist may be about 10%, about 20%, about 30%, about 40%, about 50%, about 60%, about 70%, about 80%, about 90%, or about 95% smaller than a dimension of an element of the plurality of elements. In some instances, the dimension comprises a length. In some instances, the plurality of elements comprises a plurality of blazed gratings, mirrors, microshutters, or a combination thereof.

In some instances, the method comprises separating spots of the array of spots of light by passing the array of spots of light through a first optical component. The method may further comprise providing an array of spots of light. The first optical component may comprise a focal length (f₀). In some instances, the method further comprises focusing the array of spots of light over a distance (d) that is substantially similar to f₀. In some instances, the method may further comprise focusing the array of spots onto the plurality of elements, wherein each spot of the array of spots of light is aligned with each of the elements of the plurality of elements. In some cases, the array of spots of light comprises an array of tweezers. In some cases, each of the focused spots of light of the array may be separated by a distance. In some instances, the distances may be defined as the dimension between a first center of a first focused spot of light and a second center of a second focused spot. In some cases, the distance may be about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, about 1.0 μm, about 1.1 μm, about 1.2 μm, about 1.3 μm, about 1.4 μm, about 1.5 μm, about 1.6 μm, about 1.7 μm, about 1.8 μm, about 1.9 μm, about 2.0 μm, about 2.1 μm, about 2.2 μm, about 2.3 μm, about 2.4 μm, about 2.5 μm, about 2.6 μm, about 2.7 μm, about 2.8 μm, about 2.9 μm, about 3.0 μm, about 3.1 μm, about 3.2 μm, about 3.3 μm, about 3.4 μm, about 3.5 μm, about 3.6 μm, about 3.7 μm, about 3.8 μm, about 3.9 μm, about 4.0 μm, about 4.1 μm, about 4.2 μm, about 4.3 μm, about 4.4 μm, about 4.5 μm, about 4.6 μm, about 4.7 μm, about 4.8 μm, about 4.9 μm, about 5.0 μm, about 6.0 μm, about 7.0 μm, about 8.0 μm, about 9.0 μm, about 10 μm, about 20 μm, about 30 μm, about 40 μm, about 50 μm, about 60 μm, about 70 μm, about 80 μm, about 90 μm, or about 100 μm. The distance may be at most about 100 μm, about 90 μm, about 80 μm, about 70 μm, about 60 μm, about 50 μm, about 40 μm, about 30 μm, about 20 μm, or about 10 μm. In some instances, the distance may be at least about 50 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, or about 10 μm.

Orienting—In some cases, orienting the plurality of elements comprises orienting a portion of the plurality of elements at an orientation. In some cases, the plurality of elements comprises a plurality of mirrors. In some instances, the orientation comprises an angle ranging from about −17° to about +17° relative to an incident plane. The incident plane may be defined as a plane perpendicular to a plane defined by a plane comprising the plurality of elements. In some instances, orienting the plurality of mirrors comprises orienting a first portion of the plurality of mirrors at an angle from about 0° to about +17° relative to an incident plane. In some instances, orienting the plurality of mirrors comprises orienting a second portion of the plurality of mirrors at an angle from about −17° to about +0° relative to the incident plane. In some instances, orienting the plurality of mirrors comprises orienting a first portion of the plurality of mirrors at a first angle ranging from about 0° to about +17° relative to an incident plane, and orienting a second portion of the plurality of mirrors at a second angle ranging from −17° to 0° relative to the incident plane. In some instances, the plurality of mirrors may be operably coupled to a digital device.

In some instances, the digital device may orient the first portion of the plurality of elements or the second portion of the plurality of mirrors to form a pattern. The digital device may be configured to generate a pattern via controlling the elements of the plurality of elements. Patterns may be generated based on a refresh rate. In some cases, the refresh rate corresponds to a change in the orientation of an element of the plurality of elements over time. In some instances, the refresh rate ranges from about 100 Hz to about 100 kHz, about 200 Hz to about 900 kHz, from about 300 Hz to about 800 kHz, from about 500 Hz to about 700 kHz, from about 1 kHz to about 500 kHz, or from about 20 kHz to about 250 kHz. In some instances, the refresh rate is at least about 10 kHz, about 20 kHz, about 30 kHz, about 40 kHz, about 50 kHz, about 60 kHz, about 70 kHz, about 80 kHz, about 90 kHz, about 100 kHz, about 200 kHz, about 300 kHz, about 400 kHz, or about 500 kHz.

In some cases, the method further comprises addressing an arbitrary subset of the array on a time scale. In some instances, the time scale of ranging from about 1 μs to about 100 ms, from about 2 μs to about 50 ms, from about 5 μs to about 20 ms, from about 10 μs to about 10 ms, from about 20 μs to about 5 ms, from about 50 μs to about 2 ms, from about 100 μs to about 1 ms, or from about 200 μs to about 500 μs. In some instances, the time scale is at least about 1 μs, about 2 μs, about 5 μs, about 10 μs, about 20 μs, about 50 μs, about 100 μs, about 200 μs, about 500 μs, about 1 ms, about 2 ms, about 5 ms, about 10 ms, about 20 ms, about 50 ms, or about 100 ms. In some instances, the time scale is about 1 μs, about 2 μs, about 5 μs, about 10 μs, about 20 μs, about 50 μs, about 100 μs, about 200 μs, about 500 μs, about 1 ms, about 2 ms, about 5 ms, about 10 ms, about 20 ms, about 50 ms, or about 100 ms. In some instances, the time scale is at most about 100 ms, about 50 ms, about 20 ms, about 10 ms, about 5 ms, about 2 ms, about 1 ms, about 500 μs, about 200 μs, about 100 μs, or about 50 μs.

In some cases, reflecting a portion of the plurality of incident laser beams onto the array comprises reflecting a portion of the plurality of incident laser beams onto an array of trapped atoms. In some instances, the array of trapped atoms comprises a portion of a quantum computer.

### Microshutter

The present disclosure provides apparatuses comprising an array of spots of light and a beam block comprising a plurality of elements. In some cases, each spot of the array of spots of light is aligned on each of the plurality of elements of the beam block. In some cases, the beam block comprises a microshutter array. The microshutter array may comprise a plurality of microshutters. In some instances, a first portion of the microshutters may be configured to orient a first portion of the spots of light. In some cases, the first portion of the microshutters may orient the first portion of the spots of light toward a downstream component, such as a chamber comprising one or more atoms. In some cases, a second portion of the micromirrors may be configured to orient a second portion of the spots of light toward a beam dump. In some instances, each of the microshutters may be in an open configuration or a closed configuration. In some instances, the microshutter array may be operably coupled to a controller. The controller may determine whether a microshutter of the microshutter array adopts the open configuration or the closed configuration. The controller may apply a signal to the microshutter array.

In some instances, the microshutter array may comprise at least about 10, about 20, about 30, about 40, about 50, about 60, about 70, about 80, about 90, about 100, about 200, about 300, about 400, about 500, about 600, about 700, about 800, about 900, about 1,000, about 2,000, about 3,000, about 4,000, about 5,000, about 6,000, about 7,000, about 8,000, about 9,000, or about 10,000 microshutters.

Each of the plurality of microshutters may comprise a dimension, such as a length. In some instances, the length of each of the microshutters may range from about 25 μm to about 100 μm or from about 50 μm to about 200 μm. In some instances, the each of the microshutters may be separated from adjacent microshutters by at least about 5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, about 150 nm, about 200 nm, about 250 nm, about 300 nm, about 350 nm, about 400 nm, about 450 nm, or about 500 nm.

In some cases, each spot of the array of spots of light may comprise a beam waist. The beam waist may be smaller than a dimension of the microshutter, such as a length. In some cases, the beam waist is at least about 10%, about 20%, about 30%, about 40%, about 50%, about 60%, about 70%, about 80%, or about 90% smaller than the length of the microshutter.

### Example of Systems for Performing a Non-Classical Computation

FIG. 2 shows an example of a system 200 for performing a non-classical computation. The non-classical computation may comprise a quantum computation. The quantum computation may comprise a gate-model quantum computation.

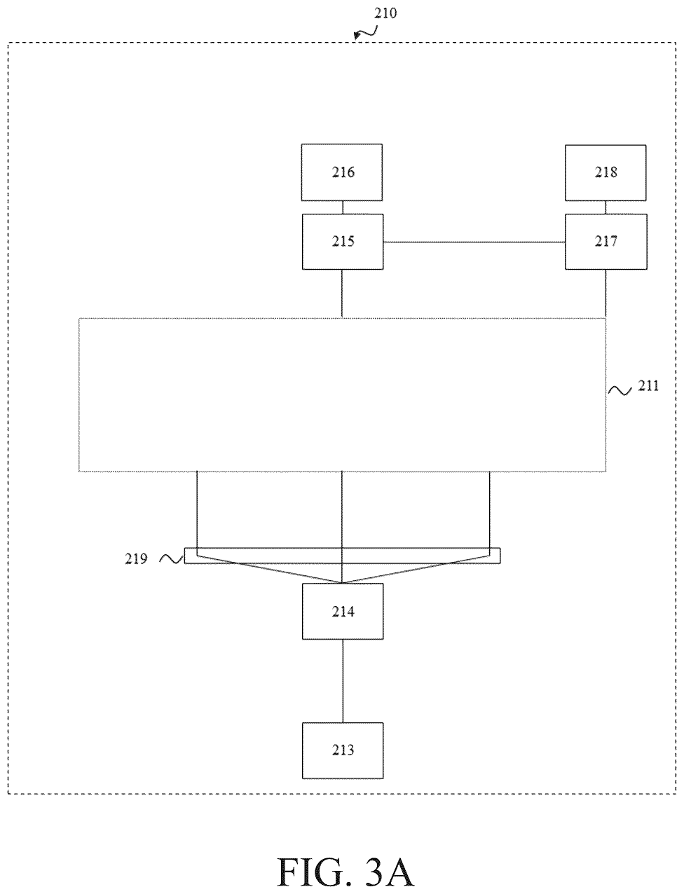

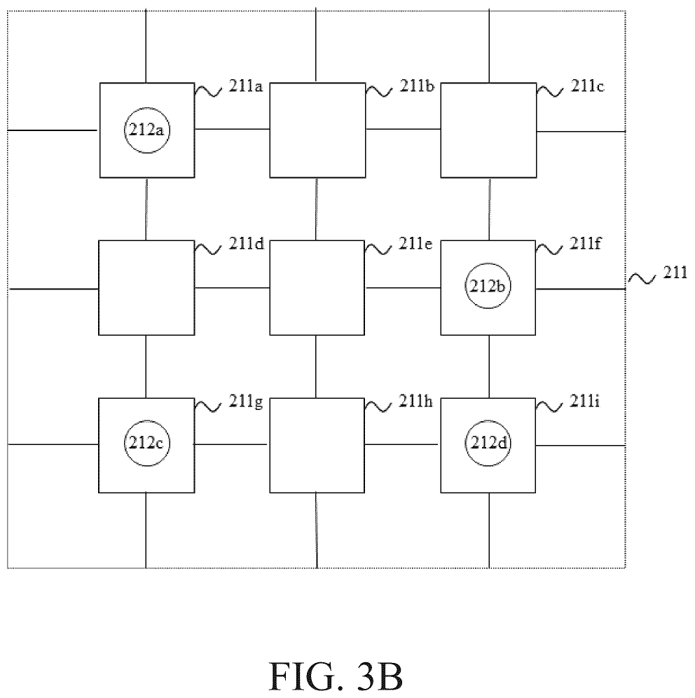

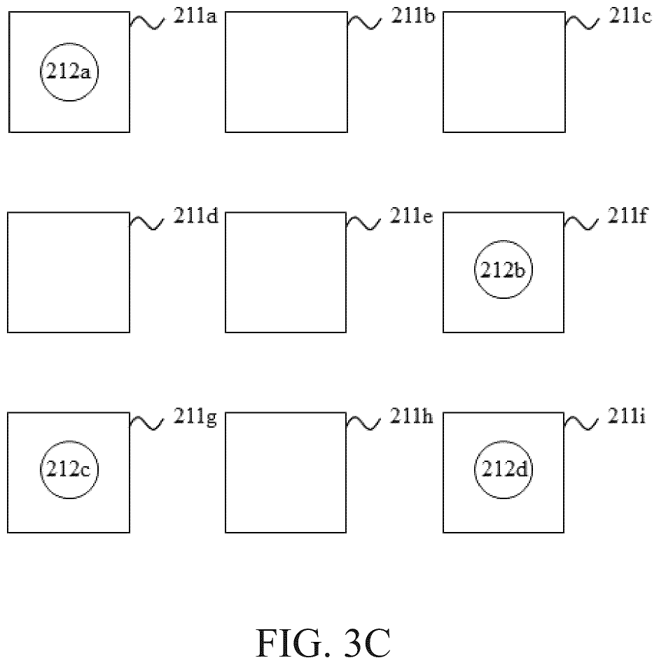

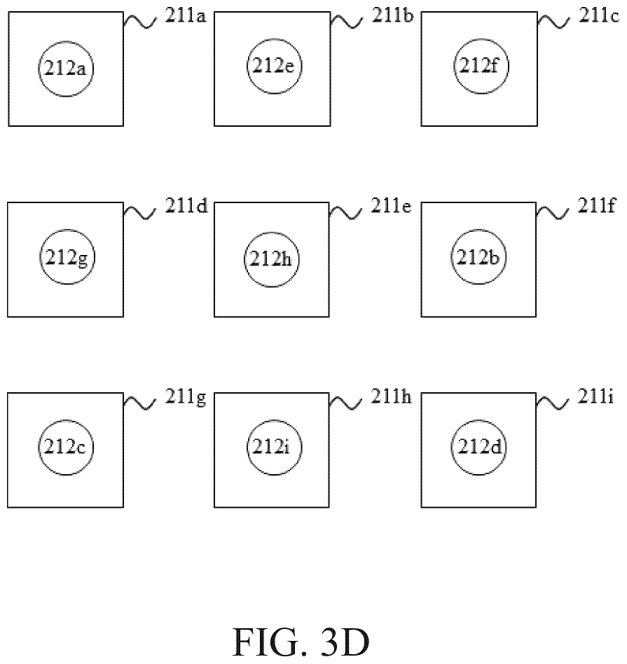

The system 200 may comprise one or more trapping units 210. The trapping units may comprise one or more optical trapping units. The optical trapping units may comprise any optical trapping unit described herein, such as an optical trapping unit described herein with respect to FIG. 3A. The optical trapping units may be configured to generate a plurality of optical trapping sites. The optical trapping units may be configured to generate a plurality of spatially distinct optical trapping sites. For instance, the optical trapping units may be configured to generate at least about 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000), or more optical trapping sites. The optical trapping units may be configured to generate at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, or fewer optical trapping sites. The optical trapping units may be configured to trap a number of optical trapping sites that is within a range defined by any two of the preceding values.

The optical trapping units may be configured to trap a plurality of atoms. For instance, the optical trapping units may be configured to trap at least about 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more atoms. The optical trapping units may be configured to trap at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, or fewer atoms. The optical trapping units may be configured to trap a number of atoms that is within a range defined by any two of the preceding values.

Each optical trapping site of the optical trapping units may be configured to trap at least about 1, 2, 3, 4, 5, 6, 7, 8, 9, 10, or more atoms. Each optical trapping site may be configured to trap at most about 10, 9, 8, 7, 6, 5, 4, 3, 2, 1, or fewer atoms. Each optical trapping site may be configured to trap a number of atoms that is within a range defined by any two of the preceding values. Each optical trapping site may be configured to trap a single atom.

One or more atoms of the plurality of atoms may comprise qubits, as described herein (for instance, with respect to FIG. 4). Two or more atoms may be quantum mechanically entangled. Two or more atoms may be quantum mechanically entangled with a coherence lifetime of at least about 1 microsecond (μs), 2 μs, 3 μs, 4 μs, 5 μs, 6 μs, 7 μs, 8 μs, 9 μs, 10 μs, 20 μs, 30 μs, 40 μs, 50 μs, 60 μs, 70 μs, 80 μs, 90 μs, 100 μs, 200 μs, 300 μs, 400 μs, 500 μs, 600 μs, 700 μs, 800 μs, 900 μs, 1 millisecond (ms), 2 ms, 3 ms, 4 ms, 5 ms, 6 ms, 7 ms, 8 ms, 9 ms, 10 ms, 20 ms, 30 ms, 40 ms, 50 ms, 60 ms, 70 ms, 80 ms, 90 ms, 100 ms, 200 ms, 300 ms, 400 ms, 500 ms, 600 ms, 700 ms, 800 ms, 900 ms, 1 second (s), 2 s, 3 s, 4 s, 5 s, 6 s, 7 s, 8 s, 9 s, 10 s, or more. Two or more atoms may be quantum mechanically entangled with a coherence lifetime of at most about 10 s, 9 s, 8 s, 7 s, 6 s, 5 s, 4 s, 3 s, 2 s, 1 s, 900 ms, 800 ms, 700 ms, 600 ms, 500 ms, 400 ms, 300 ms, 200 ms, 100 ms, 90 ms, 80 ms, 70 ms, 60 ms, 50 ms, 40 ms, 30 ms, 20 ms, 10 ms, 9 ms, 8 ms, 7 ms, 6 ms, 5 ms, 4 ms, 3 ms, 2 ms, 1 ms, 900 μs, 800 μs, 700 μs, 600 μs, 500 μs, 400 μs, 300 μs, 200 μs, 100 μs, 90 μs, 80 μs, 70 μs, 60 μs, 50 μs, 40 μs, 30 μs, 20 μs, 10 μs, 9 μs, 8 μs, 7 μs, 6 μs, 5 μs, 4 μs, 3 μs, 2 μs, 1 μs, or less. Two or more atoms may be quantum mechanically entangled with a coherence lifetime that is within a range defined by any two of the preceding values. One or more atoms may comprise neutral atoms. One or more atoms may comprise uncharged atoms.

One or more atoms may comprise alkali atoms. One or more atoms may comprise lithium (Li) atoms, sodium (Na) atoms, potassium (K) atoms, rubidium (Rb) atoms, or cesium (Cs) atoms. One or more atoms may comprise lithium—6 atoms, lithium—7 atoms, sodium—23 atoms, potassium—39 atoms, potassium—40 atoms, potassium—41 atoms, rubidium—85 atoms, rubidium—87 atoms, or caesium—133 atoms. One or more atoms may comprise alkaline earth atoms. One or more atoms may comprise beryllium (Be) atoms, magnesium (Mg) atoms, calcium (Ca) atoms, strontium (Sr) atoms, or barium (Ba) atoms. One or more atoms may comprise beryllium—9 atoms, magnesium—24 atoms, magnesium—25 atoms, magnesium—26 atoms, calcium—40 atoms, calcium—42 atoms, calcium—43 atoms, calcium—44 atoms, calcium—46 atoms, calcium—48 atoms, strontium—84 atoms, strontium—86 atoms, strontium—87 atoms, strontium—88 atoms, banum—130 atoms, barium—132 atoms, barium—133 atoms, barium—134 atoms, barium—135 atoms, barium—136 atoms, barium—137 atoms, or barium—138 atoms. One or more atoms may comprise rare earth atoms. One or more atoms may comprise scandium (Sc) atoms, yttrium (Y) atoms, lanthanum (La) atoms, cerium (Ce) atoms, praseodymium (Pr) atoms, neodymium (Nd) atoms, samarium (Sm) atoms, europium (Eu) atoms, gadolinium (Gd) atoms, terbium (Tb) atoms, dysprosium (Dy) atoms, holmium (Ho) atoms, erbium (Er) atoms, thulium (Tm) atoms, ytterbium (Yb) atoms, or lutetium (Lu) atoms. One or more atoms may comprise scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms.

The plurality of atoms may comprise a single element selected from the group consisting of Li, Na, K, Rb, Cs, Be, Mg, Ca, Sr, and Ba. The plurality of atoms may comprise a mixture of elements selected from the group consisting of Li, Na, K, Rb, Cs, Be, Mg, Ca, Sr, and Ba. The plurality of atoms may comprise a natural isotopic mixture of one or more elements selected from the group consisting of Li, Na, K, Rb, Cs, Be, Mg, Ca, Sr, and Ba. The plurality of atoms may comprise an isotopically enriched mixture of one or more elements selected from the group consisting of Li, Na, K. Rb, Cs, Be, Mg, Ca. Sr, and Ba. The plurality of atoms may comprise a natural isotopic mixture of one or more elements selected from the group consisting of Sc, Y. La, Ce, Pr, Nd, Sm, Eu, Gd, Tb, Dy, Ho, Er, Tm, Yb, and Lu. The plurality of atoms may comprise an isotopically enriched mixture of one or more elements selected from the group consisting of Sc, Y, La, Ce, Pr, Nd, Sm, Eu, Gd, Th, Dy, Ho, Er, Tm, Yb, and Lu, atoms may comprise rare earth atoms. For instance, the plurality of atoms may comprise lithium-6 atoms, lithium-7 atoms, sodium-23 atoms, potassium-39 atoms, potassium-40 atoms, potassium-41 atoms, rubidium-85 atoms, rubidium-87 atoms, caesium-133 atoms, beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium—84 atoms, strontium—86 atoms, strontium—87 atoms, strontium—88 atoms, barium-130 atoms, barium-132 atoms, barium-133 atoms, barium-134 atoms, barium-135 atoms, barium-136 atoms, barium-137 atoms, barium-138 atoms, scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms enriched to an isotopic abundance of at least about 50%, 60%, 70%, 80%, 90% 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99%, or more. The plurality of atoms may comprise lithium—6 atoms, lithium—7 atoms, sodium—23 atoms, potassium—39 atoms, potassium—40 atoms, potassium—41 atoms, rubidium—85 atoms, rubidium—87 atoms, caesium—133 atoms, beryllium—9 atoms, magnesium—24 atoms, magnesium—25 atoms, magnesium—26 atoms, calcium—40 atoms, calcium—42 atoms, calcium—43 atoms, calcium—44 atoms, calcium—46 atoms, calcium—48 atoms, strontium—84 atoms, strontium—86 atoms, strontium—87 atoms, strontium—88 atoms, barium—130 atoms, barium—132 atoms, barium—133 atoms, barium—134 atoms, barium—135 atoms, barium—136 atoms, barium—137 atoms, barium—138 atoms, scandium—45 atoms, yttrium—89 atoms, lanthanum—139 atoms, cerium—136 atoms, cerium—138 atoms, cerium—140 atoms, cerium—142 atoms, praseodymium—141 atoms, neodymium—142 atoms, neodymium—143 atoms, neodymium—145 atoms, neodymium—146 atoms, neodymium—148 atoms, samarium—144 atoms, samarium—149 atoms, samarium—150 atoms, samarium—152 atoms, samarium—154 atoms, europium—151 atoms, europium—153 atoms, gadolinium—154 atoms, gadolinium—155 atoms, gadolinium—156 atoms, gadolinium—157 atoms, gadolinium—158 atoms, gadolinium—160 atoms, terbium—159 atoms, dysprosium—156 atoms, dysprosium—158 atoms, dysprosium—160 atoms, dysprosium—161 atoms, dysprosium—162 atoms, dysprosium—163 atoms, dysprosium—164 atoms, erbium—162 atoms, erbium—164 atoms, erbium—166 atoms, erbium—167 atoms, erbium—168 atoms, erbium—170 atoms, holmium—165 atoms, thulium—169 atoms, ytterbium—168 atoms, ytterbium—170 atoms, ytterbium—171 atoms, ytterbium—172 atoms, ytterbium—173 atoms, ytterbium—174 atoms, ytterbium—176 atoms, lutetium—175 atoms, or lutetium—176 atoms enriched to an isotopic abundance of at most about 99.99%, 99.98%, 99.97%, 99.96%, 99.95%, 99.94%, 99.93%, 99.92%, 99.91%, 99.9%, 99.8%, 99.7%, 99.6%, 99.5%, 99.4%, 99.3%, 99.2%, 99.1%, 99%, 98%, 97%, 96%, 95%, 94%, 93%, 92%, 91%, 90%, 80%, 70%, 60%, 50%, or less. The plurality of atoms may comprise lithium—6 atoms, lithium—7 atoms, sodium—23 atoms, potassium—39 atoms, potassium—40 atoms, potassium—41 atoms, rubidium—85 atoms, rubidium—87 atoms, caesium—133 atoms, beryllium—9 atoms, magnesium—24 atoms, magnesium—25 atoms, magnesium—26 atoms, calcium—40 atoms, calcium—42 atoms, calcium—43 atoms, calcium—44 atoms, calcium—46 atoms, calcium—48 atoms, strontium—84 atoms, strontium—86 atoms, strontium—87 atoms, strontium—88 atoms, banum—130 atoms, barium—132 atoms, barium—133 atoms, barium—134 atoms, barium—135 atoms, barium—136 atoms, barium—137 atoms, barium—138 atoms, scandium—45 atoms, yttrium—89 atoms, lanthanum—139 atoms, cerium—136 atoms, cerium—138 atoms, cerium—140 atoms, cerium—142 atoms, praseodymium—141 atoms, neodymium—142 atoms, neodymium—143 atoms, neodymium—145 atoms, neodymium—146 atoms, neodymium—148 atoms, samarium—144 atoms, samarium—149 atoms, samarium—150 atoms, samarium—152 atoms, samarium—154 atoms, europium—151 atoms, europium—153 atoms, gadolinium—154 atoms, gadolinium—155 atoms, gadolinium—156 atoms, gadolinium—157 atoms, gadolinium—158 atoms, gadolinium—160 atoms, terbium—159 atoms, dysprosium—156 atoms, dysprosium—158 atoms, dysprosium—160 atoms, dysprosium—161 atoms, dysprosium—162 atoms, dysprosium—163 atoms, dysprosium—I64 atoms, erbium—162 atoms, erbium—164 atoms, erbium—166 atoms, erbium—167 atoms, erbium—168 atoms, erbium—170 atoms, holmium—165 atoms, thulium—169 atoms, ytterbium—168 atoms, ytterbium—170 atoms, ytterbium—171 atoms, ytterbium—172 atoms, ytterbium—173 atoms, ytterbium—174 atoms, ytterbium—176 atoms, lutetium—175 atoms, or lutetium—176 atoms enriched to an isotopic abundance that is within a range defined by any two of the preceding values.

The system 200 may comprise one or more first electromagnetic delivery units 220. The first electromagnetic delivery units may comprise any electromagnetic delivery unit described herein, such as an electromagnetic delivery unit described herein with respect to FIG. 4. The first electromagnetic delivery units may be configured to apply first electromagnetic energy to one or more atoms of the plurality of atoms. Applying the first electromagnetic energy may induce the atoms to adopt one or more superposition states of a first atomic state and a second atomic state that is different from the first atomic state.

The first atomic state may comprise a first single-qubit state. The second atomic state may comprise a second single-qubit state. The first atomic state or second atomic state may be elevated in energy with respect to a ground atomic state of the atoms. The first atomic state or second atomic state may be equal in energy with respect to the ground atomic state of the atoms.

The first atomic state may comprise a first hyperfine electronic state and the second atomic state may comprise a second hyperfine electronic state that is different from the first hyperfine electronic state. For instance, the first and second atomic states may comprise first and second hyperfine states on a multiplet manifold, such as a triplet manifold. The first and second atomic states may comprise first and second hyperfine states, respectively, on a ³P₁ or ³P₂ manifold. The first and second atomic states may comprise first and second hyperfine states, respectively, on a ³P₁ or ³P₂ manifold of any atom described herein, such as a strontium—87 ³P₁ manifold or a strontium—87 ³P₂ manifold.

In some cases, the first and second atomic states are first and second hyperfine states of a first electronic state. Optical excitation may be applied between a first electronic state and a second electronic state. The optical excitation may excite the first hyperfine state and/or the second hyperfine state to the second electronic state. A single-qubit transition may comprise a two-photon transition between two hyperfine states within the first electronic state using a second electronic state as an intermediate state. To drive a single-qubit transition, a pair of frequencies, each detuned from a single-photon transition to the intermediate state, may be applied to drive a two-photon transition. In some cases, the first and second hyperfine states are hyperfine states of the ground electronic state. The ground electronic state may not decay by spontaneous or stimulated emission to a lower electronic state. The hyperfine states may comprise nuclear spin states.

In some cases, the hyperfine states comprise nuclear spin states of a strontium—87 ¹S₀ manifold and the qubit transition drives one or both of two nuclear spin states of strontium—87 ¹S₀ to a state detuned from or within the ³P₂ or ³P₁ manifold. In some cases, the one-qubit transition is a two photon Raman transition between nuclear spin states of strontium—87 ¹S₀ via a state detuned from or within the ³P₂ or ³P₁ manifold. In some cases, the nuclear spin states may be Stark shifted nuclear spin states. A Stark shift may be driven optically. An optical Stark shift may be driven off resonance with any, all, or a combination of a single-qubit transition, a two-qubit transition, a shelving transition, an imaging transition, etc.

In some cases, the hyperfine states comprise nuclear spin states of a ytterbium

The first atomic state may comprise a first nuclear spin state and the second atomic state may comprise a second nuclear spin state that is different from the first nuclear spin state. The first and second atomic states may comprise first and second nuclear spin states, respectively, of a quadrupolar nucleus. The first and second atomic states may comprise first and second nuclear spin states, respectively, of a spin-1, spin-3/2, spin-2, spin-5/2, spin-3, spin-7/2, spin-4, or spin-9/2 nucleus. The first and second atomic states may comprise first and second nuclear spin states, respectively, of any atom described herein, such as first and second spin states of strontium—87.

For first and second nuclear spin states associated with a nucleus comprising a spin greater than 1/2 (such as a spin-1, spin-3/2, spin-2, spin-5/2, spin-3, spin-7/2, spin-4, or spin-9/2 nucleus), transitions between the first and second nuclear spin states may be accompanied by transitions between other spin states on the nuclear spin manifold. For instance, for a spin-9/2 nucleus in the presence of a uniform magnetic field, all of the nuclear spin levels may be separated by equal energy. Thus, a transition (such as a Raman transition) designed to transfer atoms from, for instance, an m_{N}=9/2 spin state to an m_{N}=7/2 spin state, may also drive m_{N}=7/2 to m_{N}=5/2, m_{N}=5/2 to m_{N}=3/2, m_{N}=3/2 to m_{N}=1/2, m_{N}=1/2 to m_{N}=−1/2, m_{N}=−1/2 to m_{N}=−3/2, m_{N}=−3/2 to m_{N}=−5/2, m_{N}=−5/2 to m_{N}=−7/2, and m_{N}=−7/2 to m_{N}=−9/2, where m_{N} is the nuclear spin state. Similarly, a transition (such as a Raman transition) designed to transfer atoms from, for instance, an m_{N}=9/2 spin state to an m_{N}=5/2 spin state, may also drive m_{N}=7/2 to m_{N}=3/2, m_{N}=5/2 to m_{N}=1/2, m_{N}=3/2 to m_{N}=−1/2, m_{N}=1/2 to m_{N}=−3/2, m_{N}=−1/2 to m_{N}=−5/2, m_{N}=−3/2 to m_{N}=−7/2, and m_{N}=−5/2 to m_{N}=−9/2. Such a transition may thus not be selective for inducing transitions between particular spin states on the nuclear spin manifold.

It may be desirable to instead implement selective transitions between particular first and second spins states on the nuclear spin manifold. This may be accomplished by providing light from a light source that provides an AC Stark shift and pushes neighboring nuclear spin states out of resonance with a transition between the desired transition between the first and second nuclear spin states. For instance, if a transition from first and second nuclear spin states having m_{N}=−9/2 and m_{N}=−7/2 is desired, the light may provide an AC Stark shift to the m_{N}=−5/2 spin state, thereby greatly reducing transitions between the m_{N}=−7/2 and m_{N}=−5/2 states. Similarly, if a transition from first and second nuclear spin states having m_{N}=−9/2 and m_{N}=−5/2 is desired, the light may provide an AC Stark shift to the m_{N}=−1/2 spin state, thereby greatly reducing transitions between the m_{N}=−5/2 and m_{N}=−1/2 states. This may effectively create a two-level subsystem within the nuclear spin manifold that is decoupled from the remainder of the nuclear spin manifold, greatly simplifying the dynamics of the qubit systems. It may be advantageous to use nuclear spin states near the edge of the nuclear spin manifold (e.g., m_{N}=−9/2 and m_{N}=−7/2, m_{N}=7/2 and m_{N}=9/2, m_{N}=−9/2 and m_{N}=−5/2, or m_{N}=5/2 and m_{N}=9/2 for a spin-9/2 nucleus) such that only one AC Stark shift is required. Alternatively, nuclear spin states farther from the edge of the nuclear spin manifold (e.g., m_{N}=−5/2 and m_{N}=−3/2 or m_{N}=−5/2 and m_{N}=−1/2) may be used and two AC Stark shifts may be implemented (e.g., at m_{N}=−7.12 and m_{N}=−1/2 or m_{N}=−9/2 and m_{N}=3/2).

Stark shifting of the nuclear spin manifold may shift neighboring nuclear spin states out of resonance with the desired transition between the first and second nuclear spin states and a second electronic state or a state detuned therefrom. Stark shifting may decrease leakage from the first and second nuclear spin state to other states in the nuclear spin manifold. Starks shifts may be achievable up to 100s of kHz for less than 10 mW beam powers. Upper state frequency selectivity may decrease scattering from imperfect polarization control. Separation of different angular momentum states in the ³P₁ manifold may be many gigahertz from the single and two-qubit gate light. Leakage to other states in the nuclear spin manifold may lead to decoherence. The Rabi frequency for two-qubit transitions (e.g., how quickly the transition can be driven) may be faster than the decoherence rate. Scattering from the intermediate state in the two-qubit transition may be a source of decoherence. Detuning from the intermediate state may improve fidelity of two-qubit transitions.

Qubits based on nuclear spin states in the electronic ground state may allow exploitation of long-lived metastable excited electronic states (such as a ³P₀ state in strontium—87) for qubit storage. Atoms may be selectively transferred into such a state to reduce cross-talk or to improve gate or detection fidelity. Such a storage or shelving process may be atom-selective using the SLMs or AODs described herein. A shelving transition may comprise a transition between the ¹S₀ state in strontium—87 to the ³P₀ or ³P₂ state in strontium—87.

The clock transition (also a “shelving transition” or a “storage transition” herein) may be qubit-state selective. The upper state of the clock transition may have a very long natural lifetime, e.g., greater than 1 second. The linewidth of the clock transition may be much narrower than the qubit energy spacing. This may allow direct spectral resolution. Population may be transferred from one of the qubit states into the clock state. This may allow individual qubit states to be read out separately, by first transferring population from one qubit state into the clock state, performing imaging on the qubits, then transferring the population back into the ground state from the clock state and imaging again. In some cases, a magic wavelength transition is used to drive the clock transition.

The clock light for shelving can be atom-selective or not atom-selective. In some cases, the clock transition is globally applied (e.g., not atom selective). A globally applied clock transition may include directing the light without passing through a microscope objective or structuring the light. In some cases, the clock transition is atom-selective. Clock transition which are atom-selective may potentially allow us to improve gate fidelities by minimizing cross-talk. For example, to reduce cross talk in an atom, the atom may be shelved in the clock state where it may not be affected by the light. This may reduce cross-talk between neighboring qubits undergoing transitions. To implement atom-selective clock transitions, the light may pass through one or more microscope objectives and/or may be structured on one or more of a spatial light modulator, digital micromirror device, crossed acousto-optic deflectors, etc.

The system 200 may comprise one or more readout units 230. The readout units may comprise one or more readout optical units. The readout optical units may be configured to perform one or more measurements of the one or more superposition states to obtain the non-classical computation. The readout optical units may comprise one or more optical detectors. The detectors may comprise one or more photomultiplier tubes (PMTs), photodiodes, avalanche diodes, single-photon avalanche diodes, single-photon avalanche diode arrays, phototransistors, reverse-biased light emitting diodes (LEDs), charge coupled devices (CCDs), or complementary metal oxide semiconductor (CMOS) cameras. The optical detectors may comprise one or more fluorescence detectors. The readout optical unit may comprise one or more objectives, such as one or more objective having a numerical aperture (NA) of at least about 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, or more. The objective may have an NA of at most about 1, 0.95, 0.9, 0.85, 0.8, 0.75, 0.7, 0.65, 0.6, 0.55, 0.5, 0.45, 0.4, 0.35, 0.3, 0.25, 0.2, 0.15, 0.1, or less. The objective may have an NA that is within a range defined by any two of the preceding values.

The one or more readout optical units 230 may make measurements, such as projective measurements, by applying light resonant with an imaging transition. The imaging transition may cause fluorescence. An imaging transition may comprise a transition between the ¹S₀ state in strontium—87 to the ¹P¹ state in strontium—87. The ¹P₁ state in strontium—87 may fluoresce. The lower state of the qubit transition may comprise two nuclear spin states in the ¹S₀ manifold. The one or more states may be resonant with the imaging transition. A measurement may comprise two excitations. In a first excitation, one of the two lower states may be excited to the shelving state (e.g., ³P₀ state in strontium—87). In a second excitation, the imaging transition may be excited. The first transition may reduce cross-talk between neighboring atoms during computation. Fluorescence generated from the imaging transition may be collected on one or more readout optical units 230.

The imaging units may be used to determine if one or more atoms were lost from the trap. The imaging units may be used to observe the arrangement of atoms in the trap.

The system 200 may comprise one or more vacuum units 240. The one or more vacuum units may comprise one or more vacuum pumps. The vacuum units may comprise one or more roughing vacuum pumps, such as one or more rotary pumps, rotary vane pumps, rotary piston pumps, diaphragm pumps, piston pumps, reciprocating piston pumps, scroll pumps, or screw pumps. The one or more roughing vacuum pumps may comprise one or more wet (for instance, oil-sealed) or dry roughing vacuum pumps. The vacuum units may comprise one or more high-vacuum pumps, such as one or more cryosorption pumps, diffusion pumps, turbomolecular pumps, molecular drag pumps, turbo-drag hybrid pumps, cryogenic pumps, ions pumps, or getter pumps.

The vacuum units may comprise any combination of vacuum pumps described herein. For instance, the vacuum units may comprise one or more roughing pumps (such as a scroll pump) configured to provide a first stage of rough vacuum pumping. The roughing vacuum pumps may be configured to pump gases out of the system 200 to achieve a low vacuum pressure condition. For instance, the roughing pumps may be configured to pump gases out of the system 200 to achieve a low vacuum pressure of at most about 103 Pascals (Pa). The vacuum units may further comprise one or more high-vacuum pumps (such as one or more ion pumps, getter pumps, or both) configured to provide a second stage of high vacuum pumping or ultra-high vacuum pumping. The high-vacuum pumps may be configured to pump gases out of the system 200 to achieve a high vacuum pressure of at most about 10⁻³ Pa or an ultra-high vacuum pressure of at most about 10⁻⁶ Pa once the system 200 has reached the low vacuum pressure condition provided by the one or more roughing pumps.

The vacuum units may be configured to maintain the system 200 at a pressure of at most about 10⁻⁶ Pa, 9×10⁻⁷ Pa, 8×10⁻⁷ Pa, 7×10⁻⁷ Pa, 6×10⁻⁷ Pa, 5×10⁻⁷ Pa, 4×10⁻⁷ Pa, 3×10⁻⁷ Pa, 2×10⁻⁷ Pa, 10⁻⁷ Pa, 9×10⁻⁸ Pa, 8×10⁻⁸ Pa, 7×10⁻⁸ Pa, 6×10⁻⁸ Pa, 5×10⁻⁸ Pa, 4×10⁻⁸ Pa, 3×10⁻⁸ Pa, 2×10⁻⁸ Pa, 10⁻⁸ Pa, 9×10⁻⁹ Pa, 8×10⁻⁹ Pa, 7×10⁻⁹ Pa, 6×10⁻⁹ Pa, 5×10⁻⁹ Pa, 4×10⁻⁹ Pa, 3×10⁻⁹ Pa, 2×10⁻⁹ Pa, 10⁻⁹ Pa, 9×10⁻¹⁰ Pa, 8×10⁻¹⁰ Pa, 7×10⁻¹⁰ Pa, 6×10⁻¹⁰ Pa, 5×10⁻¹⁰ Pa, 4×10⁻¹⁰ Pa, 3×10⁻¹⁰ Pa, 2×10⁻¹⁰ Pa, 10⁻¹⁰ Pa, 9×10⁻¹¹ Pa, 8×10⁻¹¹ Pa, 7×10⁻¹¹ Pa, 6×10⁻¹¹ Pa, 5×10⁻¹¹ Pa, 4×10⁻¹¹ Pa, 3×10⁻⁴ Pa, 2×10⁻¹ Pa, 10⁻¹¹ Pa, 9×10⁻¹² Pa, 8×10⁻¹² Pa, 7×10⁻¹² Pa, 6×10⁻¹ Pa, 5×10⁻¹² Pa, 4×10⁻¹² Pa, 3×10⁻¹² Pa, 2×10⁻¹² Pa, 10⁻¹² Pa, or lower. The vacuum units may be configured to maintain the system 200 at a pressure of at least about 10⁻¹² Pa, 2×10⁻¹² Pa, 3×10⁻⁴ Pa, 4×10⁻¹ Pa, 5×10⁻¹ Pa, 6×10⁻¹² Pa, 7×10⁻⁴ Pa, 8×10⁻¹² Pa, 9×10⁻¹¹ Pa, 10⁻¹¹ Pa, 2×10⁻¹ Pa, 3×10⁻¹¹ Pa, 4×10⁻¹¹ Pa, 5×10⁻¹¹ Pa, 6×10⁻¹¹ Pa, 7×10⁻¹¹ Pa, 8×10⁻¹¹ Pa, 9×10⁻¹¹ Pa, 10⁻¹⁰ Pa, 2×10⁻¹⁰ Pa, 3×10⁻¹⁰ Pa, 4×10⁻¹⁰ Pa, 5×10⁻¹⁰ Pa, 6×10⁻¹⁰ Pa, 7×10⁻¹⁰ Pa, 8×10⁻¹⁰ Pa, 9×10⁻¹⁰ Pa, 10⁻⁹ Pa, 2×10⁻⁹ Pa, 3×10⁻⁹ Pa, 4×10⁻⁹ Pa, 5×10⁻⁹ Pa, 6×10⁻⁹ Pa, 7×10⁻⁹ Pa, 8×10⁻⁹ Pa, 9×10⁻⁹ Pa, 10⁻⁸ Pa, 2×10⁻⁸ Pa, 3×10⁻⁸ Pa, 4×10⁻⁸ Pa, 5×10⁻⁸ Pa, 6×10⁻⁸ Pa, 7×10⁻⁸ Pa, 8×10⁻⁸ Pa, 9×10⁻¹ Pa, 10⁻⁷ Pa, 2×10⁻⁷ Pa, 3×10⁻⁷ Pa, 4×10⁻⁷ Pa, 5×10⁻⁷ Pa, 6×10⁻⁷ Pa, 7×10⁻⁷ Pa, 8×10⁻⁷ Pa, 9×10⁻⁷ Pa, 10⁻⁶ Pa. or higher. The vacuum units may be configured to maintain the system 200 at a pressure that is within a range defined by any two of the preceding values.

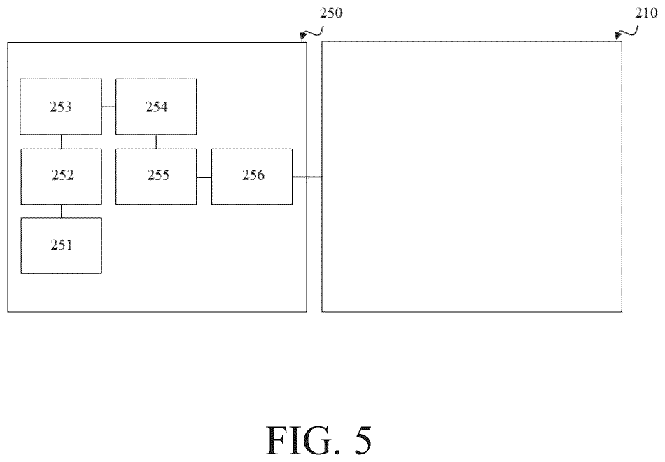

The system 200 may comprise one or more state preparation units 250. The state preparation units may comprise any state preparation unit described herein, such as a state preparation unit described herein with respect to FIG. 5. The state preparation units may be configured to prepare a state of the plurality of atoms.

The system 200 may comprise one or more atom reservoirs 260. The atom reservoirs may be configured to supply one or more replacement atoms to replace one or more atoms at one or more optical trapping sites upon loss of the atoms from the optical trapping sites. The atom reservoirs may be spatially separated from the optical trapping units. For instance, the atom reservoirs may be located at a distance from the optical trapping units.

Alternatively or in addition, the atom reservoirs may comprise a portion of the optical trapping sites of the optical trapping units. A first subset of the optical trapping sites may be utilized for performing quantum computations and may be referred to as a set of computationally-active optical trapping sites, while a second subset of the optical trapping sites may serve as an atom reservoir. For instance, the first subset of optical trapping sites may comprise an interior array of optical trapping sites, while the second subset of optical trapping sites comprises an exterior array of optical trapping sites surrounding the interior array. The interior array may comprise a rectangular, square, rectangular prism, or cubic array of optical trapping sites.

The system 200 may comprise one or more atom movement units 270. The atom movement units may be configured to move the one or more replacement atoms from the one or more atoms reservoirs to the one or more optical trapping sites. For instance, the one or more atom movement units may comprise one or more electrically tunable lenses, acousto-optic deflectors (AODs), or spatial light modulators (SLMs).

The system 200 may comprise one or more entanglement units 280. The entanglement units may be configured to quantum mechanically entangle at least a first atom of the plurality of atoms with at least a second atom of the plurality of atoms. The first or second atom may be in a superposition state at the time of quantum mechanical entanglement. Alternatively or in addition, the first or second atom may not be in a superposition state at the time of quantum mechanical entanglement. The first atom and the second atom may be quantum mechanically entangled through one or more magnetic dipole interactions, induced magnetic dipole interactions, electric dipole interactions, or induced electric dipole interactions. The entanglement units may be configured to quantum mechanically entangle any number of atoms described herein.

The entanglement units may also be configured to quantum mechanically entangle at least a subset of the atoms with at least another atom to form one or more multi-qubit units. The multi-qubit units may comprise two-qubit units, three-qubit units, four-qubit units, or n-qubit units, where n may be 5, 6, 7, 8, 9, 10, or more. For instance, a two-qubit unit may comprise a first atom quantum mechanically entangled with a second atom, a three-qubit unit may comprise a first atom quantum mechanically entangled with a second and third atom, a four-qubit unit may comprise a first atom quantum mechanically entangled with a second, third, and fourth atom, and so forth. The first, second, third, or fourth atom may be in a superposition state at the time of quantum mechanical entanglement. Alternatively or in addition, the first, second, third, or fourth atom may not be in a superposition state at the time of quantum mechanical entanglement. The first, second, third, and fourth atom may be quantum mechanically entangled through one or more magnetic dipole interactions, induced magnetic dipole interactions, electric dipole interactions, or induced electric dipole interactions.

The entanglement units may comprise one or more Rydberg units. The Rydberg units may be configured to electronically excite the at least first atom to a Rydberg state or to a superposition of a Rydberg state and a lower-energy atomic state, thereby forming one or more Rydberg atoms or dressed Rydberg atoms. The Rydberg units may be configured to induce one or more quantum mechanical entanglements between the Rydberg atoms or dressed Rydberg atoms and the at least second atom. The second atom may be located at a distance of at least about 200 nanometers (nm), 300 nm, 400 nm, 500 nm, 600 nm, 700 nm, 800 nm, 900 nm, 1 micrometer (μm), 2 μm, 3 μm, 4 μm, 5 μm, 6 μm, 7 μm, 8 μm, 9 μm, 10 μm, or more from the Rydberg atoms or dressed Rydberg atoms. The second atom may be located at a distance of at most about 10 μm, 9 μm, 8 μm, 7 μm, 6 μm, 5 μm, 4 μm, 3 μm, 2 μm, 1 μm, 900 nm, 800 nm, 700 nm, 600 nm, 500 nm, 400 nm, 300 nm, 200 nm, or less from the Rydberg atoms or dressed Rydberg atoms. The second atom may be located at a distance from the Rydberg atoms or dressed Rydberg atoms that is within a range defined by any two of the preceding values. The Rydberg units may be configured to allow the Rydberg atoms or dressed Rydberg atoms to relax to a lower-energy atomic state, thereby forming one or more two-qubit units. The Rydberg units may be configured to induce the Rydberg atoms or dressed Rydberg atoms to relax to a lower-energy atomic state. The Rydberg units may be configured to drive the Rydberg atoms or dressed Rydberg atoms to a lower-energy atomic state. For instance, the Rydberg units may be configured to apply electromagnetic radiation (such as RF radiation or optical radiation) to drive the Rydberg atoms or dressed Rydberg atoms to a lower-energy atomic state. The Rydberg units may be configured to induce any number of quantum mechanical entanglements between any number of atoms of the plurality of atoms.

The Rydberg units may comprise one or more light sources (such as any light source described herein) configured to emit light having one or more ultraviolet (UV) wavelengths. The UV wavelengths may be selected to correspond to a wavelength that forms the Rydberg atoms or dressed Rydberg atoms. For instance, the light may comprise one or more wavelengths of at least about 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, or more. The light may comprise one or more wavelengths of at most about 400 nm, 390 nm, 380 nm, 370 nm, 360 nm, 350 nm, 340 nm, 330 nm, 320 nm, 310 nm, 300 nm, 290 nm, 280 nm, 270 nm, 260 nm, 250 nm, 240 nm, 230 nm, 220 nm, 210 nm, 200 nm, or less. The light may comprise one or more wavelengths that are within a range defined by any two of the preceding values. For instance, the light may comprise one or more wavelengths that are within a range from 300 nm to 400 nm.

The Rydberg units may be configured to induce a two-photon transition to generate an entanglement. The Rydberg units may be configured to induce a two-photon transition to generate an entanglement between two atoms. The Rydberg units may be configured to selectively induce a two-photon transition to selectively generate an entanglement between two atoms. For instance, the Rydberg units may be configured to direct electromagnetic energy (such as optical energy) to particular optical trapping sites to selectively induce a two-photon transition to selectively generate the entanglement between the two atoms. The two atoms may be trapped in nearby optical trapping sites. For instance, the two atoms may be trapped in adjacent optical trapping sites. The two-photon transition may be induced using first and second light from first and second light sources, respectively. The first and second light sources may each comprise any light source described herein (such as any laser described herein). The first light source may be the same or similar to a light source used to perform a single-qubit operation described herein. Alternatively, different light sources may be used to perform a single-qubit operation and to induce a two-photon transition to generate an entanglement. The first light source may emit light comprising one or more wavelengths in the visible region of the optical spectrum (e.g., within a range from 400 nm to 800 nm or from 650 nm to 700 nm). The second light source may emit light comprising one or more wavelengths in the ultraviolet region of the optical spectrum (e.g., within a range from 200 nm to 400 nm or from 300 nm to 350 nm). The first and second light sources may emit light having substantially equal and opposite spatially-dependent frequency shifts.

The Rydberg atoms or dressed Rydberg atoms may comprise a Rydberg state that may have sufficiently strong interatomic interactions with nearby atoms (such as nearby atoms trapped in nearby optical trapping sites) to enable the implementation of multi-qubit operations. The Rydberg states may comprise a principal quantum number of at least about 50, 60, 70, 80, 90, 100, or more. The Rydberg states may comprise a principal quantum number of at most about 100, 90, 80, 70, 60, 50, or less. The Rydberg states may comprise a principal quantum number that is within a range defined by any two of the preceding values. The Rydberg states may interact with nearby atoms through van der Waals interactions. The van der Waals interactions may shift atomic energy levels of the atoms.

State selective excitation of atoms to Rydberg levels may enable the implementation of multi-qubit operations. The multi-qubit operations may comprise two-qubit operations, three-qubit operations, or n-qubit operations, where n is 4, 5, 6, 7, 8, 9, 10, or more. Two-photon transitions may be used to excite atoms from a ground state (such as a ¹S₀ ground state) to a Rydberg state (such as an n³S₁ state, wherein n is a principal quantum number described herein).

State selectivity may be accomplished by a combination of laser polarization and spectral selectivity. The two-photon transitions may be implemented using first and second laser sources, as described herein. The first laser source may emit pi-polarized light, which may not change the projection of atomic angular momentum along a magnetic field. The second laser may emit circularly polarized light, which may change the projection of atomic angular momentum along the magnetic field by one unit. The first and second qubit levels may be excited to Rydberg level using this polarization. However, the Rydberg levels may be more sensitive to magnetic fields than the ground state so that large splittings (for instance, on the order of 100s of MHz) may be readily obtained. This spectral selectivity may allow state selective excitation to Rydberg levels.

Multi-qubit operations (such as two-qubit operations, three-qubit operations, four-qubit operations, and so forth) may rely on energy shifts of levels due to van der Waals interactions described herein. Such shifts may either prevent the excitation of one atom conditional on the state of the other or change the coherent dynamics of excitation of the two-atom system to enact a two-qubit operation. In some cases, “dressed states” may be generated under continuous driving to enact two-qubit operations without requiring full excitation to a Rydberg level (for instance, as described in www.arxiv.org/abs/1605.05207, which is incorporated herein by reference in its entirety for all purposes).

The system 200 may comprise one or more second electromagnetic delivery units (not shown in FIG. 2). The second electromagnetic delivery units may comprise any electromagnetic delivery unit described herein, such as an electromagnetic delivery unit described herein with respect to FIG. 4. The first and second electromagnetic delivery units may be the same. The first and second electromagnetic delivery units may be different. The second electromagnetic delivery units may be configured to apply second electromagnetic energy to the one or more multi-qubit units. The second electromagnetic energy may comprise one or more pulse sequences. The first electromagnetic energy may precede, be simultaneous with, or follow the second electromagnetic energy.

The pulse sequences may comprise any number of pulses. For instance, the pulse sequences may comprise at least about 1, 2, 3, 4, 5, 6, 7, 8, 9, 10, 20, 30, 40, 50, 60, 70, 80, 90, 100, 200, 300, 400, 500, 600, 700, 800, 900, 1,000, or more pulses. The pulse sequences may comprise at most about 1,000, 900, 800, 700, 600, 500, 400, 300, 200, 100, 90, 80, 70, 60, 50, 40, 30, 20, 10, 9, 8, 7, 6, 5, 4, 3, 2, or 1 pulses. The pulse sequences may comprise a number of pulses that is within a range defined by any two of the preceding values. Each pulse of the pulse sequence may comprise any pulse shape, such as any pulse shape described herein.

The pulse sequences may be configured to decrease the duration of time required to implement multi-qubit operations, as described herein (for instance, with respect to Example 3). For instance, the pulse sequences may comprise a duration of at least about 10 nanoseconds (ns), 20 ns, 30 ns, 40 ns, 50 ns, 60 ns, 70 ns, 80 ns, 90 ns, 100 ns, 200 ns, 300 ns, 400 ns, 500 ns, 600 ns, 700 ns, 800 ns, 900 ns, 1 microsecond (μs), 2 μs, 3 μs, 4 μs, 5 μs, 6 μs, 7 μs, 8 μs, 9 μs, 10 μs, 20 μs, 30 μs, 40 μs, 50 μs, 60 μs, 70 μs, 80 μs, 90 μs, 100 μs, or more. The pulse sequences may comprise a duration of at most about 100 μs, 90 μs, 80 μs, 70 μs, 60 μs, 50 μs, 40 μs, 30 μs, 20 μs, 10 μs, 9 μs, 8 μs, 7 μs, 6 μs, 5 μs, 4 μs, 3 μs, 2 μs, 1 μs, 900 ns, 800 ns, 700 ns, 600 ns, 500 ns, 400 ns, 300 ns, 200 ns, 100 ns, 90 ns, 80 ns, 70 ns, 60 ns, 50 ns, 40 ns, 30 ns, 20 ns, 10 ns, or less. The pulse sequences may comprise a duration that is within a range defined by any two of the preceding values.

The pulse sequences may be configured to increase the fidelity of multi-qubit operations, as described herein. For instance, the pulse sequences may enable multi-qubit operations with a fidelity of at least about 0.5, 0.6, 0.7, 0.8, 0.9, 0.91, 0.92, 0.93, 0.94, 0.95, 0.96, 0.97, 0.98, 0.99, 0.991, 0.992, 0.993, 0.994, 0.995, 0.996, 0.997, 0.998, 0.999, 0.9991, 0.9992, 0.9993, 0.9994, 0.9995, 0.9996, 0.9997, 0.9998, 0.9999, 0.99991, 0.99992, 0.99993, 0.99994, 0.99995, 0.99996, 0.99997, 0.99998, 0.99999, 0.999991, 0.999992, 0.999993, 0.999994, 0.999995, 0.999996, 0.999997, 0.999998, 0.999999, or more. The pulse sequences may enable multi-qubit operations with a fidelity of at most about 0.999999, 0.999998, 0.999997, 0.999996, 0.999995, 0.999994, 0.999993, 0.999992, 0.999991, 0.99999, 0.99998, 0.99997, 0.99996, 0.99995, 0.99994, 0.99993, 0.99992, 0.99991, 0.9999, 0.9998, 0.9997, 0.9996, 0.9995, 0.9994, 0.9993, 0.9992, 0.9991, 0.999, 0.998, 0.997, 0.996, 0.995, 0.994, 0.993, 0.992, 0.991, 0.99, 0.98, 0.97, 0.96, 0.95, 0.94, 0.93, 0.92, 0.91, 0.9, 0.8, 0.7, 0.6, 0.5, or less. The pulse sequences may enable multi-qubit operations with a fidelity that is within a range defined by any two of the preceding values.

The pulse sequences may enable the implementation of multi-qubit operations on non-adiabatic timescales while maintaining effectively adiabatic dynamics. For instance, the pulse sequences may comprise one or more of shortcut to adiabaticity (STA) pulse sequences, transitionless quantum driving (TQD) pulse sequences, superadiabatic pulse sequences, counterdiabatic driving pulse sequences, derivative removal by adiabatic gate (DRAG) pulse sequences, and weak anharmonicity with average Hamiltonian (Wah Wah) pulse sequences. For instance, the pulse sequences may be similar to those described in M. V. Berry, “Transitionless Quantum Driving,” Journal of Physics A: Mathematical and Theoretical 42(36), 365303 (2009), www.doi.org/10.1088/1751-8113/42/36/365303: Y.-Y. Jau et al., “Entangling Atomic Spins with a Strong Rydberg-Dressed Interaction.” Nature Physics 12(1), 71-74 (2016); T. Keating et al., “Robust Quantum Logic in Neutral Atoms via Adiabatic Rydberg Dressing,” Physical Review A 91, 012337 (2015); A. Mitra et al., “Robust Mölmer-Sörenson Gate for Neutral Atoms Using Rapid Adiabatic Rydberg Dressing,” www.arxiv.org/abs/1911.04045 (2019); or L. S. Theis et al., “Counteracting Systems of Diabaticities Using DRAG Controls: The Status after 10 Years,” Europhysics Letters 123(6), 60001 (2018), each of which is incorporated herein by reference in its entirety for all purposes.

The pulse sequences may further comprise one or more optimal control pulse sequences. The optimal control pulse sequences may be derived from one or more procedures, including gradient ascent pulse engineering (GRAPE) methods. Krotov's method, chopped basis methods, chopped random basis (CRAB) methods, Nelder-Mead methods, gradient optimization using parametrization (GROUP) methods, genetic algorithm methods, and gradient optimization of analytic controls (GOAT) methods. For instance, the pulse sequences may be similar to those described in N. Khaneja et al., “Optimal Control of Coupled Spin Dynamics: Design of NMR Pulse Sequences by Gradient Ascent Algorithms,”. Journal of Magnetic Resonance 172(2), 296-305 (2005); or J. T. Merrill et al., “Progress in Compensating Pulse Sequences for Quantum Computation,” Advances in Chemical Physics 154, 241-294 (2014), each of which is incorporated by reference in its entirety for all purposes.

### Example of Cloud Computing

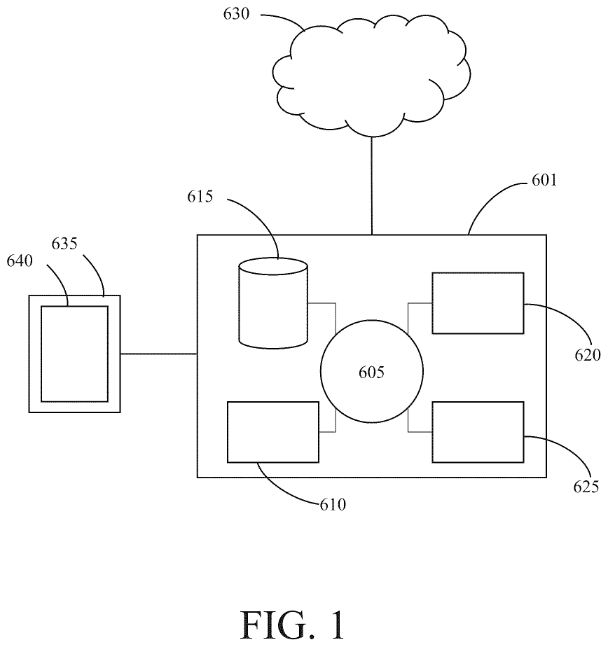

The system 200 may be operatively coupled to a digital computer described herein (such as a digital computer described herein with respect to FIG. 1) over a network described herein (such as a network described herein with respect to FIG. 1). The network may comprise a cloud computing network.

### Example of Optical Trapping Units

FIG. 3A shows an example of an optical trapping unit 210. The optical trapping unit may be configured to generate a plurality 211 of spatially distinct optical trapping sites, as described herein. For instance, as shown in FIG. 3B, the optical trapping unit may be configured to generate a first optical trapping site 211a, second optical trapping site 211b, third optical trapping site 211c, fourth optical trapping site 211d, fifth optical trapping site 211e, sixth optical trapping site 211f, seventh optical trapping site 211g, eighth optical trapping site 211h, and ninth optical trapping site 211i, as depicted in FIG. 3A. The plurality of spatially distinct optical trapping sites may be configured to trap a plurality of atoms, such as first atom 212a, second atom 212b, third atom 212c, and fourth atom 212d, as depicted in FIG. 3A. As depicted in FIG. 3B, each optical trapping site may be configured to trap a single atom. As depicted in FIG. 3D, some of the optical trapping sites may be empty (i.e., not trap an atom).

As shown in FIG. 3B, the plurality of optical trapping sites may comprise a two-dimensional (2D) array. The 2D array may be perpendicular to the optical axis of optical components of the optical trapping unit depicted in FIG. 3A. Alternatively, the plurality of optical trapping sites may comprise a one-dimensional (1D) array or a three-dimensional (3D) array.

Although depicted as comprising nine optical trapping sites filled by four atoms in FIG. 3B, the optical trapping unit 210 may be configured to generate any number of spatially distinct optical trapping sites described herein and may be configured to trap any number of atoms described herein.

Each optical trapping site of the plurality of optical trapping sites may be spatially separated from each other optical trapping site by a distance of at least about 200 nm, 300r nm, 400 nm, 500 nm, 600 nm, 700 nm, 800 nm, 900 nm, 1 μm, 2 μm, 3 μm, 4 μm, 5 μm, 6 μm, 7 μm, 8 μm, 9 μm, 10 μm, or more. Each optical trapping site may be spatially separated from each other optical trapping site by a distance of at most about 10 μm, 9 μm, 8 μm, 7 μm, 6 μm, 5 μm, 4 μm, 3 μm, 2 μm, 1 μm, 900 nm, 800 nm, 700 nm, 600 nm, 500 nm, 400 nm, 300 nm, 200 nm, or less. Each optical trapping site may be spatially separated from each other optical trapping site by a distance that is within a range defined by any two of the preceding values.

The optical trapping sites may comprise one or more optical tweezers. Optical tweezers may comprise one or more focused laser beams to provide an attractive or repulsive force to hold or move the one or more atoms. The beam waist of the focused laser beams may comprise a strong electric field gradient. The atoms may be attracted or repelled along the electric field gradient to the center of the laser beam, which may contain the strongest electric field. The optical trapping sites may comprise one or more optical lattice sites of one or more optical lattices. The optical trapping sites may comprise one or more optical lattice sites of one or more one-dimensional (1D) optical lattices, two-dimensional (2D) optical lattices, or three-dimensional (3D) optical lattices. For instance, the optical trapping sites may comprise one or more optical lattice sites of a 2D optical lattice, as depicted in FIG. 3B.

The optical lattices may be generated by interfering counter-propagating light (such as counter-propagating laser light) to generate a standing wave pattern having a periodic succession of intensity minima and maxima along a particular direction. A 1D optical lattice may be generated by interfering a single pair of counter-propagating light beams. A 2D optical lattice may be generated by interfering two pairs of counter-propagating light beams. A 3D optical lattice may be generated by interfering three pairs of counter-propagating lights beams. The light beams may be generated by different light sources or by the same light source. Therefore, an optical lattice may be generated by at least about 1, 2, 3, 4, 5, 6, or more light sources or at most about 6, 5, 4, 3, 2, or 1 light sources.

Returning to the description of FIG. 3A, the optical trapping unit may comprise one or more light sources configured to emit light to generate the plurality of optical trapping sites as described herein. For instance, the optical trapping unit may comprise a single light source 213, as depicted in FIG. 3A. Though depicted as comprising a single light source in FIG. 3A, the optical trapping unit may comprise any number of light sources, such as at least about 1, 2, 3, 4, 5, 6, 7, 8, 9, 10, or more light sources or at most about 10, 9, 8, 7, 6, 5, 4, 3, 2, or 1 light sources. The light sources may comprise one or more lasers. The lasers may be configured to operate at a resolution limit of the lasers. For example, the lasers can be configured to provide diffraction limited spot sizes for optical trapping.

The lasers may comprise one or more continuous wave lasers. The lasers may comprise one or more pulsed lasers. The lasers may comprise one or more gas lasers, such as one or more helium-neon (HeNe) lasers, argon (Ar) lasers, krypton (Kr) lasers, xenon (Xe) ion lasers, nitrogen (N₂) lasers, carbon dioxide (CO₂) lasers, carbon monoxide (CO) lasers, transversely excited atmospheric (TEA) lasers, or excimer lasers. For instance, the lasers may comprise one or more argon dimer (Ar₂) excimer lasers, krypton dimer (Kr₂) excimer lasers, fluorine dimer (F₂) excimer lasers, xenon dimer (Xe₂) excimer lasers, argon fluoride (ArF) excimer lasers, krypton chloride (KrCl) excimer lasers, krypton fluoride (KrF) excimer lasers, xenon bromide (XeBr) excimer lasers, xenon chloride (XeCl) excimer lasers, or xenon fluoride (XeF) excimer lasers. The laser may comprise one or more dye lasers.

The lasers may comprise one or more metal-vapor lasers, such as one or more helium-cadmium (HeCd) metal-vapor lasers, helium-mercury (HeHg) metal-vapor lasers, helium-selenium (HeSe) metal-vapor lasers, helium-silver (HeAg) metal-vapor lasers, strontium (Sr) metal-vapor lasers, neon-copper (NeCu) metal-vapor lasers, copper (Cu) metal-vapor lasers, gold (Au) metal-vapor lasers, manganese (Mn) metal-vapor laser, or manganese chloride (MnCl₂) metal-vapor lasers.

The lasers may comprise one or more solid-state lasers, such as one or more ruby lasers, metal-doped crystal lasers, or metal-doped fiber lasers. For instance, the lasers may comprise one or more neodymium-doped yttrium aluminum garnet (Nd:YAG) lasers, neodymium/chromium doped yttrium aluminum garnet (Nd/Cr:YAG) lasers, erbium-doped yttrium aluminum garnet (Er:YAG) lasers, neodymium-doped yttrium lithium fluoride (Nd:YLF) lasers, neodymium-doped yttrium orthovanadate (ND:YVO₄) lasers, neodymium-doped yttrium calcium oxoborate (Nd:YCOB) lasers, neodymium glass (Nd:glass) lasers, titanium sapphire (Ti:sapphire) lasers, thulium-doped ytrium aluminum garnet (Tm:YAG) lasers, ytterbium-doped ytrrium aluminum garnet (Yb:YAG) lasers, ytterbium-doped glass (Yt:glass) lasers, holmium ytrrium aluminum garnet (Ho:YAG) lasers, chromium-doped zinc selenide (Cr:ZnSe) lasers, cerium-doped lithium strontium aluminum fluoride (Ce:LiSAF) lasers, cerium-doped lithium calcium aluminum fluoride (Ce:LiCAF) lasers, erbium-doped glass (Er:glass) lasers, erbium-ytterbium-codoped glass (Er/Yt:glass) lasers, uranium-doped calcium fluoride (U:CaF₂) lasers, or samarium-doped calcium fluoride (Sm:CaF₂) lasers.

The lasers may comprise one or more semiconductor lasers or diode lasers, such as one or more gallium nitride (GaN) lasers, indium gallium nitride (InGaN) lasers, aluminum gallium indium phosphide (AlGaInP) lasers, aluminum gallium arsenide (AlGaAs) lasers, indium gallium arsenic phosphide (InGaAsP) lasers, vertical cavity surface emitting lasers (VCSELs), or quantum cascade lasers.

The lasers may emit continuous wave laser light. The lasers may emit pulsed laser light. The lasers may have a pulse length of at least about 1 femtoseconds (fs), 2 fs, 3 fs, 4 fs, 5 fs, 6 fs, 7 fs, 8 fs, 9 fs, 10 fs, 20 fs, 30 fs, 40 fs, 50 fs, 60 fs, 70 fs, 80 fs, 90 fs, 100 fs, 200 fs, 300 fs, 400 fs, 500 fs, 600 fs, 700 fs, 800 fs, 900 fs, 1 picosecond (ps), 2 ps, 3 ps, 4 ps, 5 ps, 6 ps, 7 ps, 8 ps, 9 ps, 10 ps, 20 ps, 30 ps, 40 ps, 50 ps, 60 ps, 70 ps, 80 ps, 90 ps, 100 ps, 200 ps, 300 ps, 400 ps, 500 ps, 600 ps, 700 ps, 800 ps, 900 ps, 1 nanosecond (ns), 2 ns, 3 ns, 4 ns, 5 ns, 6 ns, 7 ns, 8 ns, 9 ns, 10 ns, 20 ns, 30 ns, 40 ns, 50 ns, 60 ns, 70 ns, 80 ns, 90 ns, 100 ns, 200 ns, 300 ns, 400 ns, 500 ns, 600 ns, 700 ns, 800 ns, 900 ns, 1,000 ns, or more. The lasers may have a pulse length of at most about 1,000 ns, 900 ns, 800 ns, 700 ns, 600 ns, 500 ns, 400 ns, 300 ns, 200 ns, 100 ns, 90 ns, 80 ns, 70 ns, 60 ns, 50 ns, 40 ns, 30 ns, 20 ns, 10 ns, 9 ns, 8 ns, 7 ns, 6 ns, 5 ns, 4 ns, 3 ns, 2 ns, 1 ns, 900 ps, 800 ps, 700 ps, 600 ps, 500 ps, 400 ps, 300 ps, 200 ps, 100 ps, 90 ps, 80 ps, 70 ps, 60 ps, 50 ps, 40 ps, 30 ps, 20 ps, 10 ps, 9 ps, 8 ps, 7 ps, 6 ps, 5 ps, 4 ps, 3 ps, 2 ps, 1 ps, 900 fs, 800 fs, 700 fs, 600 fs, 500 fs, 400 fs, 300 fs, 200 fs, 100 fs, 90 fs, 80 fs, 70 fs, 60 fs, 50 fs, 40 fs, 30 fs, 20 fs, 10 fs, 9 fs, 8 fs, 7 fs, 6 fs, 5 fs, 4 fs, 3 fs, 2 fs, 1 fs, or less. The lasers may have a pulse length that is within a range defined by any two of the preceding values.

The lasers may have a repetition rate of at least about 1 hertz (Hz), 2 Hz, 3 Hz, 4 Hz, 5 Hz, 6 Hz, 7 Hz, 8 Hz, 9 Hz, 10 Hz, 20 Hz, 30 Hz, 40 Hz, 50 Hz, 60 Hz, 70 Hz, 80 Hz, 90 Hz, 100 Hz, 200 Hz, 300 Hz, 400 Hz, 500 Hz, 600 Hz, 700 Hz, 800 Hz, 900 Hz, 1 kilohertz (kHz), 2 kHz, 3 kHz, 4 kHz, 5 kHz, 6 kHz, 7 kHz, 8 kHz, 9 kHz, 10 kHz, 20 kHz, 30 kHz, 40 kHz, 50 kHz, 60 kHz, 70 kHz, 80 kHz, 90 kHz, 100 kHz, 200 kHz, 300 kHz, 400 kHz, 500 kHz, 600 kHz, 700 kHz, 800 kHz, 900 kHz, 1 megahertz (MHz), 2 MHz, 3 MHz, 4 MHz, 5 MHz, 6 MHz, 7 MHz, 8 MHz, 9 MHz, 10 MHz, 20 MHz. 30 MHz, 40 MHz, 50 MHz, 60 MHz, 70 MHz, 80 MHz. 90 MHz, 100 MHz, 200 MHz. 300 MHz, 400 MHz, 500 MHz. 600 MHz, 700 MHz, 800 MHz, 900 MHz, 1,000 MHz, or more. The lasers may have a repetition rate of at most about 1,000 MHz, 900 MHz, 800 MHz, 700 MHz, 600 MHz, 500 MHz, 400 MHz, 300 MHz, 200 MHz, 100 MHz, 90 MHz, 80 MHz, 70 MHz, 60 MHz, 50 MHz, 40 MHz, 30 MHz, 20 MHz, 10 MHz, 9 MHz, 8 MHz, 7 MHz, 6 MHz, 5 MHz, 4 MHz, 3 MHz, 2 MHz, 1 MHz, 900 kHz, 800 kHz, 700 kHz, 600 kHz, 500 kHz, 400 kHz, 300 kHz, 200 kHz, 100 kHz, 90 kHz, 80 kHz, 70 kHz, 60 kHz, 50 kHz, 40 kHz, 30 kHz, 20 kHz, 10 kHz, 9 kHz, 8 kHz, 7 kHz, 6 kHz, 5 kHz, 4 kHz, 3 kHz, 2 kHz, 1 kHz, 900 Hz, 800 Hz, 700 Hz, 600 Hz, 500 Hz, 400 Hz, 300 Hz, 200 Hz 100 Hz, 90 Hz, 80 Hz, 70 Hz, 60 Hz, 50 Hz, 40 Hz, 30 Hz, 20 Hz, 10 Hz, 9 Hz, 8 Hz, 7 Hz, 6 Hz, 5 Hz, 4 Hz, 3 Hz, 2 Hz, 1 Hz, or less. The lasers may have a repetition rate that is within a range defined by any two of the preceding values.

The lasers may emit light having a pulse energy of at least about 1 nanojoule (nJ), 2 nJ, 3 nJ, 4 n, 5 nJ, 6 nJ, 7 nJ, 8 nJ, 9 nJ, 10 nJ, 20 nJ, 30 nJ, 40 nJ, 50 nJ, 60 nJ, 70 nJ, 80 nJ, 90 nJ, 100 nJ, 200 nJ, 300 nJ, 400 nJ, 500 nJ, 600 nJ, 700 nJ, 800 nJ, 900 nJ, 1 microjoule (μJ), 2 μJ, 3 μJ, 4 μJ, 5 μJ, 6 μJ, 7 μJ, 8 μJ, 9 μJ, 10 μJ, 20 μJ, 30 μJ, 40 μJ, 50 μJ, 60 μJ, 70 μJ, 80 μJ, 90 μJ, 100 μJ, 200 μJ, 300 μJ, 400 μJ, 500 μJ, 600 μJ, 700 μJ, 800 μJ, 900 μJ, a least 1 millijoule (mJ), 2 mJ, 3 mJ, 4 mJ, 5 mJ, 6 mJ, 7 mJ, 8 mJ, 9 mJ, 10 mJ, 20 mJ, 30 mJ, 40 mJ, 50 mJ, 60 mJ, 70 mJ, 80 ml, 90 mJ, 100 ml, 200 mJ, 300 mJ, 400 mJ, 500 mJ, 600 mJ, 700 mJ, 800 mJ, 900 mJ, a least 1 Joule (J), or more. The lasers may emit light having a pulse energy of at most about 1 J, 900 mJ, 800 mJ, 700 mJ, 600 mJ, 500 mJ, 400 ml, 300 ml, 200 mJ, 100 mJ, 90 mJ, 80 mJ, 70 mJ, 60 mJ, 50 mJ, 40 mJ, 30 mJ, 20 m, 10 mJ, 9 ml, 8 mJ, 7 mJ, 6 mJ, 5 ml, 4 mJ, 3 mJ, 2 mJ, 1 mJ, 900 μJ, 800 μJ, 700 μJ, 600 μJ, 500 μJ, 400 μJ, 300 μJ, 200 μJ, 100 μJ, 90 μJ, 80 μJ, 70 μJ, 60 μJ, 50 μJ, 40 μJ, 30 μJ, 20 μJ, 10 μJ, 9 μJ, 8 μJ, 7 μJ, 6 μJ, 5 μJ, 4 μJ, 3 μJ, 2 μJ, 1 μJ, 900 nJ, 800 nJ, 700 nJ, 600 nJ, 500 nJ, 400 nJ, 300 nJ, 200 nJ, 100 nJ, 90 nJ, 80 nJ, 70 nJ, 60 nJ, 50 nJ, 40 nJ, 30 nJ, 20 nJ, 10 nJ, 9 nJ, 8 nJ, 7 nJ, 6 nJ, 5 nJ, 4 nJ, 3 nJ, 2 nJ, 1 nJ, or less. The lasers may emit light having a pulse energy that is within a range defined by any two of the preceding values.

The lasers may emit light having an average power of at least about 1 microwatt (μW), 2 μW, 3 μW, 4 μW, 5 μW, 6 μW, 7 μW, 8 μW, 9 μW, 10 μW, 20 μW, 30 μW, 40 μW, 50 μW, 60 μW, 70 μW, 80 μW, 90 μW, 100 μW, 200 μW, 300 μW, 400 μW, 500 μW, 600 μW, 700 μW, 800 μW, 900 μW, 1 milliwatt (mW), 2 mW, 3 mW, 4 mW, 5 mW, 6 mW, 7 mW, 8 mW, 9 mW, 10 mW, 20 mW, 30 mW, 40 mW, 50 mW, 60 mW, 70 mW, 80 mW, 90 mW, 100 mW, 200 mW, 300 mW, 400 mW, 500 mW, 600 mW, 700 mW, 800 mW, 900 mW, 1 watt (W), 2 W, 3 W, 4 W, 5 W, 6 W, 7 W, 8 W, 9 W, 10 W, 20 W, 30 W, 40 W, 50 W, 60 W, 70 W, 80 W, 90 W, 100 W, 200 W, 300 W, 400 W, 500 W, 600 W, 700 W, 800 W, 900 W, 1,000 W, or more. The lasers may emit light having an average power of at most about 1,000 W, 900 W, 800 W, 700 W, 600 W, 500 W, 400 W, 300 W, 200 W, 100 W, 90 W, 80 W, 70 W, 60 W, 50 W, 40 W, 30 W, 20 W, 10 W, 9 W, 8 W, 7 W, 6 W, 5 W, 4 W, 3 W, 2 W, 1 W, 900 mW, 800 mW, 700 mW, 600 mW, 500 mW, 400 mW, 300 mW, 200 mW, 100 mW, 90 mW, 80 mW, 70 mW, 60 mW, 50 mW, 40 mW, 30 mW, 20 mW, 10 mW, 9 mW, 8 mW, 7 mW, 6 mW, 5 mW, 4 mW, 3 mW, 2 mW, 1 mW, 900 μW, 800 μW, 700 μW, 600 μW, 500 μW, 400 μW, 300 μW, 200 μW, 100 μW, 90 μW, 80 μW, 70 μW, 60 μW, 50 μW, 40 μW, 30 μW, 20 μW, 10 μW, 9 μW, 8 μW, 7 μW, 6 μW, 5 μW, 4 μW, 3 μW, 2 μW, 1 μW, or more. The lasers may emit light having a power that is within a range defined by any two of the preceding values.

The lasers may emit light comprising one or more wavelengths in the ultraviolet (UV), visible, or infrared (IR) portions of the electromagnetic spectrum. The lasers may emit light comprising one or more wavelengths of at least about 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, 1,010 nm, 1,020 nm, 1,030 nm, 1,040 nm, 1,050 nm, 1,060 nm, 1,070 nm, 1,080 nm 1,090 nm, 1,100 nm, 1,110 nm, 1,120 nm, 1,130 nm, 1,140 nm, 1,150 nm, 1,160 nm, 1,170 nm, 1.180 nm, 1,190 nm, 1,200 nm, 1,210 nm, 1,220 nm, 1,230 nm, 1,240 nm, 1,250 nm, 1,260 nm, 1,270 nm, 1,280 nm, 1,290 nm, 1,300 nm, 1,310 nm, 1,320 nm, 1,330 nm, 1,340 nm, 1,350 nm, 1,360 nm, 1,370 nm, 1,380 nm, 1,390 nm, 1,400 nm, or more. The lasers may emit light comprising one or more wavelengths of at most about 1,400 nm, 1,390 nm, 1,380 nm, 1,370 nm, 1,360 nm, 1,350 nm, 1,340 nm, 1,330 nm, 1,320 nm, 1,310 nm, 1,300 nm, 1,290 nm, 1,280 nm, 1,270 nm, 1,260 nm, 1,250 nm, 1,240 nm, 1,230 nm, 1,220 nm, 1,210 nm, 1,200 nm, 1,190 nm, 1,180 nm, 1,170 nm, 1,160 nm, 1,150 nm, 1,140 nm, 1,130 nm, 1,120 nm, 1.110 nm, 1,100 nm, 1,090 nm, 1,080 nm, 1,070 nm, 1,060 nm, 1,050 nm, 1,040 nm, 1,030 nm, 1,020 nm, 1,010 nm, 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm 530 nm, 520 nm, 510 nm, 500 nm, 490 nm, 480 nm, 470 nm, 460 nm, 450 nm, 440 mm, 430 nm, 420 nm, 410 nm, 400 nm, 390 nm, 380 nm, 370 nm, 360 nm, 350 nm, 340 nm, 330 nm, 320 nm, 310 nm, 300 nm, 290 nm, 280 nm, 270 nm, 260 nm, 250 nm, 240 nm, 230 nm, 220 nm, 210 nm, 200 nm. The lasers may emit light comprising one or more wavelengths that are within a range defined by any two of the preceding values.

The lasers may emit light having a bandwidth of at least about 1×10⁻¹⁵ nm, 2×10⁻¹⁵ nm, 3×10⁻¹⁵ nm, 4×10⁻¹⁵ nm, 5×10⁻¹⁵ nm, 6×10⁻¹⁵ nm, 7×10⁻¹⁵ nm, 8×10⁻¹⁵ nm, 9×10⁻¹⁵ nm, 1×10⁻¹⁴ nm, 2×10⁻¹⁴ nm, 3×10⁻¹⁴ nm, 4×10⁻¹⁴ nm, 5×10⁻¹⁴ nm, 6×10⁻¹⁴ nm, 7×10⁻¹⁴ nm, 8×10⁻¹⁴ nm, 9×10⁻¹⁴ nm, 1×10⁻¹³ nm, 2×10⁻¹³ nm, 3×10⁻¹³ nm, 4×10⁻¹³ nm, 5×10⁻¹³ nm, 6×10⁻¹³ nm, 7×10⁻¹³ nm, 8×10⁻¹³ nm, 9×10⁻¹³ nm, 1×10⁻¹² nm, 2×10⁻¹² nm, 3×10⁻¹² nm, 4×10⁻¹² nm, 5×10⁻¹² nm, 6×10⁻¹² nm, 7×10⁻¹² nm, 8×10⁻¹² nm, 9×10⁻¹² nm, 1×10⁻¹¹ nm, 2×10⁻¹¹ nm, 3×10⁻¹¹ nm, 4×10⁻¹¹ nm, 5×10⁻¹¹ nm, 6×10⁻¹¹ nm, 7×10⁻¹¹ nm, 8×10⁻¹¹ nm, 9×10⁻¹¹ nm, 1×10⁻¹⁰ nm, 2×10⁻¹⁰ nm, 3×10⁻¹⁰ nm, 4×10⁻¹⁰ nm, 5×10⁻¹⁰ nm, 6×10⁻¹⁰ nm, 7×10⁻¹⁰ nm, 8×10⁻¹⁰ nm, 9×10⁻¹⁰ nm, 1×10⁻⁹ nm, 2×10⁻⁹ nm, 3×10⁻⁹ nm, 4×10⁻⁹ nm, 5×10⁻⁹ nm, 6×10⁻⁹ nm, 7×10⁻⁹ nm, 8×10⁻⁹ nm, 9×10⁻⁹ nm, 1×10⁻⁸ nm, 2×10⁻⁸ nm, 3×10⁻⁸ nm, 4×10⁻⁸ nm, 5×10⁻⁸ nm, 6×10⁻⁸ nm, 7×10⁻⁸ nm, 8×10⁻⁸ nm, 9×10⁻⁸ nm, 1×10⁻⁷ nm, 2×10⁻⁷ nm, 3×10⁻⁷ nm, 4×10⁻⁷ nm, 5×10⁻⁷ nm, 6×10⁻⁷ nm, 7×10⁻⁷ nm, 8×10⁻⁷ nm, 9×10⁻⁷ nm, 1×10⁻⁶ nm, 2×10⁻⁶ nm, 3×10⁻⁶ nm, 4×10⁻⁶ nm, 5×10⁻⁶ nm, 6×10⁻⁶ nm, 7×10⁻⁶ nm, 8×10⁻⁶ nm, 9×10⁻⁶ nm, 1×10⁻⁵ nm, 2×10⁻⁵ nm, 3×10⁻⁵ nm, 4×10⁻⁵ nm, 5×10⁻⁵ nm, 6×10⁻⁵ nm, 7×10⁻⁵ nm, 8×10⁻⁵ nm, 9×10⁻⁵ nm, 1×10⁻⁴ nm, 2×10⁻⁴ nm, 3×10⁻⁴ nm, 4×10⁻⁴ nm, 5×10⁻⁴ nm, 6×10⁻⁴ nm, 7×10⁻⁴ nm, 8×10⁻⁴ nm, 9×10⁻⁴ nm, 1×10⁻³ nm, or more. The lasers may emit light having a bandwidth of at most about 1×10⁻³ nm, 9×10⁻⁴ nm, 8×10⁻⁴ nm, 7×10⁻⁴ nm, 6×10⁻⁴ nm, 5×10⁻⁴ nm, 4×10⁻⁴ nm, 3×10⁻⁴ nm, 2×10⁻⁴ nm, 1×10⁻⁴ nm, 9×10⁻⁵ nm, 8×10⁻⁵ nm, 7×10⁻⁵ nm, 6×10⁻⁵ nm, 5×10⁻⁵ nm, 4×10⁻⁵ nm, 3×10⁻⁵ nm, 2×10⁻⁵ nm, 1×10⁻⁵ nm, 9×10⁻⁶ nm, 8×10⁻⁶ nm, 7×10⁻⁶ nm, 6×10⁻⁶ nm, 5×10⁻⁶ nm, 4×10⁻⁶ nm, 3×10⁻⁶ nm, 2×10⁻⁶ nm, 1×10⁻⁶ nm, 9×10⁻⁷ nm, 8×10⁻⁷ nm, 7×10⁻⁷ nm, 6×10⁻⁷ nm, 5×10⁻⁷ nm, 4×10⁻⁷ nm, 3×10⁻⁷ nm, 2×10⁻⁷ nm, 1×10⁻⁷ nm, 9×10⁻⁸ nm, 8×10⁻⁸ nm, 7×10⁻⁸ nm, 6×10⁻⁸ nm, 5×10⁻⁸ nm, 4×10⁻⁸ nm, 3×10⁻⁸ nm, 2×10⁻⁸ nm, 1×10⁻⁸ nm, 9×10⁻⁹ nm, 8×10⁻⁹ nm, 7×10⁻⁹ nm, 6×10⁻⁹ nm, 5×10⁻⁹ nm, 4×10⁻⁹ nm, 3×10⁻⁹ nm, 2×10⁻⁹ nm, 1×10⁻⁹ nm, 9×10⁻¹⁰ nm, 8×10⁻¹⁰ nm, 7×10⁻¹⁰ nm, 6×10⁻¹⁰ nm, 5×10⁻¹⁰ nm, 4×10⁻¹⁰ nm, 3×10⁻¹⁰ nm, 2×10⁻¹⁰ nm, 1×10⁻¹⁰ nm, 9×10⁻¹¹ nm, 8×10⁻¹¹ nm, 7×10⁻¹¹ nm 6×10⁻¹¹ nm, 5×10⁻¹¹ nm, 4×10⁻¹¹ nm, 3×10⁻¹¹ nm, 2×10⁻¹¹ nm, 1×10⁻¹¹ nm, 9×10⁻¹² nm, 8×10⁻¹² nm, 7×10⁻¹² nm, 6×10⁻¹² nm, 5×10⁻¹² nm, 4×10⁻¹² nm, 3×10⁻¹² nm, 2×10⁻¹² nm, 1×10⁻¹² nm, 9×10⁻¹³ nm, 8×10⁻¹³ nm, 7×10⁻¹³ nm, 6×10⁻¹³ nm, 5×10⁻¹³ nm, 4×10⁻¹³ nm, 3×10⁻¹³ nm, 2×10⁻¹³ nm, 1×10⁻¹³ nm, 9×10⁻¹⁴ nm, 8×10⁻¹⁴ nm, 7×10⁻¹⁴ nm, 6×10⁻¹⁴ nm, 5×10⁻¹⁴ nm, 4×10⁻¹⁴ nm, 3×10⁻¹⁴ nm, 2×10⁻¹⁴ nm, 1×10⁻¹⁴ nm, 9×10⁻¹⁵ nm, 8×10⁻¹⁵ nm, 7×10⁻¹⁵ nm, 6×10⁻¹⁵ nm, 5×10⁻¹⁵ nm, 4×10⁻¹⁵ nm, 3×10⁻¹⁵ nm, 2×10⁻¹⁵ nm, 1×10⁻¹⁵ nm, or less. The lasers may emit light having a bandwidth that is within a range defined by any two of the preceding values.

The light sources may be configured to emit light tuned to one or more magic wavelengths corresponding to the plurality of atoms. A magic wavelength corresponding to an atom may comprise any wavelength of light that gives rise to equal or nearly equal polarizabilities of the first and second atomic states. The magic wavelengths for a transition between the first and second atomic states may be determined by calculating the wavelength-dependent polarizabilities of the first and second atomic states and finding crossing points. Light tuned to such a magic wavelength may give rise to equal or nearly equal differential light shifts in the first and second atomic states, regardless of the intensity of the light emitted by the light sources. This may effectively decouple the first and second atomic states from motion of the atoms. The magic wavelengths may utilize one or more scalar or tensor light shifts. The scalar or tensor light shifts may depend on magnetic sublevels within the first and second atomic states.

For instance, group III atoms and metastable states of alkaline earth or alkaline earth-like atoms may possess relatively large tensor shifts whose angle relative to an applied magnetic field may be tuned to cause a situation in which scalar and tensor shifts balance and give a zero or near zero differential light shift between the first and second atomic states. The angle θ may be tuned by selecting the polarization of the emitted light. For instance, when the emitted light is linearly polarized, the total polarizability α may be written as a sum of the scalar component α_{scalar}, and the tensor component αₜₑₙₛₒᵣ:

$$α = {α}_{scalar} + ( 3 cos {θ}^{2} - 1 ) {α}_{tensor}$$

By choosing θ appropriately, the polarizability of the first and second atomic states may be chosen to be equal or nearly equal, corresponding to a zero or near zero differential light shift and the motion of the atoms may be decoupled.

The light sources may be configured to direct light to one or more optical modulators (OMs) configured to generate the plurality of optical trapping sites. For instance, the optical trapping unit may comprise an OM 214 configured to generate the plurality of optical trapping sites. Although depicted as comprising one OM in FIG. 3A, the optical trapping unit may comprise any number of OMs, such as at least about 1, 2, 3, 4, 5, 6, 7, 8, 9, 10, or more OMs or at most about 10, 9, 8, 7, 6, 5, 4, 3, 2, or 1 OMs. The OMs may comprise one or more digital micromirror devices (DMDs). The OMs may comprise one or more liquid crystal devices, such as one or more liquid crystal on silicon (LCoS) devices. The OMs may comprise one or more spatial light modulators (SLMs). The OMs may comprise one or more acousto-optic deflectors (AODs) or acousto-optic modulators (AOMs). The OMs may comprise one or more electro-optic deflectors (EODs) or electro-optic modulators (EOMs).

The OM may be optically coupled to one or more optical element to generate a regular array of optical trapping sites. For instance, the OM may be optically coupled to optical element 219, as shown in FIG. 3A. The optical elements may comprise lenses or microscope objectives configured to re-direct light from the OMs to form a regular rectangular grid of optical trapping sites.

For instance, as shown in FIG. 3A, the OM may comprise an SLM, DMD, or LCoS device. The SLM, DMD, or LCoS device may be imaged onto the back focal plane of the microscope objectives. This may allow for the generation of an arbitrary configuration of optical trapping sites in two or three dimensions.

Alternatively or in addition, the OMs may comprise first and second AODs. The active regions of the first and second AODs may be imaged onto the back focal plane of the microscope objectives. The output of the first AOD may be optically coupled to the input of the second AOD. In this manner, the second AOD may make a copy of the optical output of the first AOD. This may allow for the generation of optical trapping sites in two or three dimensions.

Alternatively or in addition, the OMs may comprise static optical elements, such as one or more microlens arrays or holographic optical elements. The static optical elements may be imaged onto the back focal plane of the microscope objectives. This may allow for the generation of an arbitrary configuration of optical trapping sites in two or three dimensions.

The optical trapping unit may comprise one or more imaging units configured to obtain one or more images of a spatial configuration of the plurality of atoms trapped within the optical trapping sites. For instance, the optical trapping unit may comprise imaging unit 215. Although depicted as comprising a single imaging unit in FIG. 3A, the optical trapping unit may comprise any number of imaging units, such as at least about 1, 2, 3, 4, 5, 6, 7, 8, 9, 10, or more imaging units or at most about 10, 9, 8, 7, 6, 5, 4, 3, 2, or 1 imaging units. The imaging units may comprise one or more lens or objectives. The imaging units may comprise one or more PMTs, photodiodes, avalanche photodiodes, phototransistors, reverse-biased LEDs, CCDs, or CMOS cameras. The imaging unit may comprise one or more fluorescence detectors. The images may comprise one or more fluorescence images, single-atom fluorescence images, absorption images, single-atom absorption images, phase contrast images, or single-atom phase contrast images.

The optical trapping unit may comprise one or more spatial configuration artificial intelligence (AI) units configured to perform one or more AI operations to determine the spatial configuration of the plurality of atoms trapped within the optical trapping sites based on the images obtained by the imaging unit. For instance, the optical trapping unit may comprise spatial configuration AI unit 216. Although depicted as comprising a single spatial configuration AI unit in FIG. 3A, the optical trapping unit may comprise any number of spatial configuration AI units, such as at least about 1, 2, 3, 4, 5, 6, 7, 8, 9, 10, or more spatial configuration AI units or at most about 10, 9, 8, 7, 6, 5, 4, 3, 2, or 1 spatial configuration AI units. The AI operations may comprise any machine learning (ML) or reinforcement learning (RL) operations described herein.

The optical trapping unit may comprise one or more atom rearrangement units configured to impart an altered spatial arrangement of the plurality of atoms trapped with the optical trapping sites based on the one or more images obtained by the imaging unit. For instance, the optical trapping unit may comprise atom rearrangement unit 217. Although depicted as comprising a single atom rearrangement unit in FIG. 3A, the optical trapping unit may comprise any number of atom rearrangement units, such as at least about 1, 2, 3, 4, 5, 6, 7, 8, 9, 10, or more atom rearrangement units or at most about 10, 9, 8, 7, 6, 5, 4, 3, 2, or 1 atom rearrangement units.

The optical trapping unit may comprise one or more spatial arrangement artificial intelligence (AI) units configured to perform one or more AI operations to determine the altered spatial arrangement of the plurality of atoms trapped within the optical trapping sites based on the images obtained by the imaging unit. For instance, the optical trapping unit may comprise spatial arrangement AI unit 218. Although depicted as comprising a single spatial arrangement AI unit in FIG. 3A, the optical trapping unit may comprise any number of spatial arrangement AI units, such as at least about 1, 2, 3, 4, 5, 6, 7, 8, 9, 10, or more spatial arrangement AI units or at most about 10, 9, 8, 7, 6, 5, 4, 3, 2, or 1 spatial arrangement AI units. The AI operations may comprise any machine learning (ML) or reinforcement learning (RL) operations described herein.

In some cases, the spatial configuration AI units and the spatial arrangement AI units may be integrated into an integrated AI unit. The optical trapping unit may comprise any number of integrated AI units, such as at least about 1, 2, 3, 4, 5, 6, 7, 8, 9, 10, or more integrated AI units, or at most about 10, 9, 8, 7, 6, 5, 4, 3, 2, or 1 integrated AI units.

The atom rearrangement unit may be configured to alter the spatial arrangement in order to obtain an increase in a filling factor of the plurality of optical trapping sites. A filling factor may be defined as a ratio of the number of computationally active optical trapping sites occupied by one or more atoms to the total number of computationally active optical trapping sites available in the optical trapping unit or in a portion of the optical trapping unit. For instance, initial loading of atoms within the computationally active optical trapping sites may give rise to a filling factor of less than 100%, 90%, 80%, 70%, 60%, 50%, or less, such that atoms occupy fewer than 100%, 90%, 70%, 60%, 50%, or less of the available computationally active optical trapping sites, respectively. It may be desirable to rearrange the atoms to achieve a filling factor of at least about 50%, 60%, 70%, 80%, 90%, or 100%. By analyzing the imaging information obtained by the imaging unit, the atom rearrangement unit may attain a filling factor of at least about 50%, 60%, 70%, 80%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99%, or more. The atom rearrangement unit may attain a filling factor of at most about 99.99%, 99.98%, 99.97%, 99.96%, 99.95%, 99.94%, 99.93%, 99.92%, 99.91%, 99.9%, 99.8%, 99.7%, 99.6%, 99.5%, 99.4%, 99.3%, 99.2%, 99.1%, 99%. 98%, 97%, 96%, 95%, 94%, 93%, 92%, 91%, 90%, 80%, 70%, 60%, 50%, or less. The atom rearrangement unit may attain a filling factor that is within a range defined by any two of the preceding values.

By way of example, FIG. 3C shows an example of an optical trapping unit that is partially filled with atoms. As depicted in FIG. 3C, initial loading of atoms within the optical trapping sites may give rise to a filling factor of 44.4% (4 atoms filling 9 available optical trapping sites). By moving atoms from different regions of the optical trapping unit (not shown in FIG. 3C) to unoccupied optical trapping sites or by moving atoms from an atom reservoir described herein, a much higher filling factor may be obtained, as shown in FIG. 3D.

FIG. 3D shows an example of an optical trapping unit that is completely filled with atoms. As depicted in FIG. 3D, fifth atom 212e, sixth atom 212f, seventh atom 212g, eighth atom 212h, and ninth atom 212i may be moved to fill unoccupied optical trapping sites. The fifth, sixth, seventh, eighth, and ninth atoms may be moved from different regions of the optical trapping unit (not shown in FIG. 3C) or by moving atoms from an atom reservoir described herein. Thus, the filling factor may be substantially improved following rearrangement of atoms within the optical trapping sites. For instance, a filling factor of up to 100% (such 9 atoms filling 9 available optical trapping sites, as shown in FIG. 3D) may be attained.

Atom rearrangement may be performed by (i) acquiring an image of the optical trapping unit, identifying filled and unfilled optical trapping sites, (ii) determining a set of moves to bring atoms from filled optical trapping sites to unfilled optical trapping sites, and (iii) moving the atoms from filled optical trapping sites to unfilled optical trapping sites. Operations (i). (ii), and (iii) may be performed iteratively until a large filling factor is achieved. Operation (iii) may comprise translating the moves identified in operation (ii) to waveforms that may be sent to an arbitrary waveform generator (AWG) and using the AWG to drive AODs to move the atoms. The set of moves may be determined using the Hungarian algorithm described in W. Lee et al, “Defect-Free Atomic Array Formation Using Hungarian Rearrangement Algorithm,” Physical Review A 95, 053424 (2017), which is incorporated herein by reference in its entirety for all purposes.

### Example of Electromagnetic Delivery Units

FIG. 4 shows an example of an electromagnetic delivery unit 220. The electromagnetic delivery unit may be configured to apply electromagnetic energy to one or more atoms of the plurality of atoms, as described herein. The electromagnetic delivery unit may comprise one or more light sources, such as any light source described herein. The electromagnetic energy may comprise optical energy. The optical energy may comprise any repetition rate, pulse energy, average power, wavelength, or bandwidth described herein.

The electromagnetic delivery unit may comprise one or more microwave or radio-frequency (RF) energy sources, such as one or more magnetrons, klystrons, traveling-wave tubes, gyrotrons, field-effect transistors (FETs), tunnel diodes, Gunn diodes, impact ionization avalanche transit-time (IMPATT) diodes, or masers. The electromagnetic energy may comprise microwave energy or RF energy. The RF energy may comprise one or more wavelengths of at least about 1 millimeter (mm), 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, 1 meter (m), 2 m, 3 m, 4 m, 5 m, 6 m, 7 m, 8 m, 9 m, 10 m, 20 m, 30 m, 40 m, 50 m, 60 m, 70 m, 80 m, 90 m, 100 m, 200 m, 300 m, 400 m, 500 m, 600 m, 700 m, 800 m, 900 m, 1 kilometer (km), 2 km, 3 km, 4 km, 5 km, 6 km, 7 km, 8 km, 9 km, 10 km, or more. The RF energy may comprise one or more wavelengths of at most about 10 km, 9 km, 8 km, 7 km, 6 km, 5 km, 4 km, 3 km, 2 km, 1 km, 900 m, 800 m, 700 m, 600 m, 500 m, 400 m, 300 m, 200 m, 100 m, 90 m, 80 m, 70 m, 60 m, 50 m, 40 m, 30 m, 20 m, 10 m, 9 m, 8 m, 7 m, 6 m, 5 m, 4 m, 3 m, 2 m, 1 m, 900 mm, 800 mm, 700 mm, 600 mm, 500 mm, 400 mm, 300 mm, 200 mm, 100 mm, 90 mm, 80 mm, 70 mm, 60 mm, 50 mm, 40 mm, 30 mm, 20 mm, 10 mm, 9 mm, 8 mm, 7 mm, 6 mm, 5 mm, 4 mm, 3 mm, 2 mm, 1 mm, or less. The RF energy may comprise one or more wavelengths that are within a range defined by any two of the preceding values.

The RF energy may comprise an average power of at least about 1 microwatt (μW), 2 μW, 3 μW, 4 μW, 5 μW, 6 μW, 7 μW, 8 μW, 9 μW, 10 μW, 20 μW, 30 μW, 40 μW, 50 μW, 60 μW, 70 μW, 80 μW, 90 μW, 100 μW, 200 μW, 300 μW, 400 μW, 500 μW, 600 μW, 700 μW, 800 μW, 900 μW, 1 milliwatt (mW), 2 mW, 3 mW, 4 mW, 5 mW, 6 mW, 7 mW, 8 mW, 9 mW, 10 mW, 20 mW, 30 mW, 40 mW, 50 mW, 60 mW, 70 mW, 80 mW, 90 mW, 100 mW, 200 mW, 300 mW, 400 mW, 500 mW, 600 mW, 700 mW, 800 mW, 900 mW, 1 Watt (W), 2 W, 3 W, 4 W, 5 W, 6 W, 7 W, 8 W, 9 W, 10 W, 20 W, 30 W, 40 W, 50 W, 60 W, 70 W, 80 W, 90 W, 100 W, 200 W, 300 W, 400 W, 500 W, 600 W, 700 W, 800 W, 900 W, 1,000 W, or more. The RF energy may comprise an average power of at most about 1,000 W, 900 W, 800 W, 700 W, 600 W, 500 W, 400 W, 300 W, 200 W, 100 W, 90 W, 80 W, 70 W, 60 W, 50 W, 40 W, 30 W, 20 W, 10 W, 9 W, 8 W, 7 W, 6 W, 5 W, 4 W, 3 W, 2 W, 1 W, 900 mW, 800 mW, 700 mW, 600 mW, 500 mW, 400 mW, 300 mW, 200 mW, 100 mW, 90 mW, 80 mW, 70 mW, 60 mW, 50 mW, 40 mW, 30 mW, 20 mW, 10 mW, 9 mW, 8 mW, 7 mW, 6 mW, 5 mW, 4 mW, 3 mW, 2 mW, 1 mW, 900 μW, 800 μW, 700 μW, 600 μW, 500 μW, 400 μW, 300 μW, 200 μW, 100 μW, 90 μW, 80 μW, 70 μW, 60 μW, 50 μW, 40 μW, 30 μW, 20 μW, 10 μW, 9 μW, 8 μW, 7 μW, 6 μW, 5 μW, 4 μW, 3 μW, 2 μW, 1 μW, or less. The RF energy may comprise an average power that is within a range defined by any two of the preceding values.

The electromagnetic delivery unit may comprise one or more light sources, such as any light source described herein. For instance, the electromagnetic delivery unit may comprise light source 221. Although depicted as comprising a single light source in FIG. 4, the electromagnetic delivery unit may comprise any number of light sources, such as at least about 1, 2, 3, 4, 5, 6, 7, 8, 9, 10, or more light sources or at most about 10, 9, 8, 7, 6, 5, 4, 3, 2, or 1 light sources.

The light sources may be configured to direct light to one or more OMs configured to selectively apply the electromagnetic energy to one or more atoms of the plurality of atoms. For instance, the electromagnetic delivery unit may comprise OM 222. Although depicted as comprising a single OM in FIG. 4, the electromagnetic delivery unit may comprise any number of OMs, such as at least about 1, 2, 3, 4, 5, 6, 7, 8, 9, 10, or more OMs or at most about 10, 9, 8, 7, 6, 5, 4, 3, 2, or 1 OMs. The OMs may comprise one or more SLMs, AODs, or AOMs. The OMs may comprise one or more DMDs. The OMs may comprise one or more liquid crystal devices, such as one or more LCoS devices.

The electromagnetic delivery unit may comprise one or more electromagnetic energy artificial intelligence (AI) units configured to perform one or more AI operations to selectively apply the electromagnetic energy to the atoms. For instance, the electromagnetic delivery unit may comprise AI unit 223. Although depicted as comprising a single AI unit in FIG. 4, the electromagnetic delivery unit may comprise any number of AI units, such as at least about 1, 2, 3, 4, 5, 6, 7, 8, 9, 10, or more AI units or at most about 10, 9, 8, 7, 6, 5, 4, 3, 2, or 1 AI units. The AI operations may comprise any machine learning (ML) or reinforcement learning (RL) operations described herein.

The electromagnetic delivery unit may be configured to apply one or more single-qubit operations (such as one or more single-qubit gate operations) on the qubits described herein. The electromagnetic delivery unit may be configured to apply one or more two-qubit operations (such as one or more two-qubit gate operations) on the two-qubit units described herein. Each single-qubit or two-qubit operation may comprise a duration of at least about 10 nanoseconds (ns), 20 ns, 30 ns, 40 ns, 50 ns, 60 ns, 70 ns, 80 ns, 90 ns, 100 ns, 200 ns, 300 ns, 400 ns, 500 ns, 600 ns, 700 ns, 800 ns, 900 ns, 1 microsecond (ps), 2 μs, 3 μs, 4 μs, 5 μs, 6 μs, 7 μs, 8 μs, 9 μs, 10 μs, 20 μs, 30 μs, 40 μs, 50 μs, 60 μs, 70 μs, 80 μs, 90 μs, 100 μs, or more. Each single-qubit or two-qubit operation may comprise a duration of at most about 100 μs, 90 μs, 80 μs, 70 μs, 60 μs, 50 μs, 40 μs, 30 μs, 20 μs, 10 μs, 9 μs, 8 μs, 7 μs, 6 μs, 5 μs, 4 μs, 3 μs, 2 μs, 1 μs, 900 ns, 800 ns, 700 ns, 600 ns, 500 ns, 400 ns, 300 ns, 200 ns, 100 ns, 90 ns, 80 ns, 70 ns, 60 ns, 50 ns, 40 ns, 30 ns, 20 ns, 10 ns, or less. Each single-qubit or two-qubit operation may comprise a duration that is within a range defined by any two of the preceding values. The single-qubit or two-qubit operations may be applied with a repetition frequency of at least 1 kilohertz (kHz), 2 kHz, 3 kHz, 4 kHz, 5 kHz, 6 kHz, 7 kHz, 8 kHz, 9 kHz, 10 kHz, 20 kHz, 30 kHz, 40 kHz, 50 kHz, 60 kHz, 70 kHz, 80 kHz, 90 kHz, 100 kHz, 200 kHz, 300 kHz, 400 kHz, 500 kHz, 600 kHz, 700 kHz, 800 kHz, 900 kHz, 1,000 kHz, or more. The single-qubit or two-qubit operations may be applied with a repetition frequency of at most 1,000 kHz, 900 kHz, 800 kHz, 700 kHz, 600 kHz, 500 kHz, 400 kHz, 300 kHz, 200 kHz, 100 kHz, 90 kHz, 80 kHz, 70 kHz, 60 kHz, 50 kHz, 40 kHz, 30 kHz, 20 kHz, 10 kHz, 9 kHz, 8 kHz, 7 kHz, 6 kHz, 5 kHz, 4 kHz, 3 kHz, 2 kHz, 1 kHz, or less. The single-qubit or two-qubit operations may be applied with a repetition frequency that is within a range defined by any two of the preceding values.

The electromagnetic delivery unit may be configured to apply one or more single-qubit operations by inducing one or more Raman transitions between a first qubit state and a second qubit state described herein. The Raman transitions may be detuned from a ³P₀ or ³P₁ line described herein. For instance, the Raman transitions may be detuned by at least about 1 kHz, 2 kHz, 3 kHz, 4 kHz, 5 kHz, 6 kHz, 7 kHz, 8 kHz, 9 kHz, 10 kHz, 20 kHz, 30 kHz, 40 kHz, 50 kHz, 60 kHz, 70 kHz, 80 kHz, 90 kHz, 100 kHz, 200 kHz, 300 kHz, 400 kHz, 500 kHz, 600 kHz, 700 kHz, 800 kHz, 900 kHz. 1 MHz, 2 MHz, 3 MHz, 4 MHz, 5 MHz, 6 MHz, 7 MHz, 8 MHz, 9 MHz, 10 MHz, 20 MHz, 30 MHz, 40 MHz, 50 MHz, 60 MHz, 70 MHz, 80 MHz, 90 MHz, 100 MHz, 200 MHz, 300 MHz, 400 MHz, 500 MHz, 600 MHz, 700 MHz, 800 MHz. 900 MHz, 1 GHz, or more. The Raman transitions may be detuned by at most about 1 GHz, 900 MHz, 800 MHz, 700 MHz, 600 MHz, 500 MHz, 400 MHz, 300 MHz, 200 MHz, 100 MHz, 90 MHz. 80 MHz, 70 MHz, 60 MHz, 50 MHz, 40 MHz, 30 MHz, 20 MHz, 10 MHz, 9 MHz, 8 MHz, 7 MHz, 6 MHz, 5 MHz, 4 MHz, 3 MHz, 2 MHz, 1 MHz, 900 kHz, 800 kHz, 700 kHz, 600 kHz, 500 kHz, 400 kHz, 300 kHz, 200 kHz, 100 kHz, 90 kHz, 80 kHz, 70 kHz, 60 kHz, 50 kHz, 40 kHz, 30 kHz, 20 kHz, 10 kHz, 9 kHz, 8 kHz, 7 kHz, 6 kHz, 5 kHz, 4 kHz, 3 kHz, 2 kHz, 1 kHz, or less. The Raman transitions may be detuned by a value that is within a range defined by any two of the preceding values.

Raman transitions may be induced on individually selected atoms using one or more spatial light modulators (SLMs) or acousto-optic deflectors (AODs) to impart a deflection angle and/or a frequency shift to a light beam based on an applied radio-frequency (RF) signal. The SLM or AOD may be combined with an optical conditioning system that images the SLM or AOD active region onto the back focal plane of a microscope objective. The microscope objective may perform a spatial Fourier transform on the optical field at the position of the SLM or AOD. As such, angle (which may be proportional to RF frequency) may be converted into position. For example, applying a comb of radio frequencies to an AOD may generate a linear array of spots at a focal plane of the objective, with each spot having a finite extent determined by the characteristics of the optical conditioning system (such as the point spread function of the optical conditioning system).

To perform a Raman transition on a single atom with a single SLM or AOD, a pair of frequencies may be applied to the SLM or AOD simultaneously. The two frequencies of the pair may have a frequency difference that matches or nearly matches the splitting energy between the first and second qubit states. For instance, the frequency difference may differ from the splitting energy by at most about 1 MHz, 900 kHz, 800 kHz, 700 kHz, 600 kHz, 500 kHz, 400 kHz, 300 kHz, 200 kHz, 100 kHz, 90 kHz, 80 kHz, 70 kHz, 60 kHz, 50 kHz, 40 kHz, 30 kHz, 20 kHz, 10 kHz, 9 kHz, 8 kHz, 7 kHz, 6 kHz, 5 kHz, 4 kHz, 3 kHz, 2 kHz, 1 kHz, 900 Hz, 800 Hz, 700 Hz, 600 Hz, 500 Hz, 400 Hz, 300 Hz, 200 Hz, 100 Hz, 90 Hz, 80 Hz, 70 Hz, 60 Hz, 50 Hz, 40 Hz, 30 Hz, 20 Hz, 10 Hz, 9 Hz, 8 Hz, 7 Hz, 6 Hz, 5 Hz, 4 Hz, 3 Hz, 2 Hz, 1 Hz, or less. The frequency difference may differ from the splitting energy by at least about 1 Hz, 2 Hz, 3 Hz, 4 Hz, 5 Hz, 6 Hz, 7 Hz, 8 Hz, 9 Hz, 10 Hz, 20 Hz, 30 Hz, 40 Hz, 50 Hz, 60 Hz, 70 Hz, 80 Hz, 90 Hz, 100 Hz, 200 Hz, 300 Hz, 400 Hz, 500 Hz, 600 Hz, 700 Hz, 800 Hz, 900 Hz, 1 kHz, 2 kHz, 3 kHz, 4 kHz, 5 kHz, 6 kHz, 7 kHz, 8 kHz, 9 kHz, 10 kHz, 20 kHz, 30 kHz, 40 kHz, 50 kHz, 60 kHz, 70 kHz, 80 kHz, 90 kHz, 100 kHz, 200 kHz, 300 kHz, 400 kHz, 500 kHz, 600 kHz, 700 kHz, 800 kHz, 900 kHz, 1 MHz, or more. The frequency difference may differ from the splitting energy by about 0 Hz. The frequency difference may differ from the splitting energy by a value that is within a range defined by any two of the preceding values. The optical system may be configured such that the position spacing corresponding to the frequency difference is not resolved and such that light at both of the two frequencies interacts with a single atom.

The electromagnetic delivery units may be configured to provide a beam with a characteristic dimension of at least about 10 nm, 50 nm, 75 nm, 100 nm, 125 nm, 150 nm, 175 nm, 200 nm, 225 nm, 250 nm, 275 nm, 300 nm, 325 nm, 350 nm, 375 nm, 400 nm, 425 nm, 450 nm, 475 nm, 500 nm, 525 nm, 550 nm, 575 nm, 600 nm, 625 nm, 650 nm, 675 nm, 700 nm, 725 nm, 750 nm, 775 nm, 800 nm, 825 nm, 850 nm, 875 nm, 900 nm, 925 nm, 950 nm, 975 nm, 1 micrometer (μm), 1.5 μm, 2 μm, 2.5 μm 3 μm, 3.5 μm, 4 μm, 4.5 μm, 5 μm, 5.5 μm, 6 μm, 6.5 μm, 7 μm, 7.5 μm, 8 μm, 8.5 μm, 9 μm, 9.5 μm, 10 μm, or more. The electromagnetic delivery units may be configured to provide a beam with a characteristic dimension of at most about 10 μm, 9.5 μm, 9 μm, 8.5 μm, 8 μm, 7.5 μm, 7 μm, 6.5 μm, 6 μm, 5.5 μm, 5 μm, 4.5 μm, 4 μm, 3.5 μm, 3 μm, 2.5 μm, 2 μm, 1.5 μm, 1 μm, 975 nm, 950 nm, 925 nm, 900 nm, 875 nm, 850 nm, 825 nm, 800 nm, 775 nm, 750 nm, 725 nm, 700 nm, 675 nm, 650 nm, 625 nm, 600 nm, 575 nm, 550 nm, 525 nm, 500 nm, 475 nm, 450 nm, 425 nm, 400 nm, 375 nm, 350 nm, 325 nm, 300 nm, 275 nm, 250 nm, 225 nm, 200 nm, 175 nm, 150 nm, 125 nm, 100 nm, 75 nm, 25 nm, 10 nm, or less. The electromagnetic delivery units may be configured to provide a beam with a characteristic dimension as defined by any two of the proceeding values. For example, the beam can have a characteristic dimension of about 1.5 micrometers to about 2.5 micrometers. Examples of characteristic dimensions include, but are not limited to, a Gaussian beam waist, the full width at half maximum (FWHM) of the beam size, the beam diameter, the 1/e² width, the D4σ width, the D86 width, and the like. For example, the beam may have a Gaussian beam waist of at least about 1.5 micrometers.

The characteristic dimension of the beam may be bounded at the low end by the size of the atomic wavepacket of an optical trapping site. For example, the beam can be formed such that the intensity variation of the beam over the trapping site is sufficiently small as to be substantially homogeneous over the trapping site. In this example, the beam homogeneity can improve the fidelity of a qubit in the trapping site. The characteristic dimension of the beam may be bounded at the high end by the spacing between trapping sites. For example, a beam can be formed such that it is small enough that the effect of the beam on a neighboring trapping site/atom is negligible. In this example, the effect may be negligible if the effect can be minimized by techniques such as, for example, composite pulse engineering. The characteristic dimension may be different from a maximum achievable resolution of the system. For example, a system can have a maximum resolution of 700 nm, but the system may be operated at 1.5 micrometers. In this example, the value of the characteristic dimension may be selected to optimize the performance of the system in view of the considerations described elsewhere herein. The characteristic dimension may be invariant for different maximally achievable resolutions. For example, a system with a maximum resolution of 500 nm and a system with a maximum resolution of 2 micrometers may both be configured to operate at a characteristic dimension of 2 micrometers. In this example, 2 micrometers may be the optimal resolution based on the size of the trapping sites.

### Example of Integrated Optical Trapping Units and Electromagnetic Delivery Units

The optical trapping units and electromagnetic delivery units described herein may be integrated into a single optical system. A microscope objective may be used to deliver electromagnetic radiation generated by an electromagnetic delivery unit described herein and to deliver light for trapping atoms generated by an optical trapping unit described herein. Alternatively or in addition, different objectives may be used to deliver electromagnetic radiation generated by an electromagnetic delivery unit and to deliver light from trapping atoms generated by an optical trapping unit.

A single SLM or AOD may allow the implementation of qubit operations (such as any single-qubit or two-qubit operations described herein) on a linear array of atoms. Alternatively or in addition, two separate SLMs or AODs may be configured to each handle light with orthogonal polarizations. The light with orthogonal polarizations may be overlapped before the microscope objective. In such a scheme, each photon used in a two-photon transition described herein may be passed to the objective by a separate SLM or AOD, which may allow for increased polarization control. Qubit operations may be performed on a two-dimensional arrangement of atoms by bringing light from a first SLM or AOD into a second SLM or AOD that is oriented substantially orthogonally to the first SLM or AOD via an optical relay. Alternatively or in addition, qubit operations may be performed on a two-dimensional arrangement of atoms by using a one-dimensional array of SLMs or AODs.

The stability of qubit gate fidelity may be improved by maintaining overlap of light from the various light sources described herein (such as light sources associated with the optical trapping units or electromagnetic delivery units described herein). Such overlap may be maintained by an optical subsystem that measures the direction of light emitted by the various light sources, allowing closed-loop control of the direction of light emission. The optical subsystem may comprise a pickoff mirror located before the microscope objective. The pickoff mirror may be configured to direct a small amount of light to a lens, which may focus a collimated beam and convert angular deviation into position deviation. A position-sensitive optical detector, such as a lateral-effect position sensor or quadrant photodiode, may convert the position deviation into an electronic signal and information about the deviation may be fed into a compensation optic, such as an active mirror.

The stability of qubit gate manipulation may be improved by controlling the intensity of light from the various light sources described herein (such as light sources associated with the optical trapping units or electromagnetic delivery units described herein). Such intensity control may be maintained by an optical subsystem that measures the intensity of light emitted by the various light sources, allowing closed-loop control of the intensity. Each light source may be coupled to an intensity actuator, such as an intensity servo control. The actuator may comprise an acousto-optic modulator (AOM) or electro-optic modulator (EOM). The intensity may be measured using an optical detector, such as a photodiode or any other optical detector described herein. Information about the intensity may be integrated into a feedback loop to stabilize the intensity.

### Example of Optical Cavities

The present disclosure provides devices for forming an optical trap. The device may comprise a first optical cavity. The first optical cavity may be configured to form a first standing wave pattern. The first standing wave pattern may be one dimensional or two dimensional. The device may comprise a second optical cavity. The second optical cavity may be configured to form a second standing wave pattern. The second optical cavity may be configured to form a running wave pattern. The device may comprise a chamber configured to hold one or more atoms disposed within a three-dimensional trapping potential formed by at least the first standing wave pattern and the second standing wave pattern.

The one or more atoms may comprise one or more qubits as described elsewhere herein. For example, the one or more atoms may be configured to be usable as one or more qubits. The one or more qubits may be configured to perform a non-classical computation (e.g., a non-classical computation as described elsewhere herein). For example, the one or more qubits can be configured to perform a gate-based quantum computation. In another example, the one or more qubits may be configured to perform a quantum computation. The one or more atoms may comprise at least about 1, 2, 3, 4, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 300, 400, 500, or more atoms. The one or more atoms may comprise at most about 500, 400, 300, 200, 190, 180, 170, 160, 150, 140, 130, 120, 110, 100, 95, 90, 85, 80, 75, 70, 65, 60, 55, 50, 45, 40, 35, 30, 25, 20, 15, 10, 5, 4, 3, 2, or fewer atoms. The one or more atoms may comprise a number of atoms as defined by any two of the proceeding values. For example, the one or more atoms may comprise from about 75 to about 150 atoms. The one or more atoms may comprise neutral atoms. For example, the one or more atoms may comprise atoms that are not ionized (e.g., are in a neutral state). Each atom of the one or more atoms may be a neutral atom. For example, each atom of an array of atoms can be not ionized. The one or more atoms may comprise rare earth atoms (e.g., lanthanide series atoms (e.g., ytterbium, neodymium, lanthanum, erbium, etc.), scandium, yttrium, etc.), alkali atoms (e.g., sodium, potassium, etc.), alkali earth atoms (e.g., calcium, strontium (e.g., strontium—87 atoms), etc.), or the like, or any combination thereof.

The present disclosure provides devices for generating a phase stable cavity. The phase stability may comprise a polarization and/or intensity stability for different translations in free space. For example, the polarization and/or intensity may remain the same for different translations in space. The device may comprise a cavity spacer comprising one or more mirrors affixed to the cavity spacer. The one or more mirrors may be oriented to form a three-dimensional trapping potential within the cavity spacer. The cavity spacer may comprise glass having a coefficient of thermal expansion of at least about 1, 2, 3, 4, 5, 6, 7, 8, 9, 10, 20, 30, 40, 50, 60, 70, 80, 90, 100, 200, 300, 400, 500, 600, 700, 800, 900, 1,000, or more parts per billion (ppb) per degree Celsius at 5 to 35° C. The cavity spacer may comprise glass having a coefficient of thermal expansion of at most about 1,000, 900, 800, 700, 600, 500, 400, 300, 200, 100, 90, 80, 70, 60, 50, 40, 30, 20, 10, 9, 8, 7, 6, 5, 4, 3, 2, 1, or less parts per billion (ppb) per degree Celsius at 5 to 35° C. The error of the proceeding values may be about 1, 5, 10, 20, 30, 40, 50, 60, 70, 80, 90, 100, or more parts per billion (ppb) per degree Celsius at 5 to 35° C. Examples of cavity spacer materials include, but are not limited to, fused silica, ultra-low thermal expansion glasses (ULE), or the like.

The one or more mirrors may form a first optical cavity. The first optical cavity may be configured to form a first standing wave pattern. The first standing wave pattern may be one dimensional or two dimensional. The one or more mirrors may form a second optical cavity. The second optical cavity may be configured to form a second standing wave pattern. The one or more atoms may be disposed within the three-dimensional trapping potential formed by at least the first standing wave pattern and the second standing wave pattern. For example, the single cavity spacer can be the single substrate on which the first and second cavity mirrors can be placed. In this example, the first and second cavities can form overlapping potential waves, which in turn can form a plurality of optical traps. The plurality of optical traps can then be used as described elsewhere herein. Using a single spacer for the plurality of cavities can result in increased thermal, and thereby system, stability. In some cases, a plurality of different cavity spacers can be used for the plurality of optical cavities. For example, each optical cavity can be disposed on a different cavity spacer. Using multiple spacers for the plurality of cavities can provide simpler manufacturing and cost savings but may result in lower thermal stability.

### Example of State Preparation Units

FIG. 5 shows an example of a state preparation unit 250. The state preparation unit may be configured to prepare a state of the plurality of atoms, as described herein. The state preparation unit may be coupled to the optical trapping unit and may direct atoms that have been prepared by the state preparation unit to the optical trapping unit. The state preparation unit may be configured to cool the plurality of atoms. The state preparation unit may be configured to cool the plurality of atoms prior to trapping the plurality of atoms at the plurality of optical trapping sites.

The state preparation unit may comprise one or more Zeeman slowers. For instance, the state preparation unit may comprise a Zeeman slower 251. Although depicted as comprising a single Zeeman slower in FIG. 5, the state preparation may comprise any number of Zeeman slowers, such as at least about 1, 2, 3, 4, 5, 6, 7, 8, 9, 10, or more Zeeman slowers or at most about 10, 9, 8, 7, 6, 5, 4, 3, 2, or 1 Zeeman slowers. The Zeeman slowers may be configured to cool one or more atoms of the plurality of atoms from a first velocity or distribution of velocities (such an emission velocity from an of an atom source, room temperature, liquid nitrogen temperature, or any other temperature) to a second velocity that is lower than the first velocity or distribution of velocities.

The first velocity or distribution of velocities may be associated with a temperature of at least about 50 Kelvin (K), 60 K, 70 K, 80 K, 90 K, 100 K, 200 K, 300 K, 400 K, 500 K, 600 K, 700 K, 800 K, 900 K, 1,000 K, or more. The first velocity or distribution of velocities may be associated with a temperature of at most about 1,000 K, 900 K, 800 K, 700 K, 600 K, 500 K, 400 K, 300 K, 200 K, 100 K, 90 K, 80 K, 70 K, 60 K, 50 K, or less. The first velocity or distribution of velocities may be associated with a temperature that is within a range defined by any two of the preceding values. The second velocity may be at least about 1 meter per second (m/s), 2 m/s, 3 m/s, 4 m/s, 5 m/s, 6 m/s, 7 m/s, 8 m/s, 9 m/s, 10 m/s, or more. The second velocity may be at most about 10 m/s, 9 m/s, 8 m/s, 7 m/s, 6 m/s, 5 m/s, 4 m/s, 3 m/s, 2 m/s, 1 m/s, or less. The second velocity may be within a range defined by any two of the preceding values. The Zeeman slowers may comprise 1D Zeeman slowers.

The state preparation unit may comprise a first magneto-optical trap (MOT) 252. The first MOT may be configured to cool the atoms to a first temperature. The first temperature may be at most about 10 millikelvin (mK), 9 mK, 8 mK, 7 mK, 6 mK, 5 mK, 4 mK, 3 mK, 2 mK, 1 mK, 0.9 mK, 0.8 mK, 0.7 mK, 0.6 mK, 0.5 mK, 0.4 mK, 0.3 mK, 0.2 mK, 0.1 mK, or less. The first temperature may be at least about 0.1 mK, 0.2 mK, 0.3 mK, 0.4 mK, 0.5 mK, 0.6 mK, 0.7 mK, 0.8 mK, 0.9 mK, 1 mK, 2 mK, 3 mK, 4 mK, 5 mK, 6 mK, 7 mK, 8 mK, 9 mK, 10 mK, or more. The first temperature may be within a range defined by any two of the preceding values. The first MOT may comprise a 1D, 2D, or 3D MOT.

The first MOT may comprise one or more light sources (such as any light source described herein) configured to emit light. The light may comprise one or more wavelengths of at least about 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, or more. The light may comprise one or more wavelengths of at most about 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 49% nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nm, 650 nm to 1,000 nm, 400 nm to 900 nm, 400 nm to 800 nm, 400 nm to 700 nm, 400 nm to 600 nm, 400 nm to 500 nm, 500 nm to 700 nm, or 650 nm to 700 nm.

The state preparation unit may comprise a second MOT 253. The second MOT may be configured to cool the atoms from the first temperature to a second temperature that is lower than the first temperature. The second temperature may be at most about 100 microkelvin (μK), 90 μK, 80 μK, 70 μK, 60 μK, 50 μK, 40 μK, 30 μK, 20 K, 10 μK, 9 μK, 8 μK, 7 μK, 6 μK, 5 μK, 4 μK, 3 μK, 2 μK, 1 μK, 900 nanokelvin (nK), 800 nK, 700 nK, 600 nK, 500 nK, 400 nK, 300 nK, 200 nK, 100 nK, or less. The second temperature may be at least about 100 nK, 200 nK, 300 nK, 400 nK, 500 nK, 600 nK, 700 nK, 800 nK, 900 nK, 1 μK, 2 μK, 3 μK, 4 μK, 5 μK, 6 μK, 7 μK, 8 μK, 9 μK, 10 μK, 20 μK, 30 μK, 40 μK, 50 μK, 60 μK, 70 μK, 80 μK, 90 μK, 100 μK, or more. The second temperature may be within a range defined by any two of the preceding values. The second MOT may comprise a 1D, 2D, or 3D MOT.

The second MOT may comprise one or more light sources (such as any light source described herein) configured to emit light. The light may comprise one or more wavelengths of at least about 400 nm 410 nm, 420 nm, 430 nm, 440 nm, 450 nm, 460 nm, 470 nm 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, or more. The light may comprise one or more wavelengths of at most about 1,000 nm, 990 nm, 980 nm, 970 nm, 960 nm, 950 nm 940 nm, 930 nm, 920 nm, 910 nm, 900 nm, 890 nm, 880 nm 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nm, 650 nm to 1,000 nm, 400 nm to 900 nm, 400 nm to 800 nm, 400 nm to 700 nm, 400 nm to 600 nm, 400 nm to 500 nm, 500 nm to 700 nm, or 650 nm to 700 nm.

Although depicted as comprising two MOTs in FIG. 5, the state preparation unit may comprise any number of MOTs, such as at least about 1, 2, 3, 4, 5, 6, 7, 8, 9, 10, or more MOTs or at most about 10, 9, 8, 7, 6, 5, 4, 3, 2, or 1 MOTs.

The state preparation unit may comprise one or more sideband cooling units or Sisyphus cooling units (such as a sideband cooling unit described in www.arxiv.org/abs/1810.06626 or a Sisyphus cooling unit described in www.arxiv.org/abs/1811.06014, each of which is incorporated herein by reference in its entirety for all purposes). For instance, the state preparation unit may comprise sideband cooling unit or Sisyphus cooling unit 254. Although depicted as comprising a single sideband cooling unit or Sisyphus cooling unit in FIG. 5, the state preparation may comprise any number of sideband cooling units or Sisyphus cooling units, such as at least about 1, 2, 3, 4, 5, 6, 7, 8, 9, 10, or more sideband cooling units or Sisyphus cooling units, or at most about 10, 9, 8, 7, 6, 5, 4, 3, 2, or 1 sideband cooling units or Sisyphus cooling units. The sideband cooling units or Sisyphus cooling units may be configured to use sideband cooling to cool the atoms from the second temperature to a third temperature that is lower than the second temperature. The third temperature may be at most about 10 μK, 9 μK, 8 μK, 7 μK, 6 μK, 5 μK, 4 μK, 3 μK, 2 μK, 1 μK, 900 nK, 800 nK, 700 nK, 600 nK, 500 nK, 400 nK, 300 nK, 200 nK, 100 nK, 90 nK, 80 nK, 70 nK, 60 nK, 50 nK, 40 nK, 30 nK, 20 nK, 10 nK, or less. The third temperature may be at most about 10 nK, 20 nK, 30 nK, 40 nK, 50 nK, 60 nK, 70 nK, 80 nK, 90 nK, 100 nK, 200 nK, 300 nK, 400 nK, 500 nK, 600 nK, 700 nK, 800 nK, 900 nK, 1 μK, 2 μK, 3 μK, 4 μK, 5 μK, 6 μK, 7 μK, 8 μK, 9 μK, 10 μK, or more. The third temperature may be within a range defined by any two of the preceding values.

The sideband cooling units or Sisyphus cooling units may comprise one or more light sources (such as any light source described herein) configured to emit light. The light may comprise one or more wavelengths of at least about 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, or more. The light may comprise one or more wavelengths of at most about 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1000 nm, 650 nm to 1,000 nm, 400 nm to 900 nm, 400 nm to 800 nm, 400 nm to 700 nm, 400 nm to 600 nm, 400 nm to 500 nm, 500 nm to 700 nm, or 650 nm to 700 nm.

The state preparation unit may comprise one or more optical pumping units. For instance, the state preparation unit may comprise optical pumping unit 255. Although depicted as comprising a single optical pumping unit in FIG. 5, the state preparation may comprise any number of optical pumping units, such as at least about 1, 2, 3, 4, 5, 6, 7, 8, 9, 10, or more optical pumping units, or at most about 10, 9, 8, 7, 6, 5, 4, 3, 2, or 1 optical pumping units. The optical pumping units may be configured to emit light to optically pump the atoms from an equilibrium distribution of atomic states to a non-equilibrium atomic state. For instance, the optical pumping units may be configured to emit light to optically pump the atoms from an equilibrium distribution of atomic states to a single pure atomic state. The optical pumping units may be configured to emit light to optically pump the atoms to a ground atomic state or to any other atomic state. The optical pumping units may be configured to optically pump the atoms between any two atomic states. The optical pumping units may comprise one or more light sources (such as any light source described herein) configured to emit light. The light may comprise one or more wavelengths of at least about 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, or more. The light may comprise one or more wavelengths of at most about 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nm, 650 nm to 1,000 nm, 400 nm to 900 nm, 400 nm to 800 nm, 400 nm to 700 nm, 400 nm to 600 nm, 40 nm to 500 nm, 500 nm to 700 nm, or 650 nm to 700 nm.

The state preparation unit may comprise one or more coherent driving units. For instance, the state preparation unit may comprise coherent driving unit 256. Although depicted as comprising a coherent driving unit in FIG. 5, the state preparation may comprise any number of coherent driving units, such as at least about 1, 2, 3, 4, 5, 6, 7, 8, 9, 10, or more coherent driving units or at most about 10, 9, 8, 7, 6, 5, 4, 3, 2, or 1 coherent driving units. The coherent driving units may be configured to coherently drive the atoms from the non-equilibrium state to the first or second atomic states described herein. Thus, the atoms may be optically pumped to an atomic state that is convenient to access (for instance, based on availability of light sources that emit particular wavelengths or based on other factors) and then coherently driven to atomic states described herein that are useful for performing quantum computations. The coherent driving units may be configured to induce a single photon transition between the non-equilibrium state and the first or second atomic state. The coherent driving units may be configured to induce a two-photon transition between the non-equilibrium state and the first or second atomic state. The two-photon transition may be induced using light from two light sources described herein (such as two lasers described herein).

The coherent driving units may comprise one or more light sources (such as any light source described herein) configured to emit light. The light may comprise one or more wavelengths of at least about 400 nm, 410 nm 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, or more. The light may comprise one or more wavelengths of at most about 1,000 nm, 990 nm, 980 nm, 970 nm, 960 nm, 950 nm 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nm, 650 nm to 1,000 nm, 400 nm to 900 nm, 400 nm to 800 nm, 400 nm to 700 nm, 400 nm to 600 nm, 400 nm to 500 nm, 500 nm to 700 nm, or 650 nm to 700 nm.

The coherent driving units may be configured to induce an RF transition between the non-equilibrium state and the first or second atomic state. The coherent driving units may comprise one or more electromagnetic radiation sources configured to emit electromagnetic radiation configured to induce the RF transition. For instance, the coherent driving units may comprise one or more RF sources (such as any RF source described herein) configured to emit RF radiation. The RF radiation may comprise one or more wavelengths of at least about 10 centimeters (cm), 20 cm, 30 cm, 40 cm, 50 cm, 60 cm, 70 cm, 80 cm, 90 cm, 1 meter (m), 2 m, 3 m, 4 m, 5 m, 6 m, 7 m, 8 m, 9 m, 10 in, or more. The RF radiation may comprise one or more wavelengths of at most about 10 m, 9 m, 8 m, 7 m, 6 m, 5 m, 4 m, 3 m, 2 m, 1 m, 90 cm, 80 cm, 70 cm, 60 cm, 50 cm, 40 cm, 30 cm, 20 cm, 10 cm, or less. The RF radiation may comprise one or more wavelengths that are within a range defined by any two of the preceding values. Alternatively or in addition, the coherent driving units may comprise one or more light sources (such as any light sources described herein) configured to induce a two-photon transition corresponding to the RF transition.

### Example of Controllers

The optical trapping units, electromagnetic delivery units, entanglement units, readout optical units, vacuum units, imaging units, spatial configuration AI units, spatial arrangement AI units, atom rearrangement units, state preparation units, sideband cooling units, optical pumping units, coherent driving units, electromagnetic energy AI units, atom reservoirs, atom movement units, or Rydberg excitation units may include one or more circuits or controllers (such as one or more electronic circuits or controllers) that is connected (for instance, by one or more electronic connections) to the optical trapping units, electromagnetic delivery units, entanglement units, readout optical units, vacuum units, imaging units, spatial configuration AI units, spatial arrangement AI units, atom rearrangement units, state preparation units, sideband cooling units, optical pumping units, coherent driving units, electromagnetic energy AI units, atom reservoirs, atom movement units, or Rydberg excitation units. The circuits or controllers may be configured to control the optical trapping units, electromagnetic delivery units, entanglement units, readout optical units, vacuum units, imaging units, spatial configuration AI units, spatial arrangement AI units, atom rearrangement units, state preparation units, sideband cooling units, optical pumping units, coherent driving units, electromagnetic energy AI units, atom reservoirs, atom movement units, or Rydberg excitation units.

### Example of Non-Classical Computers

The present disclosure provides non-classical computers comprising: a plurality of qubits comprising greater than 60 atoms, each atom trapped within an optical trapping site of a plurality of spatially distinct optical trapping sites, wherein the plurality of qubits comprise at least a first qubit state and a second qubit state, wherein the first qubit state comprises a first atomic state and the second qubit state comprises a second atomic state: one or more electromagnetic delivery units configured to apply electromagnetic energy to one or more qubits of the plurality of qubits, thereby imparting a non-classical operation to the one or more qubits, which non-classical operation includes a superposition between at least the first qubit state and the second qubit state; one or more entanglement units configured to quantum mechanically entangle at least a subset of the plurality of qubits in the superposition with at least another qubit of the plurality of qubits; and one or more readout optical units configured to perform one or more measurements of the one or more qubits, thereby obtaining a non-classical computation.

The present disclosure provides non-classical computers comprising a plurality of qubits comprising greater than 60 atoms each trapped within an optical trapping site of a plurality of spatially distinct optical trapping sites.

### Example of Methods for Performing a Non-Classical Computation

The present disclosure provides methods for performing a non-classical computation, comprising: (a) generating a plurality of spatially distinct optical trapping sites, the plurality of optical trapping sites configured to trap a plurality of atoms, the plurality of atoms comprising greater than 60 atoms; (b) applying electromagnetic energy to one or more atoms of the plurality of atoms, thereby inducing the one or more atoms to adopt one or more superposition states of a first atomic state and at least a second atomic state that is different from the first atomic state; (c) quantum mechanically entangling at least a subset of the one or more atoms in the one or more superposition states with at least another atom of the plurality of atoms; and (d) performing one or more optical measurements of the one or more superposition state to obtain the non-classical computation.

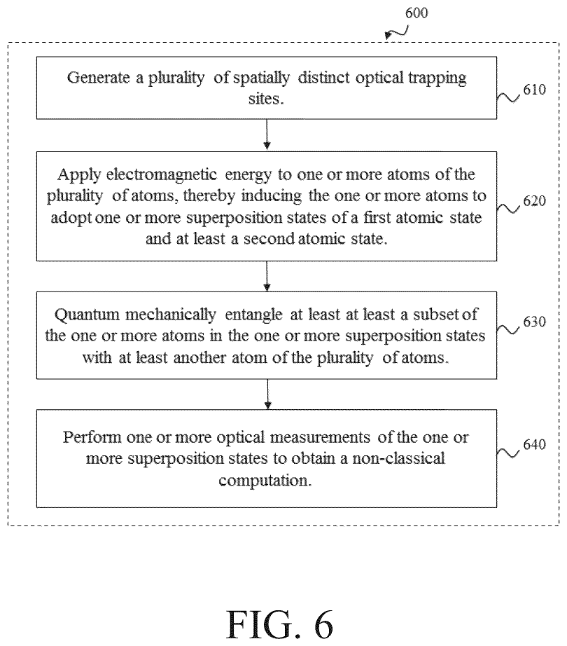

FIG. 6 shows a flowchart for an example of a first method 600 for performing a non-classical computation.

In a first operation 610, the method 600 may comprise generating a plurality of spatially distinct optical trapping sites. The plurality of optical trapping sites may be configured to trap a plurality of atoms. The plurality of atoms may comprise greater than 60 atoms. The optical trapping sites may comprise any optical trapping sites described herein. The atoms may comprise any atoms described herein.

In a second operation 620, the method 600 may comprise applying electromagnetic energy to one or more atoms of the plurality of atoms, thereby inducing the one or more atoms to adopt one or more superposition states of a first atomic state and at least a second atomic state that is different from the first atomic state. The electromagnetic energy may comprise any electromagnetic energy described herein. The first atomic state may comprise any first atomic state described herein. The second atomic state may comprise any second atomic state described herein.

In a third operation 630, the method 600 may comprise quantum mechanically entangling at least a subset of the one or more atoms in the one or more superposition states with at least another atom of the plurality of atoms. The atoms may be quantum mechanically entangled in any manner described herein (for instance, as described herein with respect to FIG. 2).

In a fourth operation 640, the method 600 may comprise performing one or more optical measurements of the one or more superposition state to obtain the non-classical computation. The optical measurements may comprise any optical measurements described herein.

The present disclosure provides methods for performing a non-classical computation, comprising: (a) providing a plurality of qubits comprising greater than 60 atoms, each atom trapped within an optical trapping site of a plurality of spatially distinct optical trapping sites, wherein the plurality of qubits comprise at least a first qubit state and a second qubit state, wherein the first qubit state comprises a first atomic state and the second qubit state comprises a second atomic state: (b) applying electromagnetic energy to one or more qubits of the plurality of qubits, thereby imparting a non-classical operation to the one or more qubits, which non-classical operation includes a superposition between at least the first qubit state and the second qubit state; (c) quantum mechanically entangling at least a subset of the plurality of qubits in the superposition with at least another qubit of the plurality of qubits; and (d) performing one or more optical measurements of the one or more qubits, thereby obtaining said the-classical computation.

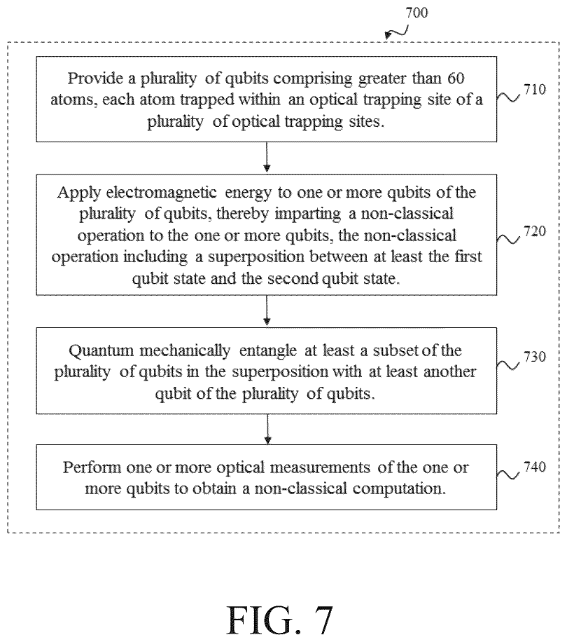

FIG. 7 shows a flowchart for an example of a second method 700 for performing a non-classical computation.

In a first operation 710, the method 700 may comprise providing a plurality of qubits comprising greater than 60 atoms, each atom trapped within an optical trapping site of a plurality of spatially distinct optical trapping sites, wherein the plurality of qubits comprise at least a first qubit state and a second qubit state, wherein the first qubit state comprises a first atomic state and the second qubit state comprises a second atomic state. The optical trapping sites may comprise any optical trapping sites described herein. The qubits may comprise any qubits described herein. The atoms may comprise any atoms described herein. The first qubit state may comprise any first qubit state described herein. The second qubit state may comprise any second qubit state described herein. The first atomic state may comprise any first atomic state described herein. The second atomic state may comprise any second atomic state described herein.

In a second operation 720, the method 700 may comprise applying electromagnetic energy to one or more qubits of the plurality of qubits, thereby imparting a non-classical operation to the one or more qubits, which non-classical operation includes a superposition between at least the first qubit state and the second qubit state. The electromagnetic energy may comprise any electromagnetic energy described herein.

In a third operation 730, the method 700 may comprise quantum mechanically entangling at least a subset of the plurality of qubits in the superposition with at least another qubit of the plurality of qubits. The qubits may be quantum mechanically entangled in any manner described herein (for instance, as described herein with respect to FIG. 2).

In a fourth operation 740, the method 700 may comprise performing one or more optical measurements of the one or more qubits, thereby obtaining the non-classical computation. The optical measurements may comprise any optical measurements described herein.

The present disclosure provides methods for performing a non-classical computation, comprising: (a) providing a plurality of qubits comprising greater than 60 atoms each trapped within an optical trapping site of a plurality of spatially distinct optical trapping sites, and (b) using at least a subset of the plurality of qubits to perform the non-classical computation.

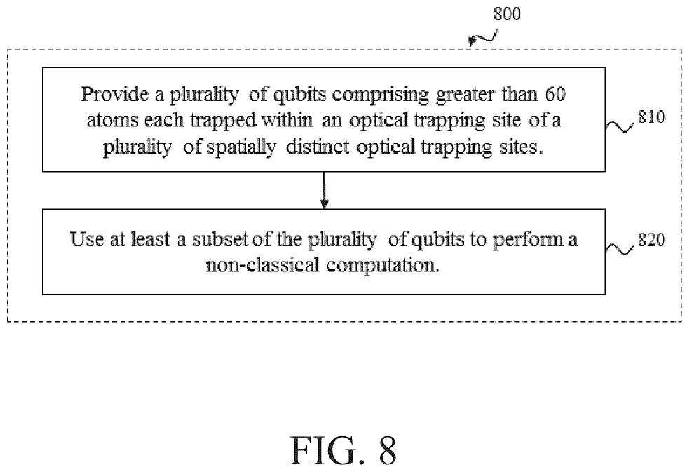

FIG. 8 shows a flowchart for an example of a third method 800 for performing a non-classical computation.

In a first operation 810, the method 800 may comprise providing a plurality of qubits comprising greater than 60 atoms each trapped within an optical trapping site of a plurality of spatially distinct optical trapping sites. The qubits may comprise any qubits described herein. The atoms may comprise any atoms described herein. The optical trapping sites may comprise any optical trapping sites described herein.

In a second operation 820, the method 800 may comprise using at least a subset of the plurality of qubits to perform a non-classical computation.

### Example of Parallel Addressing of Multi-Qubit Units

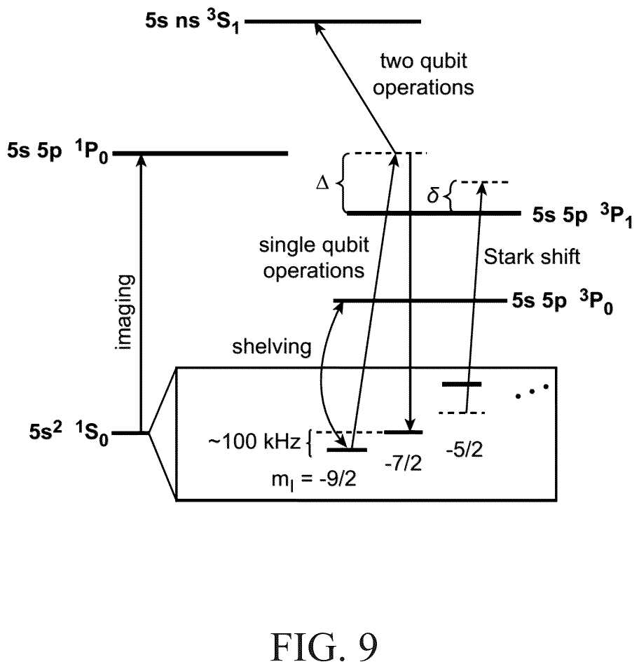

Direct excitation of strontium—87 from the ground state to Rydberg levels would require a laser with a wavelength of approximately 218 nm. Alternatively, the Rydberg excitation operation can be performed using two-photon excitation combining 689 nm and 319 nm light, each detuned from the intermediate ³P₁ state. The approximately 7 kHz width of the ³P₁ state provides an effective balance between the two-photon effective Rabi rate and scattering via spontaneous decay from the ³P₁. FIG. 9 shows an energy level structure for single-qubit and multi-qubit operations in strontium—87.

The optical system for single-qubit operations is also designed to work well for multi-qubit gates. One of the single-qubit beams is used as one leg of the two-photon excitation scheme that drives transitions to the Rydberg electronic manifold. To satisfy the spatially-dependent frequency and phase matching condition, AODs are also used for the UV light. Importantly, the optical systems are matched so that the frequency shift of the UV light from one site to another is identical to that of the 689 nm light. The consequence of this constraint is that the performance of state-of-the-art UV AODs dictate the accessible field of view (FOV) for multi-qubit operations. Further, because one of the single-qubit beams is being used for multi-qubit operations (and the two single-qubit beams are matched), the FOV for single-qubit operations will be the same. A figure of merit for UV AODs is the product of the active aperture and the RF bandwidth of the device. For a fixed beam size in the back focal plane of the objective, increasing either of these quantities results in a larger scan angle of the beams, and thus a larger FOV in the plane of the qubit array. An FOV of approximately 100 μm×100 μm was achieved, which is sufficient to address an array of approximately 1,000 atoms with a trapping site spacing of 3 μm.

### Example of Computer Systems

FIG. 1 shows a computer system 101 that is programmed or otherwise configured to operate any method or system described herein (such as system or method for performing a non-classical computation described herein). The computer system 101 can regulate various aspects of the present disclosure. The computer system 101 can be an electronic device of a user or a computer system that is remotely located with respect to the electronic device. The electronic device can be a mobile electronic device.

The computer system 101 includes a central processing unit (CPU, also “processor” and “computer processor” herein) 105, which can be a single core or multi core processor, or a plurality of processors for parallel processing. The computer system 101 also includes memory or memory location 110 (e.g., random-access memory, read-only memory, flash memory), electronic storage unit 115 (e.g., hard disk), communication interface 120 (e.g., network adapter) for communicating with one or more other systems, and peripheral devices 125, such as cache, other memory, data storage and/or electronic display adapters. The memory 110, storage unit 115, interface 120 and peripheral devices 125 are in communication with the CPU 105 through a communication bus (solid lines), such as a motherboard. The storage unit 115 can be a data storage unit (or data repository) for storing data. The computer system 101 can be operatively coupled to a computer network (“network”) 130 with the aid of the communication interface 120. The network 130 can be the Internet, an internet and/or extranet, or an intranet and/or extranet that is in communication with the Internet. The network 130 in some cases is a telecommunication and/or data network. The network 130 can include one or more computer servers, which can enable distributed computing, such as cloud computing. The network 130, in some cases with the aid of the computer system 101, can implement a peer-to-peer network, which may enable devices coupled to the computer system 101 to behave as a client or a server.

The CPU 105 can execute a sequence of machine-readable instructions, which can be embodied in a program or software. The instructions may be stored in a memory location, such as the memory 110. The instructions can be directed to the CPU 105, which can subsequently program or otherwise configure the CPU 105 to implement methods of the present disclosure. Examples of operations performed by the CPU 105 can include fetch, decode, execute, and writeback.

The CPU 105 can be part of a circuit, such as an integrated circuit. One or more other components of the system 101 can be included in the circuit. In some cases, the circuit is an application specific integrated circuit (ASIC).

The storage unit 115 can store files, such as drivers, libraries and saved programs. The storage unit 115 can store user data, e.g., user preferences and user programs. The computer system 101 in some cases can include one or more additional data storage units that are external to the computer system 101, such as located on a remote server that is in communication with the computer system 101 through an intranet or the Internet.

The computer system 101 can communicate with one or more remote computer systems through the network 130. For instance, the computer system 101 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 101 via the network 130.

Methods as described herein can be implemented by way of machine (e.g., computer processor) executable code stored on an electronic storage location of the computer system 101, such as, for example, on the memory 110 or electronic storage unit 115. The machine executable or machine-readable code can be provided in the form of software. During use, the code can be executed by the processor 105. In some cases, the code can be retrieved from the storage unit 115 and stored on the memory 110 for ready access by the processor 105. In some situations, the electronic storage unit 115 can be precluded, and machine-executable instructions are stored on memory 110.

The code can be pre-compiled and configured for use with a machine having a processor adapted to execute the code or can be compiled during runtime. The code can be supplied in a programming language that can be selected to enable the code to execute in a pre-compiled or as-compiled fashion.

Aspects of the systems and methods provided herein, such as the computer system 101, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 101 can include or be in communication with an electronic display 135 that comprises a user interface (UI) 140. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 105. The algorithm can, for example, implement methods for performing a non-classical computation described herein.

### Certain Definitions and Considerations

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out.

The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

### EXAMPLES

### Example 1: Single DMD System

As illustrated in FIG. 10A, a spatial light modulator (SLM) was configured to generate an input beam at a predetermined wavelength. The input beam comprised an array of individual spots of light. The array was passed through a first beam splitter and lens (Lens, F0). The first lens was a convex lens having a focal length (f₀), and the input beam was focused onto an array of mirrors in a digital micromirror device (DMD), which defined a first image plane. The DMD was placed at a distance (d) corresponding to f₀ from the first lens F0. The DMD was operably coupled to a controller that defined the angle at which focused light was reflected. Each of the mirrors of the DMD was programmed to reflect light toward a downstream component, including an array, or toward a beam dump at an angle θ. θ was defined as the angle between the input array of spots of light and the optical path of the reflected light. Mirrors angled at 120 reflected light toward the downstream component. Mirrors angled at −12° reflected light toward the beam dump. The reflected light directed towards the downstream component were diffuse and refocused through a second lens (F1) having a focal length fₐ. The refocused light passed through a conjugate plane and through a third lens (F2) having a focal length f_{b}. As illustrated in FIG. 10B, an image taken at an arbitrary distance from a third lens illustrated that spots within the array of light were defocused by a factor of sin(θ), or by a factor of 0.4 when θ was 24° (i.e., when mirrors were oriented at ˜12°). Additionally, spots within the array of light exhibited shrinkage by cos(θ), or by a factor of 0.91 when θ was 24°.

### Example 2: Dual DMD System

As illustrated in FIG. 11, an apparatus for addressing an array of trapped atoms included a light source and a plurality of mirrors. The light source was an SLM. The plurality of mirrors was incorporated into a DMD. The plurality of mirrors within the DMD was mounted over a stage in the DMD, and the stage defined the first image plane. The light source generated an array of light. The light was passed through a polarizing beam splitter and focused onto the plurality of mirrors of the DMD via a first lens with a focal length f₀. A portion of the mirrors of the DMD were oriented from about 0° to about 12° to direct the focused light toward a downstream component. The downstream component was an array of trapped atoms. The remaining portion of mirrors of the DMD were oriented from about −12° to about 0°, such that the focused light was directed toward a beam dump. The portion of light that was focused onto the mirrors oriented at about 0° to about 12° were re-focused via a second lens with a focal length fₐ. The light passed through a conjugate plane and subsequently refocused via a third lens with a focal length f_{b}. The refocused light was directed over a plurality of mirrors. The plurality of mirrors was mounted over a stage, which defined the second image plane. The plurality of mirrors and the stage were incorporated into a second DMD. A portion of the mirrors of the second DMD were oriented at a first position to selectively reflect light toward a downstream component, and the remaining portion of the mirrors of the second DMD were oriented at a second position to selectively reflect light towards a beam dump.

### Example 3: Single DMD with a Polarizing Beam Splitter

As illustrated in FIG. 12, an apparatus for addressing an array of trapped atoms included a light source and a plurality of mirrors. The light source was an SLM. The plurality of mirrors was incorporated into a DMD. The plurality of mirrors within the DMD was mounted over a stage in the DMD, and the stage defined the first image plane. The light source generated an array of light 1240 (e.g., downward arrow corresponding to the direction of light). The light was passed through a polarizing beam splitter and focused onto the plurality of mirrors of the DMD via a first lens with a focal length f0. A portion of the mirrors of the DMD were oriented from about 0° to about 12° to direct the focused light toward a downstream component. The downstream component was an array of trapped atoms. The remaining portion of mirrors of the DMD were oriented from about −12° to about 0°, such that the focused light was directed toward a beam dump. The portion of light that was focused onto the mirrors oriented at about 0° to about 12° were re-focused via a second lens with a focal length f1. As the light approached a conjugate plane corresponding to f1, the light was reflected off of a flat mirror. The reflected light was passed through the second lens and onto the DMD, which further reflected the light through the first lens and toward the polarizing beam splitter. The output light 1245 from the polarizing beam splitter (e.g., beam splitter 1230) was directed towards a downstream component.

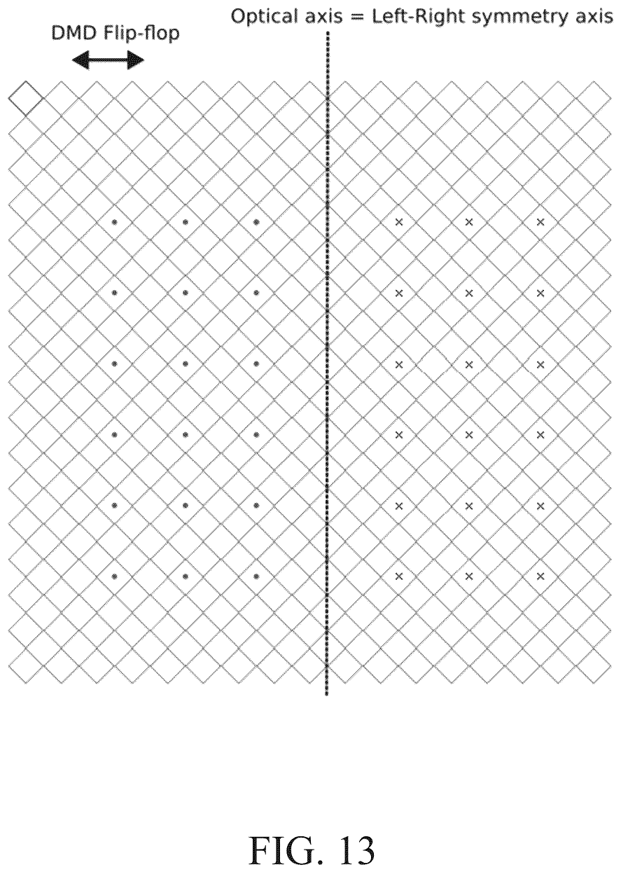

A diagram of an array of tweezers showing spots from each pass through the beam path as they fell on the elements of the DMD (e.g., DMD 1205) is illustrated in FIG. 13. The spots (circles) as they fell on the elements of the DMD from the upstream optical components are shown on the left of the optical axis. The spots as they fell on elements of the DMD as they returned from the relay components are shown as crosses (“x”) on the right of the optical axis in FIG. 13.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the disclosure shall also cover any such alternatives, modifications, variations, or equivalents. It is intended that the following claims define the scope of the disclosure and that methods and structures within the scope of these claims and their equivalents be covered thereby.

What is claimed is:

1. An apparatus for spatially separating laser beams, the apparatus comprising:
an array of spots of light; and
a beam deflector comprising a plurality of elements;
wherein each spot of the array of spots of light is aligned on each of the plurality of elements of the beam deflector.

2. The apparatus of claim 1, wherein the apparatus further comprises a chamber comprising one or more optical trapping units configured to generate a plurality of spatially distinct optical trapping sites.

3. The apparatus of claim 2, wherein the plurality of optical trapping sites is configured to trap a plurality of atoms.

4. The apparatus of claim 3, wherein the plurality of atoms comprises one or more qubits.

5. The apparatus of claim 3, wherein the plurality of atoms comprises at least 60 atoms.

6. The apparatus of claim 3, wherein the plurality of atoms comprises neutral atoms.

7. The apparatus of claim 3, wherein the plurality of atoms comprises rare earth atoms.

8. The apparatus of claim 7, wherein the plurality of atoms comprises ytterbium atoms.

9. The apparatus of claim 3, wherein the plurality of atoms comprises alkali atoms.

10. The apparatus of claim 3, wherein the plurality of atoms comprises alkaline earth atoms.

11. The apparatus of claim 10, wherein the plurality of atoms comprises strontium atoms.

12. The apparatus of claim 11, wherein the plurality of atoms comprises strontium—87 atoms.

13. The apparatus of claim 1, wherein the plurality of elements comprises a blazed grating.

14. The apparatus of claim 1, wherein the plurality of elements comprises a plurality of mirrors.

15. The apparatus of claim 14, wherein the plurality of mirrors is a digital micromirror device (DMD).

16. The apparatus of claim 15, wherein the DMD is mounted onto a stage, wherein the stage is configured to rotate along three degrees of freedom.

17. The apparatus of claim 1, wherein each of the plurality of elements is spatially separated by at least 10 nm.

18. The apparatus of claim 17, wherein each of the plurality of elements comprises a surface area.

19. The apparatus of claim 18, wherein the surface area ranges from about 1 μm² to about 10 mm².

20. The apparatus of claim 1, wherein the apparatus further comprises a first optical component.

21. The apparatus of claim 20, wherein the first optical component comprises a lens, a beam splitter, a mirror, a polarizer, a waveplate, or a combination thereof.

22. The apparatus of claim 21, wherein the first optical component comprises a first lens having a first focal length (f₀).

23. The apparatus of claim 22, wherein the plurality of elements is located at a distance (d) from the first lens, wherein the distance about the same as the first focal length.

24. The apparatus of claim 22, wherein the apparatus further comprises a relay component, wherein the relay component is along an optical path after the plurality of elements.

25. The apparatus of claim 24, wherein the array of spots of light travel along the optical path.

26. The apparatus of claim 24, wherein the relay component comprises a lens, a beam splitter, a mirror, a polarizer, a waveplate, or a combination thereof.

27. The apparatus of claim 25, wherein the relay component comprises a first relay lens having a first relay focal length (fₐ).

28. The apparatus of claim 27, wherein the first relay lens is after the plurality of elements on the optical path.

29. The apparatus of claim 28, wherein the relay component further comprises a folding mirror, wherein the folding mirror is after the first relay lens on the optical path.

30. The apparatus of claim 29, wherein the relay component further comprises a relay waveplate between the first relay lens and the folding mirror.

31. The apparatus of claim 29, wherein the apparatus further comprises a beam splitter.

32. The apparatus of claim 31, wherein the first lens and the first relay lens are separated by at most about 34°.

33. The apparatus of claim 24, wherein the apparatus further comprises a second optical component, wherein the second optical component is after the relay component along the optical path.

34. The apparatus of claim 32, wherein the second optical component comprises a plurality of mirrors.

35. The apparatus of claim 33, wherein the plurality of mirrors is a DMD.

36. The apparatus of claim 1, wherein the apparatus further comprises an optical modulator.

37. The apparatus of claim 35, wherein the optical modulator is configured to generate the array of spots of light.

38. The apparatus of claim 36, wherein the optical modulator comprises a spatial light modulator (SLM), a DMD, a liquid crystal device, or a combination thereof.

39. The apparatus of claim 35, wherein the apparatus further comprises a coherent light source configured to direct an emitted light toward the optical modulator.

40. The apparatus of claim 39, wherein the coherent light source is configured to emit light having one or more wavelengths ranging from about 200 nm to about 1,000 nm.

41. A system for addressing a subset of atoms in an array, the system comprising:
an atom rearrangement unit (ARU), the ARU comprising an apparatus:
a plurality of elements operably coupled to a digital device:
at least one lens,
wherein the plurality of elements is configured (i) to direct an array of spots of light in a direction or (ii) to direct a portion of the array of spots of light onto the array.

42. The system of claim 41, wherein the apparatus further comprises a chamber comprising one or more optical trapping units configured to generate a plurality of spatially distinct optical trapping sites.

43. The system of claim 42, wherein the plurality of optical trapping sites is configured to trap a plurality of atoms.

44. The system of claim 43, wherein the plurality of atoms comprises one or more qubits.

45. The system of claim 43, wherein the plurality of atoms comprises at least 60 atoms.

46. The system of claim 43, wherein the plurality of atoms comprises neutral atoms.

47. The system of claim 43, wherein the plurality of atoms comprises rare earth atoms.

48. The system of claim 47, wherein the plurality of atoms comprises ytterbium atoms.

49. The system of claim 43, wherein the plurality of atoms comprises alkali atoms.

50. The system of claim 43, wherein the plurality of atoms comprises alkaline earth atoms.

51. The system of claim 50, wherein the plurality of atoms comprises strontium atoms.

52. The system of claim 51, wherein the plurality of atoms comprises strontium—87 atoms.

53. The system of claim 41, wherein the plurality of elements comprises a blazed grating.

54. The system of claim 41, wherein the plurality of elements comprises a plurality of mirrors.

55. The system of claim 54, wherein the plurality of mirrors is a digital micromirror device (DMD).

56. The system of claim 55, wherein the DMD is mounted onto a stage, wherein the stage is configured to rotate along three degrees of freedom.

57. The system of claim 41, wherein each of the plurality of elements is spatially separated by at least 10 nm.

58. The system of claim 41, wherein each of the plurality of elements comprises a surface area.

59. The system of claim 58, wherein the surface area ranges from about 1 μm² to about 10 mm².

60. The system of claim 41, wherein the apparatus further comprises a first optical component.

61. The system of claim 60, wherein the first optical component comprises a lens, a beam splitter, a mirror, a polarizer, a waveplate, or a combination thereof.

62. The system of claim 61, wherein the first optical component comprises a first lens having a first focal length (f₀).

63. The system of claim 62, wherein the plurality of elements is located at a distance (d) from the first lens, wherein the distance about the same as the first focal length.

64. The system of claim 41, wherein the apparatus further comprises a relay component, wherein the relay component is along an optical path after the plurality of elements.

65. The system of claim 64, wherein the array of spots of light travel along the optical path.

66. The system of claim 64, wherein the relay component comprises a comprises a lens, a beam splitter, a mirror, a polarizer, a waveplate, or a combination thereof.

67. The system of claim 66, wherein the relay component comprises a first relay lens having a first relay focal length (fₐ).

68. The system of claim 67, wherein the first relay lens is after the plurality of elements on the optical path.

69. The system of claim 68, wherein the relay component further comprises a folding mirror, wherein the folding mirror is after the first relay lens on the optical path.

70. The system of claim 69, wherein the relay component further comprises a waveplate between the first relay lens and the folding mirror.

71. The system of claim 67, wherein the apparatus further comprises a beam splitter.

72. The system of claim 71, wherein the first lens and the first relay lens are separated by at most about 24°.

73. The system of claim 64, wherein the apparatus further comprises a second optical component, wherein the second optical component is after the relay component along the optical path.

74. The system of claim 73, wherein the second optical component comprises a plurality of mirrors.

75. The system of claim 74, wherein the plurality of mirrors is a DMD.

76. The system of claim 41, wherein the apparatus further comprises an optical modulator.

77. The system of claim 76, wherein the optical modulator comprises a spatial light modulator (SLM), a DMD, a liquid crystal device, or a combination thereof.

78. The system of claim 77, wherein the optical modulator is configured to generate the plurality of an array of spots of light.

79. The system of claim 76, wherein the apparatus comprises a light source.

80. The system of claim 79, wherein the light source comprises a coherent light source, configured to emit light having one or more wavelengths that are within a range from about 200 nm to about 1,000 nm.

81. A method for improving contrast of signals on an array, the method comprising:
a) directing an array of spots of light onto a plurality of elements, the plurality of elements controlled by a digital device, wherein each of the spots of light is directed onto a separate element of the plurality of elements;
b) orienting using the digital device the plurality of elements to direct the plurality of incident laser beams.

82. The method of claim 81, wherein the elements of the DMD are individually manipulatable to steer each of the spots of light.

83. The method of claim 81, wherein the array comprises signals having a contrast ratio of at least 1,000:1.

84. The method of claim 81, wherein the contrast ratio is at least 5,000:1, 10,000:1, or 20,000:1.

85. The method of claim 81, wherein the contrast ratio ranges from about 1,000:1 to 10,000:1.

86. The method of claim 81, wherein the method further comprises focusing the array of spots of light through a first optical component.

87. The method of claim 86, wherein the first optical component comprises a first lens having a first focal length (f₀).

88. The method of claim 87, wherein the first lens is before the plurality of elements.

89. The method of claim 87, wherein focusing an array of spots of light through the first lens comprises decreasing a waist of the array of spots of light, wherein the waist is smaller than a dimension each spot of light.

90. The method of claim 87, wherein focusing an array of spots of light comprises directing the array of spots of light over a distance (d) between the first lens and the plurality of elements, wherein d is substantially the same as f₀.

91. The method of claim 89, wherein the dimension of the element of the plurality of elements comprises a diameter or a pitch.

92. The method of claim 81, wherein the orienting the plurality of elements comprises orienting a first portion of the plurality of elements at an orientation ranging from −17° to about +170 relative to an incident plane.

93. The method of claim 92, wherein the orienting the plurality of elements comprises orienting the first portion of the plurality of elements at +17° relative to an incident plane.

94. The method of claim 93, wherein the orienting the plurality of elements comprises orienting the second portion of the plurality of elements at −17° relative to an incident plane.

95. The method of claim 92, wherein the orienting the plurality of elements comprises orienting a first portion of the plurality of elements at +17° relative to an incident plane and orienting a second portion of the plurality of elements at −17° relative to the incident plane.

96. The method of claim 95, wherein the method further comprises addressing an arbitrary subset of the array on a time scale.

97. The method of claim 96, wherein the time scale comprises at least 10 microseconds.

98. The method of claim 97, wherein the array of trapped atoms comprises a portion of a quantum computer.

99. An apparatus for spatially separating laser beams, the apparatus comprising:
an array of spots of light; and
a beam block comprising a plurality of elements;
wherein each spot of the array of spots of light is aligned on each of the plurality of elements of the beam block.

100. The apparatus of claim 99, wherein the beam block comprises a microshutter array, the microshutter array comprising microshutters.

101. The apparatus of claim 100, wherein the each of the microshutters has a length ranging from about 10 μm to about 1 mm.
